SEQUENCE LISTING (87 sequences)

SEQ ID NO: 1 - DNA, 20 bp, artificial sequence
  primer - 8F
agagtttgatymtggctcag

SEQ ID NO: 2 - DNA, 19 bp, artificial sequence
  primer 1492R
ggwtaccttgttacgactt

SEQ ID NO: 3 - DNA, 17 bp, artificial sequence
  primer 1407R
gacgggggtgwgtrcaa

SEQ ID NO: 4 - DNA, 17 bp, artificial sequence
  primer U518R
attaccgcggctgctgg

SEQ ID NO: 5 - DNA, 17 bp, artificial sequence
  primer UB357F
cctacgggaggcagcag

SEQ ID NO: 6 - DNA, 57 bp, artificial sequence
  primer dG UB 357F
cgcccgccgcgccccgcgcccgtcccgccgcccccgcccgcctacgggaggcagcag

SEQ ID NO: 7 - DNA, 16 bp, artificial sequence
  primer UA 341F1
tayggggcgcagcagg

SEQ ID NO: 8 - DNA, 58 bp, artificial sequence
  primer dG UA341F1
cgcccgccgcgccccgcgcccgtcccgccgcccccgcccgcctayggggcgcagcagg

SEQ ID NO: 9 - DNA, 18 bp, artificial sequence
  primer UA 341F2
cctacggggcgcagaggg

SEQ ID NO: 10 - DNA, 58 bp, artificial sequence
  primer dG UA341F2
cgcccgccgcgccccgcgcccgtcccgccgcccccgcccgcctacggggcgcagaggg

SEQ ID NO: 11 - DNA, 18 bp, artificial sequence
  primer U519F
cagcmgccgcggtaatwc

SEQ ID NO: 12 - DNA, 58 bp, artificial sequence
  primer U519F with 40 bp
cgcccgccgcgccccgcgcccgtcccgccgcccccgcccgcagcmgccgcggtaatwc

SEQ ID NO: 13 - DNA, 19 bp, artificial sequence
  primer UA958R
yccggcgttgamtccaatt

SEQ ID NO: 14 - DNA, 23 bp, artificial sequence
  primer UB 939R
cttgtgcgggcccccgtcatttc

SEQ ID NO: 15 - DNA, 1510 bp, unknown
  Unknown clone from enriched environmental sample that by rDNA sequence analysis has highest identity to the genus Thauera
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagagatcaggaggaacaccgatggcgaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccgaagggcgaattcgcggccgctaa

SEQ ID NO: 16 - DNA, 1489 bp, unknown
  Unknown clone from enriched environmental sample that by rDNA sequence analysis has highest identity to tThauera sp.R26885
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgccctgagggggaaagcgggggattcttcggaacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgcattctctaatataggatgtggatgacggtaccggactaagaagcaccggctaactacgtgccagcagccgcggtaatacgtagggtgcgagcgttaatctgaattactgggcgtaaagcgtgcgcaggcggttttgtaagacagatgtgaaatccccgggcttaacctgggaactgcgtttgtgactgcaaggctagagtacggcagaggggggtggaattcctggtgtagcagtgaaatgcgtagatatcgggaggatcacctatggcgagggcagccccctgggcttgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgtctggaaccttggtgagagccgagggtgccttcgggagccagaacacaggtgctgcatggctgtcgtcagctcgtgtcgtgagatgttgggttaagtcccgcaacgagcgcaacccttgtcattagttgccatcatttagttgggcactctaatgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 17 - DNA, 1489 bp, unknown
  Unknown clone from enriched environmental sample that by rDNA sequence analysis has highest identity to  Azoarcus sp. mXyN1
tggctcagattaaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgccctgagggggaaagcgggggattcttcggaacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgcattctctaatataggatgtggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggcttaacctgggaactgcgtttgtgactgcaaggctagagtacggcagaggggggtggaattcctggtgtancantgaaatgcgtaaatatcaggaggaacaccgatggcgaaggcagccccctgggcctgtactgacgctcatgcacgaaagggtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 18 - DNA, 1487 bp, unknown
  unkown clone
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgcattctctaatataggatgtggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggcttaacctgggaactgcgtttgtgactgcaaggctagagtacggcagaggggggtggaattcctggtgtaccagtgaaatgcgtaaagatcaagacgaacaccgatggcgaaggcagccccctgggcctgtactgacgctcatgcacaaaagcgtggggagcaaacaggattagataccctggtagtccacgccctaaacgatttcgactagtcgtttggagcagcaatgcactgagtgacgcagctaacgcgtgaagtcgaccgcctggggagtacggccgcaaggttaaaactcaaaggaattgacggggacccgcacaagcggtggatgatgtggattaattngatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcattagttgccatcatttagttgggcactctaatgagactgccggtgacaaaccggaggaaggtggggatgacgtcaagtcatcatggcccttacggcctgggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 19 - DNA, 1489 bp, unknown
  Unknown clone from enriched environmental sample that by rDNA sequence analysis has highest identity to Thauera sp. R26885
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggattcttcggaacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggggcaaccctgatccagccatgccgcgtgagtgaagaaggccttcgggttgtaaagctctttcggccgggaagaaatcgcgcactctaacatagtgtgtggatgacggtaccggactaagaagcaccggctaactacgtgccagcagccgcggtaatacgtagggtgcgagcgttaatcggaattactgggcgtaaagcgtgcgcaggcggttttgtaagacggatgtgaaatccccgggctcaacctgggaactgcgtttgtgactgcaaggctagagtacggcagaggggggtggaattcctggtgtagcagtgaaatgcgtagatatcaggaggaacaccgatggcgaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgtctggaaccttggtgagagccgagggtgccttcgggagccagaacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 20 - DNA, 894 bp, unknown
  Unknown clone from enriched environmental sample that by rDNA sequence analysis has highest identity to Azotobacter beijerinckii
cttaacctgggaactgcgtttgtgactgcaaggctagagtacggcagaggggggtggaattccacgtgtaacagtgaaatgcgtagagatgtggaggaacaccgatggcgaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgtctggaaccttggtgagagccgagggtgccttcgggagccagaacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 21 - DNA, 1486 bp, unknown
  Unknown clone from enriched environmental sample that by rDNA sequence analysis has highest identity to  Thauera sp. R26885
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacatgggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtaaagatcaggaggaacaccgaggggaaggcagccccctgggcctgtatgaaggctcaggcaggaaagcgtggggagcaaacaggaatagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgtctggaaccttggtgagagccgagggtgccttcgggagccagaacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccaaaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 22 - DNA, 1489 bp, unknown
  Unknown clone from enriched environmental sample that by rDNA sequence analysis has highest identity to Azoarcus sp. mXyN1
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggattcttcggaacctcgcgcgattggagcggccgatgtcggattagctagtaggtgaggtaaaggctcacctaggcgacgatccgtagcgggtctgagaggatgatccgccacactgggactgaggcacggcccagactcctacgggaggcagcagtggggaattttggacaatgggggcaaccctgatccagccatgccgcgtgagtgaagaaggccttcgggttgtaaagctctttcggccgggaagaaatcgcgcactctaacatagtgtgtggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagatatcaggaggaacaccgatggcgaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcctttatgggtagggcttcacacgtcatacaatggtcggtacagagggttgccaagccgcgaggtggagccaatcccttaaagccgattgtagtccggatcgtagtctgcaactcgactacgtgaagtcggaatcgctagtaatcgcagatcagcatgctgcggtgaatacgttcccgggtcttgcacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 23 - DNA, 1487 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttataaagctctttcggccgggaagaaatcgtggtctctaacataggccatggatgacggtaccggactaagaagcaccggctaactacgtgccagcagccgcggtaatacgtagggtgcgagcgttaatcggagttactgggcgtaaagcgtgcgcaggcggttttgtaagacagatgtgaaatccccgggctcaacctgggaactgcgtttgtgactgcaaggctagagtacggcagaggggggtggaattcctggtgtaacagtgaaatgcgtagagatcaggaggaacaccgatggcgaaggcagccccctgggcctgtactgacgctcatgcacgaaagcgtggggagcaaaaaggattaaataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 24 - DNA, 1487 bp, unknown
  Unknown clone from enriched environmental sample that by rDNA sequence analysis has highest identity to Thauera aromatica
tggctcagattgaacgctggcggcatgctttgcacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcagcctgggaactgcgtttgtgactgcaaggctagagtacggcagaagggggtggaattcctggtgtagcagtgaaatgcgttgagatcaggaggaacaccgatggcgaaggcagccccctgggcctgtactgacgctcatgtacaaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 25 - DNA, 1487 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtttagcagtgaaatgcgtagagatcaagaggaacaccgatggcgaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 26 - DNA, 1487 bp, unknown
  unknown clone
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagagatcaagaggaacaccgatggcgaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacctgccaggaaccttgccgagaggcgagggtgccttcgggagcctggacacaggtgctgcatggctgtcgtcagctcgtgtcgtgagatgttgggttaagtcccgcaacgagcgcaacccttatcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 27 - DNA, 1488 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagagatcaagaggaacaccgatggcggaagcagcccccctgggcctgtactgacgttcatgcacgaaagcgtggggagcaaacaggattagatacctggtaagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctatcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 28 - DNA, 1489 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaatttctggtgtagcagtaaaatgcgtagagatcaagaggaacaccgtatggcgaagccagcccctggggcttgtactgacgttcatgcacgaaagggtggggagcaaacaggattagatacccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 29 - DNA, 749 bp, unknown
  Unknown clone from enriched environmental sample that by rDNA sequence analysis has highest identity to Azoarcus ap. EH1O
tggctcagatcgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgccctgagggggaaagcgggggattcttcggaacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggggcaaccctgatccagccatgccgcgtgagtgaagaaggccttcgggttgtaaagctctttcggccgggaagaaatcgcgcactctaacatagtgtgtggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtaaatatcaggaggaacaccgatggcgaaggcagccccctgggcctgtactgacgctcatgcacgaaagcg

SEQ ID NO: 30 - DNA, 1487 bp, unknown
  Unknown clone from enriched environmental sample that by rDNA sequence analysis has highest identity to Thauera sp. R26885
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggtggttttgtaagacagatgtgaaatccccgggctcaacctgggaactgcgtttgtgactgcaaggctagagtacggcagaggggggtggaattcctggtgtagcagtgaaatgcgtaaagatcaagaggaacaccgatggcgaaggcagccccctgggcctgtactgacgttcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgtctggaaccttggtgagagccgagggtgccttcgggagccagaacacaggtgctgcatggctgtcgtcagctcgtgtcgtgagatgttgggttaagtcccgcaacgagcgcaacccttgtcattagttgccatcatttagttgggcactctaatgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 31 - DNA, 1487 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattaactagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagagtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtaaagatcaagaggaacaccgatggcgaatgcaaccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 32 - DNA, 1499 bp, unknown
  Unknown clone from enriched environmental sample that by rDNA sequence analysis has highest identity to Thauera aromatica
cggttaccttgttacgacttcaccccagtcatgaatctcaccgtggtaagcgccctcccgaaggttaagctacctacttctggtgaaacccacccccatggtgtgacgggcggtgtgtacaagacccgggaacgtattcaccgcagcatgctgatctgcgattactagcgattccgacttcacgtagtcgagttgcagactacgatccggactacgatcggctttaagggattggctccacctcgcggcttggcaaccctctgtaccgaccattgtatgacgtgtgaagccctacccataagggccatgaggacttgacgtcatccccaccttcctccggtttgtcaccggcagtctcactagagtgcccaaccaaatgatggcaactagtgacaagggttgcgctcgttgcgggacttaacccaacatctcacgacacgagctgacgacagccatgcagcacctgtgtccaggctcccgaaggcaccctcgcctctcggcaaggttcctggcatgtcaagggtaggtaaggtttttcgcgttgcatcgaattaatccacatcatccaccgcttgtgcgggtccccgtcaattcctttgagttttaaccttgcggccgtactccccaggcggtcgacttcacgcgttagctgcgtcactcagtgcattgctgctccgaacgactagtcgacatcgtttagggcgtggactaccagggtatctaatcctgtttgctccccacgctttcgtgcatgagcgtcagtacaggcccagggggctgccttcgccatcggtgttcctcctgatctctgcgcatttcactgctacaccaggaattccacccccctctgccgtactctagccttgcagtcacaaacgcagttcccaggttgagcccggggatttcacatctgtcttacaaaaccgcctgcgcacgctttacgcccagtaattccgattaacgctcgcaccctacgtattaccgcggctgctggcacgtagttagccggtgcttcttagtccggtaccgtcatccatggcctatgttagagaccacgatttcttcccggccgaaagagctttacaacccgaaggccttcttcactcacgcggcatggctggatcaggcttgcgcccattgtccaaaattccccactgctgcctcccgtaggagtctgggccgtgtctcagtcccagtgtggcggatcatcctctcagacccgctacggatcgtcgcctaggtgagcctttacctcacctactagctaatccgacatcggccgctccaatcgcgcgaggtccgaagatcccccgctttctccctcaggacgtatgcggtattagcgtacctttcgatacgttatcccccacgacatgggcacgttccgatgcattactcacccgttcgccactcgccggcaggccgaagcccccgctgccgttcgacttgcatgtgtaaagcatgccgccagcgttcaatctgagccatgatcaaactct

SEQ ID NO: 33 - DNA, 1429 bp, unknown
  Unknown clone from enriched environmental sample that by rDNA sequence analysis has highest identity to Thauera aromatica
tgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggattttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatatgtagggtgcgagcgttaatcggaattactgggcgtaaagcgtgcgcaggcggttttgtaagacagatgtgaaatccccgggctcaacctgggaactgcgtttgtgactgcaaggctagagtacggcggaggggggtggaattcctggtgtagcagtgaaatgcgtagagatcaggaggaacaccgatggcgaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 34 - DNA, 1439 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgccctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtaaagatcaggaggaacaccgatggcgaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaatttgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 35 - DNA, 1440 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagagatcaggaggaacaccgatggcgaaggcagccccctgggcctgtactgacgctcatgcacgaaagcctgggggagcaacaggattagataccctggtaagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgaaatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 36 - DNA, 1440 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagttctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaagggggtggaattcctggtgtagcagtgaaatgcgtagagatcaggaggaacaccgatggcgaaggcagcccccttgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgccgcggtgaatacgttcccgggtcttgtacacaccgcccgtcacaccatgggagtgggtttcaccagaagtaggtagcttaaccttcgggagggcgct

SEQ ID NO: 37 - DNA, 1439 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagagatcaagaggaacaccgatggcgaaggcagccccctgggcctgtactgacgttcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 38 - DNA, 1439 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagagagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagagatcaggaggaacaccgatggggaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 39 - DNA, 1439 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtatcagtgaaatgcgtaaagatcaagaggaacaccgatggggaaggcagccccctgggcctgtactgacgttcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgtagatcagcatgctgcggtgaatacgttcccgggtcttgtacacaccgcccgtcacaccatgggagtgggtttcaccagaagtaggtagcttaaccttcgggagggcgct

SEQ ID NO: 40 - DNA, 1439 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaactcctggtgtagcagtgaaatgcgtagagatcaggaggaacaccgatggcgaaggcagccccctgggcttgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 41 - DNA, 1439 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagagatcaggaggaacgccgatggcgaagacagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagggggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 42 - DNA, 1475 bp, unknown
  Unknown clone from enriched environmental sample that by rDNA sequence analysis has highest identity to Finegoldia magna
tggctcaggacgaacgctggcggcgtgcctaacacatgcaagtcgagcgaagtgactctgagagaaattttcggatggatcgaagagtcatcttagcggcggacgggtgagtaacgcgtgagaaacctgcctttcacaaagggatagcctcgggaaactgggattaataccttatgaaactgaattaccgcatggtagatcagtcaaagcgaataagcggtgaaagatggtctcgcgtcctattagctagttggtgaggtaacggctcaccaaggcttcgataggtagccggcctgagagggtgaacggccacactggaactgagacacggtccagactcctacgggaggcagcagtggggaatattgcacaatggaggaaactctgatgcagcgacgccgcgtgaatgatgaaggccttcgggttgtaaagttctgtccttggggaagataatgacggtacccaaggaggaagccccggctaactacgtgccagcagccgcggtaatacgtagggggcgagcgttgtccggaattattgggcgtaaagggttcgcaggcggtctgataagtcagatgtgaaaggcgtaggctcaacctacgtaagcatttgaaactgtcagacttgagttaaggagaggaaagtggaattcctagtgtagcggtgaaatgcgtagatattaggaggaataccagtggcgaagggsgactttctggacttatactgacgctgaggaacgaaagcgtggggagsaaacaggattagataccctggtagttccacgccgtaaacgawgagtgctaggtgktgggggtcaaacctcggtgccgcaasctaacgcattaagcactccgcctggggggtacgtacgcmagtatgaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggaaccacggtgagattcatgactggggtgaagtcgtaacaaggtaaccg

SEQ ID NO: 43 - DNA, 1481 bp, unknown
  Unknown clone from enriched environmental sample that by rDNA sequence analysis has highest identity to Spirochaeta sp. MET-E
tggctcagaacgaacgctggcggcgcgttttaagcatgcaagtcgagcggcaagggcctttgggcccctagagcggcggacgggtgagtaacacgtggacaatctgccccccggccggggatagcccagggaaacctggattaataccggatgagacgggacgcacgatggtgcggtccgggaaaggcgctgcggcgccgccgggggatgagtccgcgacccattagctggacggcggggtaaaggcccaccgtggcgacgatgggtagccggcctgagagggtggacggccacattggaactgagacacggtccagactcctacgggaggcagcagctaagaatcttccgcaatgggcgaaagcctgacggagcgacgccgcgtgaacgaagaaggccgtgaggttgtaaagttcttttcgggagggggaattaccgtggcagggaatggccgcgggatgacgtgaatcccggaacaagccccggctaactacgtgccagcagccgcggtaacacgtagggggcgagcgttgttcggaatcattgggcgtaaagggcgtgcaggcggcactgcaagtccggcgtgaaagaccccggcccaaccgggggggtgcgctggaaactgcggtgcttgagtacaggaggggatgccggaattccaggtgtaggggtgaaatctgtagatatctggaagaacaccgatggcgaaggcaggcatctggccatgtactgacgctgagacgcgaaggtgcggggagcaaacaggtttagataccctggtagtccgcacagtaaacgatgtgcaccagggtggcgggggtagaacccccggtaccgtagcaaacgcattaagtgcaccgcctggggagtatgctcgcaagggtgaaactcaaaggaattgacgggggcccgcacaagcggaggagcatgtggtttaattcgatgatacgcgaggaaccttacctgggctcgaacgtaagatgactgtaggtgaaagcttacatctcttcggagcattttacgaggtgctgcatggttgtcgtcagctcgtgccgtgaggtgtcgggttaagtcccataacgagcgcaacccctacctttagttgccatcaggtaatgctggggactctaaaggaactgcctacgcaagtagtgaggaaggcggggatgacgtcaaatcagcacggcccttacgtccagggctacacacgtgctacaatggccgatacagagggcagctacctggtgacaggatgcaaatctccaaagtcggtctcagttcggatcggagtctgcaacccgactccgtgaagttggattcgctagtaatcgcgcatcagccatggcgcggtgaatacgttcccgggccttgtacacaccgcccgtcaagccatggaagctggggggacctaaagtcgataaccgcaaggagtcgcctagggtaaaaccagtgactggggctaagtcgtaacaaggtaaccg

SEQ ID NO: 44 - DNA, 1488 bp, unknown
  Unknown clone from enriched environmental sample that by rDNA sequence analysis has highest identity to Azotobacter beijerinckii
tggctcagattgaacgctggcggcaggcctaacacatgcaagtcgagcggatgagtggagcttgctccatgattcagcggcggacgggtgagtaatgcctaggaatctgcctggtagtgggggacaacgtttcgaaaggaacgctaataccgcatacgtcctacgggagaaagtgggggatcttcggacctcacgctatcagatgagcctaggtcggattagctagttggcgaggtaaaggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagagatcaggaggaacaccgatggcgaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggccttgtacacaccgcccgtcacaccatgagagttggcaatacccgaagtccgtggggcaaccgtttacggagccagcggccgaaggtagggtcagcgattggggtgaagtcgtaacaaggtaaccg

SEQ ID NO: 45 - DNA, 1481 bp, unknown
  Unknown clone from enriched environmental sample that by rDNA sequence analysis has highest identity to Finegoldia magna
cggttaccttgttacgacttcaccccagtcattgcccctaccttcgacagctgcccccttttatggttagctcactggcttcgggtattgacaactcccatggtgtgacgggcggtgtgtacaagacccgggaacgcattcaccgcggcattctgatccgcgattactagcaactccgacttcatgcaggcgagttgcagcctgcaatccgaactgggatcggcttttagagatttgcttgccatcgctgacttgcttctcgttgtaccgaccattgtagcacgtgtgtagcccaggacataaagggcatgatgatttgacgtcatccccaccttcctccgatttgtcatcggcagtctctttagagtgcccaacttaatgatggcaactaaagacaagggttgcgctcgttgcgggacttaacccaacatctcacgacacgagctgacgacaaccatgcaccacctgtgtccgctgtaccccgaaggataaagatctatctctaaaccggtcagcggcatgtcaagccctggtaaggttcttcgcgttgcttcgaattaaaccacatgctccgctgcttgtgcgggtccccgtcaattcctttgagtttcatacttgcgtacgtactccccaggcggagtgcttaatgcgttagctgcggcaccgaggtttgacccccaacacctagcactcatcgtttacggcgtggactaccagggtatctaatcctgtttgctccccacgctttcgttcctcagcgtcagtataagtccagaaagtcgccttcgccactggtattcctcctaatatctacgcatttcaccgctacactaggaattccactttcctctccttaactcaagtctgacagtttcaaatgcttacgtaggttgagcctacgcctttcacatctgacttatcagaccgcctgcgaaccctttacgcccaataattccggacaacgctcgccccctacgtattaccgcggctgctggcacgtagttagccggggcttcctccttgggtaccgtcattatcttccccaaggacagaactttacaacccgaaggccttcatcattcacgcggcgtcgctgcatcagagtttcctccattgtgcaatattccccactgctgcctcccgtaggagtctggaccgtgtctcagttccagtgtggccgttcaccctctcaggccggctacctatcgaagccttggtgagccgttacctcaccaactagctaataggacgcgagaccatctttcaccgcttattcgctttgactgatctaccatgcggtaattcagtttcataaggtattaatcccagtttcccgaggctatccctttgtgaaaggcaggtttctcacgcgttactcacccgtccgccgctaagatgactcttcgatccatccgaaaayttctctcmgagtcacttcgcggcacgccgccagcgttcgtcctgagccakaatcaaactct

SEQ ID NO: 46 - DNA, 1486 bp, unknown
  Unknown clone from enriched environmental sample that by rDNA sequence analysis has highest identity to Azotobacter beijerinckii
tggctcagattgaacgctggcggcaggcctaacacatgcaagtcgagcggatgagtggagcttgctccatgattcagcggcggacgggtgagtaatgcctaggaatctgcctggtagtgggggacaacgtttcgaaaggaacgctaataccgcatacgtcctacgggagaaagtgggggatcttcggacctcacgctatcagatgagcctaggtcggattagctagttggtgaggtaaaggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggcagtaagttaataccttgctgttttgacgttaccgacagaataagcaccggctaacttcgtgccagcagccgcggtaatacgaagggtgcaagcgttaatcggaattactgggcgtaaagcgcgcgtaggtggttcgttaagttggatgtgaaagccccgggctcaacctgggaactgcatccaaaactggcgagctagagtatggcagatggtggtggaatttcctgtgtagcggtgaaatgcgtacatataggaaggaacaccagtggcgaaggcgaccacctgggctaatactgacactgaggtgcgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 47 - DNA, 1442 bp, unknown
  Unknown clone from enriched environmental sample that by rDNA sequence analysis has highest identity to Ochrobactrum sp. mp-5
tggctcagaacgaacgctggcggcaggcttaacacatgcaagtcgagcgccccgcaaggggagcggcagacgggtgagtaacgcgtgggaacgtaccttttgctacggaataactcagggaaacttgtgctaataccgtatgtgcccttcgggggaaagatttatcggcaaaggatcggcccgcgttggattagctagttggtgaggtaaaggctcaccaaggcgacgatccatagctggtctgagaggatgatcagccacactgggactgagacacggcccagactcctacgggaggcagcagtggggaatattggacaatgggcgcaagcctgatccagccatgccgcgtgagtgatgaaggccctagggttgtaaagctctttcaccggtgaagataatgacggtaaccggagaagaagccccggctaacttcgtgccagcagccgcggtratacgaagggggctagcgttgttcggatttactgggcgtaaagcgcacgtaggcggacttttaagtcaggggtgaaatcccggggctcaaycccggaactgcctttgatactggaagtcttgagtatggtagaggtgagtggaattccgagtgtagaggtgaaattcgtagatattcggaggaacaccagtggcgaaggcggctcactggaccattactgacgctgaggtgcgaaagcgtggggagcaaacaggattagataccctggtagtccacgccgtaaacgatgaatgttagccgttggggagtttactcttcggtggcgcagctaacgcattaaacattccgcctggggagtacggtcgcaagattaaaactcaaaggaattgacgggggcccgcacaagcggtggagcatgtggtttaattygaagcaacgcgcagaaccttaccagcccttgacataccggtcgcggacacagagatgtgtctttcagttcggctggaccggatacaggtgctgcatggctgtcgtcagctcgtgtcgtgagatgttgggttaagtcccgcaacgagcgcaaccctcgcccttagttgccagcatttagttgggcactctaaggggactgccggtgataagccgagaggaaggtggggatgacgtcaagtcctcatggcccttacgggctgggctacacacgtgctacaatggtggtgacagtgggcagcgagcacgcgagtgtgagctaatctccaaaagccatctcagttcggattgcactctgcaactcgagtgcatgaagttggaatcgctagtaatcgcggatcagcatgccgcggtgaatacgttcccgggccttgtacacaccgcccgtcacaccatgggagttggttttacccgaaggcgctgtgctaaccgcaaggaggcaggcgaccacggtagggtcagcgactggggtgaagtcgtaacaaggtaaccgaagggcgat

SEQ ID NO: 48 - DNA, 1478 bp, unknown
  Unknown clone from enriched environmental sample that by rDNA sequence analysis has highest identity to Anaeurovorax sp/EH8A
tggctcaggatgaacgctggcggcgtgcctaacacatgcaagtcgagcggtatatagtggaatgaaacttcggtcgagtgaagctatagagagcggcggacgggtgagtaacgcgtaggcaacctgccccatacagagggatagcctcgggaaaccgggattaaaacctcataacgcgaggagttcacatggactgctcgccaaagattcatcggtatgggatgggcctgcgtctgattagctagttggtgaggtaacggctcaccaaggcgacgatcagtatccgacctgagagggtaatcggccacattggaactgagacacagtccaaactcctacaggaggcagcagtggggaatattgcacaatgggcgaaagcctgatgcaacaacgccgcgtgagcgatgaacgcctttgggtcgtaaagctctgtccttggggaagaaacaaatgacggtacccttggaagaagccccggctaactacgtgccagcagccgcggtaatacgtagggggcgagcgttatccggaattattgggcgtaaagagtgcgtacgtggctatgtaagcgcgaggtgaaaggcaatagcttaactattgtaagccttgcgaactgtgtggcttgggtgcaggacaggaaagtggaattcctattgtagcggtgaaatgcgtagatattaggaggaacaccactggcgaaggcgactttctggactgtaactgacactgaggcacgaaagcgtggggagcaaacaggattagataccctggtagtccacgccgtaaacgatgagcactaggtgtaggggtcgcaagacttcggtgccgcagttaacgcattaagtgctccgcctggggagtacgcacgcaagtgtgaaactcaaaggaattgacggggacccgcacaagcagcggagcatgtggtttaattcgaagcaacgcgaagaaccttatcagggcttgacatccgtatgacagtccgttaaccgggacgttcttcggacagaggagacaggtggtgcatggttgtcgtcagctcgtgtcgtgagatgttgggttaagtcccgcaacgagcgcaacccttgtctttagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 49 - DNA, 883 bp, unknown
  Unknown clone from enriched environmental sample that by rDNA sequence analysis has highest identity to Anaerovorax sp. EH8A
tggctcaggatgaacgctggcggcgtgcctaacacatgcaagtcgagcggtatatagtggaacgaaacttcggtcgagtgaagccatagagagcggcggacgggtgagtaacgcgtaggcaacctgccccatacagagggatagcctcgggaaaccgggattaaaacctcataacgcgaggagttcacatggacttctcgccaaagattcatcggtatgggatgggcctgcgtctgattagctagttggtgaggtaacggctcaccaaggcgacgatcagtagccgacctgagagggtaatcggccacattggaactgagacacggtccaaactcctacgggaggcagcagtggggaatattgcacaatgggcgaaagcctgatgcagcaacgccgcgtgagcgatgaaggcctttgggtcgtaaagctctgtccttggggaagaaacaaatgacggtacccttggaggaagccccggctaactacgtgccagcagccgcggtaatacgtagggggcgagcgttatccggaattattgggcgtaaagagtgcgtaggtggccatgtaagcgcggggtgaaaggcaatagcttaactattgtaagccttgcgaactgtgtggcttgagtgcaggagaggaaagtggaattcctagtgtagcggtgaaatgcgtagatattaggaggaacaccagtggcgaaggcgactttctggactgtaactgacactgaggcacgaaagcgtggggagcaaacaggattagataccctggtagtccacgccgtaaacgatgagcactaggtgtcggggtcgcaagacttcggtgccgcagttaacgcattaagtgctccgcctggggagtacgcacgcaagtgtgaaactca

SEQ ID NO: 50 - DNA, 521 bp, unknown
  Unknown clone from enriched environmental sample that by rDNA sequence analysis has highest identity to Finegoldia magna
acatgccactgaccgcatcagagatggtgctttaccttcgggtacagtggacacaggtggtgcatggttgtcgtcagctcgtgtcgtgagatgttgggttaagtcccgcaacgagcgcaacccctgtttctagttgccagcattaagttgggcactctagagagactgccgatgacaaatcggaggaaggtggggatgacgtcaaatcatcatgccctttatgccctgggctacacacgtgctacaatggtcggtacaacgaggagcaaaccagcgatggcaagcaaatctctaaaagccgatcccagttcggattgcaggctgcaactcgcctgcatgaagtcggagttgctagtaatcgcggatcagaatgtcgcggtgaatgcgttcccgggtcttgtacacaccgcccgtcacaccatgggagttgtcaatacccgaagccagtgagctaaccagtaatggaggcagctgtcgaaggtaggggcgatgactggggtgaagtcgtaacaaggtaaccg

SEQ ID NO: 51 - DNA, 888 bp, unknown
  Unknown clone from enriched environmental sample that by rDNA sequence analysis has highest identity to Finegoldia magna
tacgtaagcatttgaaactgtcagacttgagttaaggagaggaaagtggaattcctagtgtagcggtgaaatgcgtagatattaggaggaataccagtggcgaaggcgactttctggacttatactgacgctgaggaacgaaagcgtggggagcaaacaggattagataccctggtagtccacgccgtaaacgatgagtgctaggtgttgggggtcaaacctcggtgccgcagctaacgcattaagcactccgcctggggagtacgtacgcaagtatgaaactcaaaggaattgacggggacccgcacaagcagcggagcatgtggtttaattcgaagcaacgcgaagaaccttaccagggcttgacatgccgctgaccggtgcagagatgcatctttatccttcggggtacagcggacacaggtggtgcatggttgtcgtcagctcgtgtcgtgagatgttgggttaagtcccgcaacgagcgcaacccttgtctttagttgccatcattaagttgggcactctaaagagactgccgatgacaaatcggaggaaggtggggatgacgtcaaatcatcatgccctttatgtcctgggctacacacgtgctacaatggtcggtacaacgagaagcaagtcagcgatggcaagcaaatctctaaaagccgatcccagttcggattgcaggctgcaactcgcctgcatgaagtcggagttgctagtaatcgcggatcagaatgccgcggtgaatgcgttcccgggtcttgtacacaccgcccgtcacaccatgggagttgtcaatacccgaagccagtgagctaaccataaaaggaggcagctgtcgaaggtaggggcaatgactggggtgaagtcgtaacaaggtaaccg

SEQ ID NO: 52 - DNA, 888 bp, unknown
  Unknown clone from enriched environmental sample that by rDNA sequence analysis has highest identity to Finegoldia magna
tacgtaagcatttgaaactgtcagacttgagttaaggagaggaaagtggaattcctagtgtagcggtgaaatgcgtagatattaggaggaataccagtggcgaaggcgactttctggacttatactgacgcggaggaacgaaagcgtggggagcaaacaggattagataccctggtagtccacgccgtaaacgatgagtgctaggtgttgggggtcaaacctcggtgccgcagctaacgcattaagcactccgcctggggagtacgtacgcaagtatgaaactcaaaggaattgacggggacccgcacaagcagcggagcatgtggtttaattcgaagcaacgcgaagaaccttaccagggcttgacatgccgctgaccggtttagagatagatctttacccttcggggtacagcggacacaggtggtgcatggttgtcgtcagctcgtgtcgtgagatgttgggttaagtcccgcaacgagcgcaacccttgtctttagttgccatcattaagttgggcactctaaagagactgccgatgacaaatcggaggaaggtggggatgacgtcaaatcatcatgccctttatgtcctgggctacacacgtgctacaatggtcggtacaacgagaagcaagtcagcgatggcaagcaaatctctaaaagccgatcccagttcggattgcaggctgcaactcgcctgcatggagtcggagttgctagtaatcgcggatcagaatgccgcggtgaatgcgttcccgggtcttgtacacaccgcccgtcacaccatgggagttgtcaatacccgaagccagtgagctaaccataaaagggggcagctgtcgaaggtaggggcaatgactggggtgaagtcgtaacaaggtaaccg

SEQ ID NO: 53 - DNA, 1502 bp, unknown
  Unknown clone from enriched environmental sample that by rDNA sequence analysis has highest identity to Flexistipes sp. vp180
tggctcagaacgaacgctggcggcgtgcttaacacatgcaagtcaaggagaaagtctcttcggaggcgagtaaactggcgcacgggtgagtaacgcgtgaggaacctgcccatatgtctgggataacctgctgaaaagcgggctaatactggatatattgtttaccgcatggtgaacaaggaaagttggtgcaagctaacgcatatggatggtctcgcgtctgattagctagttggtggggtaaaggctcaccaaggcgacgatcagtagccggtctgagagggtggccggccacactgggactgagacacggcccagactcctacgggaggcagcagtggggaattttgcacaatgggggcaaccctgatgcagcgacgccgcgtgaacgaggaaggccttcgggtcgtaaagttctttcgacggggaagaaatgttatacgagtaactgcgtataatttgacggtacctgtagaagcagccccggctaactccgtgccagcagccgcggtaatacggagggggcgagcgttgttcggagttactgggcgtaaagcgcacgtaggcggtgcggtaagtcaggggttaaaggtcacagctcaactgtgataaggcctttgatactatcgtgctagagtgtcagagagggtagcggaattcccggtgtagcggtgaaatgcgtatatatcgggaggaacaccagtggcgaagggcggctacctggctgataactgacgctgaggtgcgagagcgtggggagcaaacaggattagataccctggtagtccacgctgtaaacgatggacgttaggtgttgggggaaccgaccccctcagtgccgaagctaacgcgttaaacgtcccgcctggggagtacggccgcaaggttgaaactcaaaggaattgacgggggcccgcacaagcggtggagcacgtggtttaattcgatgctaaccgaagaaccttacctgggtttgacatccctcgaatcctgtagagatatgggagtgcctggcttgccaggagcgaggagacaggtgctgcatggctgtcgtcagctcgtgccgtgaggtgttgggttaagtcccgcaacgagcgcaacccctatttttagttgccatcacgttaaggtgggcactctaaagagaccgccggggataacccggaggaaggtggggatgacgtcaagtcatcatggcccttatgtccagggctacacacgtgctacaatggtgcatacagagggcagcgagacagcgatgttaagcgaatcccttaaagtgtacctcagttcggattgcagtctgcaactcgactgtatgaagccggaatcgctagtaatcgcaggtcagcaaaactgcggtgaatacgttcccgggccttgtacacaccgcccgtcacaccacgggagtcggttgtacctgaagccggtggcccaaccgcaaggggggagccgtctatggtatggctggtaactggggtgaagtcgtaacaaggtaaccg

SEQ ID NO: 54 - DNA, 1499 bp, unknown
  Unknown clone from enriched environmental sample that by rDNA sequence analysis has highest identity to Azoarcus sp. EH11
agagtttgattatggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagagatcaggaggaacaccgatggcgaaggcagccccctgggcctgtactgacgctcatgcacgaaagcgtggggagcaaacaggattagataccctggtagtccacgccgtaaacgatgagtgctaggtgttgggggtcaaacctcggtgccgcagctaacgcattaagcactccgcctggggagtacgtacgcaagtatgaaactcaaaggaattgacggggacccgcacaagcagcggagcatgtggtttaattcgaagcaacgcgaagaaccttaccagggcttgacatgccgctgaccggtttagagatagacctttatccttcggggtacagcggacacaggtggtgcatggttgtcgtcagctcgtgtcgtgagatgttgggttaagtcccgcaacgagcgcaacccttgtcactagttgccagcatttagttgggcactctggtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgaccgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 55 - DNA, 1475 bp, unknown
  Unknown clone from enriched environmental sample that by rDNA sequence analysis has highest identity to Clostridium chartatabidium
tggctcaggacgaacgctggcggcgtgcctaacacatgcaagtcgagcggagaatgcagaaatgtttacatggaagtattcttagcggcggacgggtgagtaacacgtgggtaacctgcctcaaagtgggggatagccttccgaaaggaagattaataccgcataagcctacagtgccgcatggcacagcaggaaaaggagcaatccgctttgagatggacccgcggcgcattagctagttggtgaggtaacggctcaccaaggcgacgatgcgtagccgacctgagagggtgatcggccacattggaactgagacacggtccagactcctacgggaggcagcagtggggaatattgcacaatgggcgaaagcctgatgcagcaacgccgcgtgagtgatgaaggccttcgggtcgtaaagctctttgatcagggatgataatgacagtacctgaaaaacaagccacggctaactacgtgccagcagccgcggtaatacgtaggtggcgagcgttgtccggaattactgggcgtaaaggatgcgtaggtggatacttaagtgggatgtgaaatccccgggctcaacccgggaactgcattccaaactgggtatctagagtgcaggagaggaaagcggaattcctagtgtagcggtgaaatgcgtagagatcaggaggaacaccgatggcgaaggcagccccctgggcctgtactgacgctcatgcacgaaagcgtggggagcaaacagggatagataccctggtagtccacgccctaaacgatgtcgaataagtcgttccgaccagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggcttcaccagaagtaggtagcttaaccttcgggagggcgcttaccacggtgagattcatgactggggtgaagtcgtaacaaggtaaccg

SEQ ID NO: 56 - DNA, 1492 bp, unknown
  Unknown clone from enriched environmental sample that by rDNA sequence analysis has highest identity to Deferribacter desulfuricans
tggctcagaacgaacgctggcggcgtgcttaacacatgcaagtcaaggagaaagtctcttcggaggcgagtaaactggcgcacgggtgagtaacgcgtgaggaacctgcccatatgtctgggataacctgctgaaaagcgggctaatactggatatattgtttaccgcatggtgaacaaggaaagttggtgcaagctaacgcatatggatggtctcgcgtctgattagctagttggtggggtaaaggctcaccaaggcaacgatcagtagccggtctgagagggtggccggccacactgggactgagacacggcccagactcctacgggaggcagcagtggggaattttgcacaatgggggcaaccctgatgcagcgacgccgcgtgaacgaggaaggccttcgggtcgtaaagttctttcgacggggaagaaatgttatacgagtaactgcgtataatttgacggtacccgtagaagcagccccggctaactccgtgccagcagccgcggtaatacggagggggcgagcgttgttcggagttactgggcgtaaagcgcacgtacgcggtgcggtaagtcaggggttaaaggtcacagctcaactgtgataaggcctttgatactatcgtgctagagtgtcagagagggtagcggaattcccggtgtagcggtgaaatgcgtagatatcgggaggaacaccagtagcgaaggcggctacctggctgataactgacgctgaggtgcgagagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccg

SEQ ID NO: 57 - DNA, 1519 bp, unknown
  Unknown clone from enriched environmental sample that by rDNA sequence analysis has highest identity to Azotobacter beijerinckii
tggctcagaacgaacgctggcggcgtgcttaacacatgcaagtcaaggggaaagtctcttcggaggcgagtaaactggcgcacgggtgagtaacgcgtgaggaacctgcccatatgtctgggataacctgctgaaaagcgggctaatactggatatattgtttaccgcatggtgaacaaggaaagttggtgcaagctaacgcatatggatggtctcgcgtctgattagctagttggtggggtaaaggctcaccaaggcaacgatccgtagcgggtctgagaggatggtccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtagcagtgaaatgcgtagagatcaggaggaacaccgatggcgaaggcagccccctgggcctgtactgacgctcatgcacgaaagcgtggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtaaatacgttcccgggtcttgtacacaccgcccgtcacaccatgggagtgggtttcaccagaagtaggtagcttaaccttcgggagggcgcttaccacggtgagattcatgactggggtgaagtcgtaacaaggtaaccgaagggcgaatcaatcgcctatgactgg

SEQ ID NO: 58 - DNA, 373 bp, unknown
  Unknown clone from enriched environmental sample that by rDNA sequence analysis has highest identity to Flexistipes sp. vp180
tggctcagaacgaacgctggcggcgtgcttaacacatgcaagtcaaggagaaaatctcttcgggggcgagtaaactggcgcacgggtgagtaacgcgtgaggaacctgcccatatgtctgggataacctgctgaaaagcgggctaatactggatatattgtttaccgcatggtggacaaggaaagttggtgtaagctaacgcatatggatggtctcgcgtctgattagctagttggtggggtaaaggctcaccaaggcgacgatcagtagccggtctgagagggtggccggccacactgggactgagacacggcccatactcctacgggaggcagcagtggggaattttgcacaatgggggcaaccctgatgc

SEQ ID NO: 59 - DNA, 1431 bp, unknown
  Unknown clone from enriched environmental sample that by rDNA sequence analysis has highest identity to Ochrobactrum lupini
tggctcagaacgaacgctggcggcaggcttaacacatgcaagtcgagcgccccgcaaggagagcggcagacgggtgagtaacgcgtgggaacgtaccttttgctacggaataactcagggaaacttgtgctaataccgtatgtgcccttcgggggaaagatttatcggcaaaggatcggcccgcgttggattagctagttggtgaggtaaaggctcaccaaggcgacgatccatagctggtctgagaggatgatcagccacactgggactgagacacggcccagactcctacgggaggcagcagtggggaatattggacaatgggcgcaagcctgatccagccatgccgcgtgagtgatgaaggccctagggttgtaaagctctttcaccggtgaagataatgacggtaaccggagaagaagccccggctaacttcgtgccagcagccgcggtaatacgaagggggctagcgttgttcggatttactgggcgtaaagcgcacgtaggcggacttttaagtcaggggtgaaatcccggggctcaaccccggaactgcctttgatactggaagtcttgagtatggtagaggtgagtggaattccgagtgtagaggtgaaattcgtagatattcggaggaacaccagtggcgaaggcggctcactggaccattactgacgctgaggtgcgaaagcgtggggagcaaacaggattagataccctggtagtccacgccgtaaacgatgaatgttagccgttggggagtttactcttcggtggcgcagctaacgcattaaacattccgcctggggagtacggtcgcaagattaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgccactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatrcgttcccgggtcttgtacacaccgcccgtcacaccatgggagtgggtttcaccagaagtaggtagcttaaccttcgggagggcacttaccacggtgagattcatgactggggtgaagtcgtaacaaggtaaccg

SEQ ID NO: 60 - DNA, 1454 bp, unknown
  Unknown clone from enriched environmental sample that by rDNA sequence analysis has highest identity to Pseudomonas pseudoalcligenes
tggctcagattgaacgctggcggcaggcctaacacatgcaagtcgagcggatgagtggagcttgctccatgattcagcggcggacgggtgagtaatgcctaggaatctgcctggtagtgggggacaacgtttcgaaaggaacgctaataccgcatacgtcctacgggagaaagtgggggatcttcggacctcacgctatcagatgagcctaggtcggattagctagttggcgaggtaaaggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggcagtaagttaataccttgctgttttgacgttaccgacagaataagcaccggctaacttcgtgccagcagccgcggtaatacgaagggtgcaagcgttaatcggaattactgggcgtaaagcgcgcgtaggtggttcgttaagttggatgtgaaagccccgggctcaacctgggaactgcatccaaaactggcgagctaagttatggcagaggggggtggaaatttcctgtgtagcggtgaaatgggtagatataggaaggaacaccagtggcgaaggcgaccacctgggctaatactgacactgaggtgcgaaagcgtggggagcaaacaggattagataccctggtagtccacgccgtaaacgatgtcgactagccgttgggatccttgagatcttagtggcgcagctaacgcattaagtcgaccgcctggggagtacggccgcaaggttaaaactcaaatgaattgacgggggcccgcacaagcggtggagcatgtggtttaattcgaagcaacgcgaagaaccttaccaggccttgacatgctgagaacctgccagagatggcggggtgccttcgggaactcagacacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggcctgggctacacacgtgctacaatggtcggtacaaagggttgccaagccgcgaggtggagctaatcccataaaaccgatcgtagtccggatcgcagtctgcaactcgactgcgtgaagtcggaatcgctagtaatcgtgaatcagaatgtcacggtgaatacgttcccgggccttgtacacaccgcccgtcacaccatgggagtgggttgctccagaagtagctagtctaaccttcggggggacggttaccacggagtgat

SEQ ID NO: 61 - DNA, 854 bp, unknown
  Unknown clone from enriched environmental sample that by rDNA sequence analysis has highest identity to Pseudomonas purida
tgggaactgcatccaaaactggcgagctagagtatggcagagggtggtggaatttcctgtgtagcggtgaaatgcgtagatataggaaggaacaccagtggcgaaggcgaccacctgggctaatactgacactgaggtgcgaaagcgtggagagcaaacaggattagataccctggtagtccacgccgtaaacgatgtcgactagccgttgggatccttgagatcttagtggcgcagctaacgcattaagtcgaccgcctggggagtacggccgcaaggttaaaactcaaatgaattgacgggggcccgcacaagcggtggagcatgtggtttaattcgaagcaacgcgaagaaccttaccaggccttgacatgcagagaactttccagagatggattggtgccttcgggagctctgacacaggtgctgcatggctgtcgtcagctcgtgtcgtgagatgttgggttaagtcccgtaacgagcgcaacccttgtccttagttaccagcacgttaaggtgggcactctaaggagactgccggtgacaaaccggaggaaggtggggatgacgtcaagtcatcatggcccttacggcctgggctacacacgtgctacaatggtcggtacaaagggttgccaagccgcgaggtggagctaatcccataaaaccgatcgtagtccggatcgcagtctgcaactcgactgcgtgaagtcggaatcgctagtaatcgtgaatcagaatgtcacggtgaatacgttcccgggccttgtacacaccgcccgtcacaccatgggagtgggttgctccagaagtagctagtctaaccttcggggggacggttaccacggagtgat

SEQ ID NO: 62 - DNA, 854 bp, unknown; identical to SEQ ID NO: 61
  Unknown clone from enriched environmental sample that by rDNA sequence analysis has highest identity to Pseudomonas pseudoalcligenes

SEQ ID NO: 63 - DNA, 1448 bp, unknown
  Unknown clone from enriched environmental sample that by rDNA sequence analysis has highest identity to Clostridium chartatabidium
tggctcaggacgaacgctggcggcgtgcctaacacatgcaagtcgagcggagaatgcagaaatgtttacatggaagcgttcttagcggcggacgggtgagtaacacgtgggtaacctgcctcaaagtgggggatagccttccgaaaggaagattaataccgcataagcctacagtgccgcatggcacagcaggaaaaggagcaatccgctttgagatggacccgcggcgcattagctagttggtgaggtaacggctcaccaaggcgacgatgcgtagccgacctgagagggtgatcggccacattggaactgagacacggtccagactcctacgggaggcagcagtggggaatattgcacaatgggcgaaagcctgatgcagcaacgccgcgtgagtgatgaaggccttcgggtcgtaaagctctttgatcagggatgataatgacagtacctgaaaaacaagccacggctaactacgtgccagcagccgcggtaatacgtaggtggcgagcgttgtccggaattactgggcgtaaaggatgcgtaggtggatacttaagtgggatgtgaaatccccgggctcaacccgggaactgcattccaaactgggtatctagagtgcaggagaggaaagcggaattcctagtgtagcggtgaaatgcgtagatattaggaggaacaccagtggcgaaggcggctttctggactgtaactgacactgaggcatgaaagcgtgggtagcaaacaggattagataccctggtagtccacgccgtaaacgatgggtactaggtgtaggaggtatcgaccccttctgtgccgtcgttaacacaataagtaccccgcctggggagtacggtcgcaagactaaaactcaaaggaattgacgggggcccgcacaagcagcggagcatgtggtttaattcgaagcaacgcgaagaaccttacctagacttgacatctcctgaattacccttaaccggggaagcccttcggggcaggaagacaggtggtgcatggttgtcgtcagctcgtgtcgtgagatgttgggttaagtcccgcaacgagcgcaacccttatttttagttgctaccatttggttgagcactctaaagagactgcccgggttaaccgggaggaaggtggggatgacgtcaaatcatcatgccccttatgtctagggctacacacgtgctacaatggtgagaacaaagagacgcgagaccgcgaggtggagcaaatctcataaaactcatcccagttcggattgcaggctgaaactcgcctgcatgaagccggagttgctagtaatcgcgaatcagcatgtcgcggtgaatacgttcccgggccttgtacacaccgcccgtcacaccatgagagttggcaatacccgaagtccgtggggcaaccagttaatggagccagcggccgaaggtagggtcagcgat

SEQ ID NO: 64 - DNA, 1486 bp, unknown
  Unknown clone from enriched environmental sample that by rDNA sequence analysis has highest identity to Finegoldia magna
tggctcaggacgaacgctggcggcgtgcctaacacatgcaagtcgagcgaagtgactcggagagaagttttcgaatggatcgaagagtcatcttagcggcggacgggtgagtaacgcgtgagaaacctgcctttcacaaagggatagcctcgggaaactgggattaataccttatgaaactgaattaccgcatggtagatcagtcaaagcgaataagcggtgaaagatggtctcgcgtcctattagctagttggtgaggtaacggctcaccaaggcttcgataggtagccggcctgagagggtgaacggccacactggaactgagacacggtccagactcctacgggaggcagcagtggggaatattgcacaatggaggaaactctgatgcagcgacgccgcgtgaatgatgaaggccttcgggttgtaaagttctgtccttggggaagataatgacggtacccaaggaggaagccccggctaactacgtgccagcagccgcggtaatacgtagggggcgagcgttgtccggaattattgggcgtaaagggttcgcaggcggtctgataagtcagatgtgaaaggcgtaggctcaacctacgtaagcatttgaaactgtcagacttgagttaaggagaggaaagtggaattcctagtgtagcggtgaaatgcgtagatattaagaggaataccagtggcgaaggcgactttctggacttatactgacgcttaggaacgaaagcgtggggagcaaacaggattagataccctggtagtccacgccgtaaacgatgagtgctaggtgttgggggtcaaacctcggtgccgcagctaacgcattaagcactccgcctggggagtacgtacgcaagtatgaaactcaaaggaattgacggggacccgcacaagcagcggagcatgtggtttaattcgaagcaacgcgaagaaccttaccagggcttgacatgccgctgaccggtttagagatagacctttatccttcggggtacagcggacacaggtggtgcatggttgtcgtcagctcgtgtcgtgagatgttgggttaagtcccgcaacgagcgcaacccttgtctttagttgccatcattaagttgggcactctaaagagactgccgatgacaaatcggaggaaggtgggggtgacgtcaaatcatcatgccctttatgtcctgggctacacacgtgctacaatggtcggtacaacgagaagcaagccagcgatggcaagcaaatctctaaaagccgatcccagttcggattgcaggctgcaactcgcctgcatgaagtcggagttgctagtaatcgcggatcagaatgccgcggtgaatgcgttcccgggtcttgtacacaccgcccgtcacaccatgggagttgtcaatacccgaagccagtgagctaaccataaaagggggcagctgtcgaaggtaggggcaatgactggggtgaagtcgtaacaaggtaaccg

SEQ ID NO: 65 - DNA, 881 bp, unknown
  Unknown clone from enriched environmental sample that by rDNA sequence analysis has highest identity to Finegoldia magna
tggctcaggacgaacgctggcggcgtgcctaacacatgcaagtcgagcgaagtgactcggagagaaattttcggatggatcgaagagtcatcttagcggcggacgggtgagtaacgcgtgagaaacctgcctttcacaaagggatagcctcgggaaactgggattaataccttatgaaactgaattaccgcatggtagatcagtcaaagcgaataagcggtgaaagatggtctcgcgtcctattagctagttggtgaggtaacggctcaccaaggcttcgataggtagccggcctgagagggtgaacggccacactggaactgagacacggtccagactcctacgggaggcagcagtggggaatattgcacaatggaggaaactctgatgcagcgacgccgcgtgaatgatgaaggccttcgggttgtaaagttctgtccttggggaagataatgacggtacccaaggaggaagccccggctaactacgtgccagcagccgcggtaatacgtagggggcgagcgttgtccggaattattgggcgtaaagggttcgcaggcggtctgataagtcagatgtgaaaggcgtaggctcaacctacgtaagcatttgaaactgtcagacttgagttaaggagaggaaagtggaattcctagtgtagcggtgaaatgcgtagatattaggaggaataccagtggcgaaggcgactttctggacttatactgacgctgaggaacgaaagcgtggggagcaaacaggattagataccctggtagtccacgccgtaaacgatgagtgctaggtgttgggggtcaaacctcggtgccgcagctaacgcattaagcactccgcctggggagtacgtacgcaagtatgaaact

SEQ ID NO: 66 - DNA, 1393 bp, unknown
  Unknown clone from enriched environmental sample that by rDNA sequence analysis has highest identity to Finegoldia magna
tggctcaggacgaacgctggcggcgtgcctaacacatgcaagtcgagcgaagtgactctgagagaaattttcggatggatcgaagagtcatcttagcggcggacgggtgagtaacgcgtgagaaacctgcctttcacaaagggatagcctcgggaaactgggattaataccttatgaaactgaattaccgcatggtagatcagtcaaagcgaataagcggtgaaagatggtctcgcgtcctattagctagttggtgaggtaacggctcaccaaggcttcgataggtagccggcctgagagggtgaacggccacactggaactgagacacggtccagactcctacgggaggcagcagtggggaatattgcacaatggaggaaactctgatgcagcgacgccgcgtgaatgatgaaggccttcgggttgtaaagttctgtccttggggaagataatgacggtacccaaggaggaagccccggctaactacgtgccagcagccgcggtaatacgtagggggcgagcgttgtccggaattattgggcgtaaagggttcgcaggcggtctgataagtcagatgtgaaaggcgtaggctcaacctacgtaagcatttgaaactgtcagacttgagttaaggagaggaaagtggaattcctagtgtagcggtgaaatgcgcagatattaggaggaataccagtggcgaaggcgactttctggacttatactgacgctgaggaacgaaagcgtggggagcaaacaggattagataccctggtagtccacgccgtaaacgatgagtgctaggtgttgggggtcaaacctcggtgccgcagctaacgcattaagcactccgcctggggagtacgtacgcaagtatgaaactcaaaggaattgacggggacccgcacaagcagcggagcatgtggtttaattcgaagcaacgcgaagaaccttaccagggcttgacatgccgctgaccggtttagagatagatctttatccttcggggtacggcggacacaggtggtgcatggttgtcgtcagctcgtgtcgtgagatgttgggttaagtcccgcaacgagcgcaacccttgtctttagttgccatcattaagttgggcactctaaagagactgccgatgacaaatcggaggaaggtggggatgacgtcaaatcatcatgccctttatgtcctgggctacacacgtgctacaatggtcggtacaacgagaagcaagtcagcgatggcaagcaaatctctaaaagccgatcccagttcggattgcaggctgcaactcgcctgcatgaagtcggagttgctagtaatcgcggatcagaatgccgcggtgaatgcgttcccgggtcttgtacacaccgcccgtcacaccatgggagt

SEQ ID NO: 67 - DNA, 1440 bp, unknown
  Unknown clone from enriched environmental sample that by rDNA sequence analysis has highest identity to Thauera aromatica
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagtgggggatcttcggacctcacgctatcagatgagcctaggtcggattagctagttggcgaggtaaaggctcaccaaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaagggggtggaattcctggtgtancantgaaatgcgtaaagatcaagaggaacaccgatggcgaaagcagccccctgggcctgtactgaccctcatgcacgaaagcgtggggagcaaacaagattaaataccctggtagtccacgccctaaacgatgtcgactagtcgtttggagcagcaatgcactgagtgacgcagctaacgcgtgaagtcgaccgcctggggagtacggccgcaaggttaaaactcaaaggaattgacggggacccgcacaagcggtggatgatgtggattaatttgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttagagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgctt

SEQ ID NO: 68 - DNA, 1452 bp, unknown
  Unknown clone from enriched environmental sample that by rDNA sequence analysis has highest identity to Thauera aromatica
tggctcaggacgaacgctgacggcgtgcctaacacatgcaagtcgagcggagaatgcagaaatgtttacatggaagtattcttagcggcggacgggtgagtaacacgtgggtaacctgcctcaaagtgggggatagccttccgaaaggaagattaataccgcataagcctacagtgccgcatggcacagcaggaaaaggagcaatccgctttgagatggacccgcggcgcattagctagttggtgaggtaacggctcaccaaggcgacgatgcgtagccgacctgagagggtgatcggccacattggaactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaagctagagtacggcagaagggggtggaattcctggtgtagcagtgaaatgcgtagagatcaggaggaacaccgatggcgaaggcagccccctggggcctgtactgacgctcatgcacgaaagcggggggagcaaacaggattagataccctggtagtccacgccctaaacgatgtcgactagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 69 - DNA, 1440 bp, unknown
  Unknown clone from enriched environmental sample that by rDNA sequence analysis has highest identity to Azoarcus sp. EH21
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgtgactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggatgacggtaccggactaagaagcaccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtttgtgactgcaaggctagagtacggcagaggggggtggaattcctggtgtaacaatgaaatgcgtagagatcaggaggaacacggatggcgaaggcagccccctgggcctgtactgacgctcatgcacgaaagcgtggggagcaaacaggattagataccctggtagtccacgccgtaaacgatgtcgactagccgttgggatccttgagatcttagtggcgcagctaacgcattaagtcgaccgcctggggagtacggccgcaaggttaaaactcaaatgaattgacgggggcccgcacaagcggtggagcatgtggtttaattcgaagcaacgcgaagaaccttaccaggccttgacatgcagagaactttccagagatggattggtgccttcgggagctctgacacaggtgctgcatggctgtcgtcagctcgtgtcgtgagatgttgggttaagtcccgtaacgagcgcaacccttgtccttagttaccagcacgttaaggtgggcactctaaggagactgccggtgacaaaccggaggaaggtggggatgacgtcaagtcatcatggcccttacggcctgggctacacacgtgctacaatggtcggtacaaagggttgccaagccgcgaggtggagctaatcccataaaaccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 70 - DNA, 1438 bp, unknown
  Unknown clone from enriched environmental sample that by rDNA sequence analysis has highest identity to Azotobacter beijerinckii
tggctcaggacgaacgctggcggcgtgcctaacacatgcaagtcgagcgaagtgactctgagagaaattttcggatggatcgaagagtcatcttagcggcggacgggtgagtaacgcgtgagaaacctgcctttcacaaagggatagcctcgggaaactgggattaataccttatgaaactgaattaccgcatggtagatcagtcaaagcgaataagcggtgaaagatggtctcgcgtcctattagctagttggtgaggtaacggctcaccaaggcttcgataggtagccggcctgagagggtgaacggccacactggaactgagacacggtccagactcctacgggaggcagcagtggggaatattgcacaatggaggaaactctgatgcagcgacgccgcgtgaatgatgaaggccttcgggttgtaaagttctgtccttggggaagataatgacggtacccaaggaggaagccccggctaactacgtgccagcagccgcggtaatacgtagggtgcgagcgttaatcggaattactgggcgtaaagcgtgcgcaggcggttttgtaagacagatgtgaaatccccgggctcaacctgggaactgcgtctgtgactgcaaggctagagtacggcagaggggggtggaattcctggtgtagcagtgaaatgcgtacagatcacgaggaacaccgatggcgaaggcagccccctggccctgtactgacgttcatgcacaaaagcgtggggagcaaacagggattagataccctggtagtccacgccctaaacgatgttgattagtcgttcggagcagcaatgcactgagtgacgcagctaacgcgtgaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 71 - DNA, 1437 bp, unknown
  Unknown clone from enriched environmental sample that by rDNA sequence analysis has highest identity to Azotobacter beijerinckii
tggctcagattgaacgctggcggcaggcctaacacatgcaagtcgagcggatgagtggagcttgctccatgattcagcggcggacgggtgagtaatgcctaggaatctgcctggtagtgggggacaacgtttcgaaaggaacgctaataccgcatacgtcctacgggagaaagtgggggatcttcggacctcacgctatcagatgagcctaggtcggattagctagttggtgaggtaaaggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggcagtaagttaataccttgctgttttgacgttaccgacagaataagcaccggctaacttcgtgccagcagccgcggtaatacgaagggtgcaagcgttaatcggaattactgggcgtaaagcgcgcgtaggtggttcgttaagttggatgtgaaagccccgggctcaacctgggaactgcatccaaaactagcgagctagagtatggcagagggtggtggaatttcctgtgtagcggtgaaatgcgtagatataggaaggaacaccagtggcgaaggcgaccacctggggtaatactgacactgaagtgcgaaagcggggggagcaaacaggattagataccctggtattccacgccgtaaacgatgtcgactagccgttgggatccttgagatcttagtggcgcagctaacgcattaagtcgaccgcctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 72 - DNA, 1452 bp, unknown
  Unknown clone from enriched environmental sample that by rDNA sequence analysis has highest identity to Azotobacter beijerinckii
agagtttgattctggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctcacctaggcgacgatccgtagcgggtctgagaggatgatccgccacactgggactgagacacggcccagactcctacgggaggcagcagtggggaattttggacaatgggcgcaagcctgatccagccatgccgcgtgagtgaagaaggccttcgggttgtaaagctctttcggccgggaagaaatcgtggtctctaacataggccatggttgacgttaccgacagattaagcaccggctaacttcgtgccagcagccgcggtaatacgaagggtgcaagcgttaatcggaattactgggcgtaaagcgcgcgtaggtggttcgttaagttggatgtgaaagccccgggctcaacctgggaactgcatccaaaactggcgagctagagtatggcagagggtggtggaatttcctgtgtagcggtgaaatgcgtacatataggaaggaacaccagtggcgaaggcgaccacctgggctaatactgacactgaggtgcgaaagcgtggggagcaaacaggattagataccctggtagtccacgccgtaaacgatgtcgactagccgttgggatccttgagatcttagtggcgcagctaacgcattaagtcgaccgcctggggagtacggccgcaaggttaaaactcaaatgaattgacgggggcccgcacaagcggtggagcatgtggtttaattcgaagcaacgcgaagaaccttaccaggccttgacatgctgagaacctgccagagatggcggggtgccttcgggaactcagacacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggcctgggctacacacgtgctacaatggtcggtacaaagggttgccaagccgcgaggtggagctaatcccataaaaccgatcgtagtccggatcgcagtctgcaactcgaccgcgtgaagtcggaatcgctagtaatcgtgaatcagaatgtcacggtgaatacgttcccgggccttgtacacaccgcccgtcacaccatgggggtgggttgctccagaagtagctagtctaaccttcggggggacggt

SEQ ID NO: 73 - DNA, 893 bp, unknown
  Unknown clone from enriched environmental sample that by rDNA sequence analysis has highest identity to Azotobacter beijerinckii
cggttaccttgttacgacttcaccctcctcgccggacgtaccttcggaaccgccccccctcgcgggttgggctggcgacttcgggtacccccgactcggatggtgtgacgggcggtgtgtacaaggcccgggaacgtattcaccgcgccatgctgatgcgcgattactagcgattccaacttcatggagtcgggttgcagactccaatccgtactgggaccggctttaagggattggctccacctcgcggcttggcaaccctctgtaccgaccattgtatgacgtgtgaagccctacccataagggccatgaggacttgacgtcatccccaccttcctccggtttgtcaccggcagtctcactagagtgcccaaccaaatgatggcaactagtgacaagggttgcgctcgttgcgggacttaacccaacatctcacgacacgagctgacgacagccatgcagcacctgtgtccaggctcccgaaggcaccctcgcctctcggcaaggttcctggcatgtcaagggtaggtaaggtttttcgcgttgcatcgaattaatccacatcatccaccgcttgtgcgggtccccgtcaattcctttgagttttaaccttgcggccgtactccccaggcggtcgacttcacgcgttagctgcgtcactcagtgcattgctgctccgaacgactagtcgacatcgtttagggcgtggactaccagggtatctaatcctgtttgctccccacgctttcgtgcatgagcgtcagtacaggcccagggggctgccttcgccatcggtgttcctcctgatctctacgcatttcactgctacaccaggaattccacccccctctgccgtactctagccttgcagtcacaaacgcagttcccaggtt

SEQ ID NO: 74 - DNA, 846 bp, unknown
  Unknown clone from enriched environmental sample that by rDNA sequence analysis has highest identity to Azotobacter beijerinckii
agcggtttgtagacagatgtgaatcccggctcaactggactgcgtttgatgcaagctagagtcgcagagggggggaatctgtgtagcagtgaatgcgtagagatcagaggacacgatgcgaagcagcccctgggctgtactgacgtcatgcacgaaagcgggggagcaaacaggattagatacctggtagtcacgcctaaacgatgtcgactagtcgtcggagcagcaatgcactgagtgacgcagctaacgcgtgaagtcgaccgctggggagtacggccgcaaggttaaaactcaaaggaattgacggggacccgcacaagcggtggatgatgtggattaattcgatgcaacgcgaaaaaccttacctacccttgacatgccaggaaccttgccgagaggcgagggtgccttcgggagcctggacacaggtgctgcatggctgtcgtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 75 - DNA, 1426 bp, unknown
  Unknown clone from enriched environmental sample that by rDNA sequence analysis has highest identity to Clostridium chartatabidium
tggctcaggacgaacgctggcggcgtgcctaacacatgcaagtcgagcggagaatgcagaaatgtttacatggaagtattcttagcggcggacgggtgagtaacacgtgggtaacctgcctcgaagtgggggatagccttccgaaaggaagattaataccgcataagcctacagtgccgcatggcacagcaggaaaaggagcaatccgctttgagatggacccgcggcgcattagctagttggtgaggtaacggctcaccaaggcgacgatgcgtagccgacctgagagggtgatcggccacattggaactgagacacggtccagactcctacgggaggcagcagtggggaatattgcacaatgggcgaaagcctgatgcagcaacgccgcgtgagtgatgaaggccttcgggtcgtaaagctctttgatcagggatgataatgacagtacctgaaaaacaagccacggctaactacgtgccagcagccgcggtaatacgtaggtggcgagcgttgtccggaattactgggcgtaaaggatgcgtaggtggatacttaagtgggatgtgaaatccccgggctcaacccgggaactgcattccaaactgggtatctagagtgcaggagaggaaagcggaattcctagtgtagcggtgaaatgcgtagatattaggaggaacaccagtggcgaaggcggctttctggactgtaactgacactgaggcatgaaagcgtgggtagcaaacaggattagataccctggtagtccacgccgtaaacgatgggtactaggtgtaggaggtatcgaccccttctgtgccgttgttaacacaataagtaccccgcctggggagtacggtcgcaagactaaaactcaaaggaattgacgggggcccgcacaagcagcggagcatgtggtttaattagaagcaacgcgaaaaaccttacctacccttgacatgccaggaaccttgccgagaggcgagggtgccttcgggagcctggacacaggtgctgcatggctgtagtcagctcgtgtcgtgagatgttgggttaagtcccgcaacgagcgcaacccttgtcactagttgccatcatttggttgggcactctagtgagactgccggtgacaaaccggaggaaggtggggatgacgtcaagtcctcatggcccttatgggtagggcttcacacgtcatacaatggtcggtacagagggttgccaagtcgtgaggtggagccaatcccttaaagccgatcgtagtccggatcgtagtctgcaactcgactacgtgaagtcggaatcgctagtaatcgcagatcagcatggtgcggtgaatacgttcccgggtcttgtacacaccgcccgtcacaccatgggagtgggtttcaccagaagtaggtagcttaaccttcgggagggcgct

SEQ ID NO: 76 - DNA, 1420 bp, unknown
  Unknown clone from enriched environmental sample that by rDNA sequence analysis has highest identity to Clostridium aceticum
tggctcagattgaacgctggcggcatgctttacacatgcaagtcgaacggcagcgggggcttcggcctgccggcgagtggcgaacgggtgagtaatgcatcggaacgtgcccatgtcgtgggggataacgtatcgaaaggtacgctaataccgcatacgtcctgagggagaaagcgggggatcttcggacctcgcgcgattggagcggccgatgtcggattagctagtaggtgaggtaaaggctaacctaggcgacgatccgtagcgggtctgagagggtgaacggccacactggaactgagacacggtccagactcctacgggaggcagcagtggggaatattgcacaatggaggaaactctgatgcagcgacgccgcgtgaatgatgaaggccttcgggttgtaaagttctgtccttggggaagataatgacggtacccaaggaggaagccccggctaactacgtgccagcagccgcggtaatacgtagggggcgagcgttgtccggaattattgggcgtaaagggttcgcaggcggtctgataagtcagatgtgaaaggcgtaggctcaacctacgtaagcatttgaaactgtcagacttgagttaaggagaggaaagtggaattcctagtgtagcggtgaaatgcgtagatattaggaggaataccagtggcgaaggcgactttctggacttatactgacgctgaggaacgaaagcgtggggagcaaacaggattagataccctggtagtccacgccgtaaacgatgagtgctaggtgttgggggtcaaacctcggtgccgcagctaacgcattaagcactccgcctggggagtacgtacgcaagtatgaaactcaaaggaattgacggggacccgcacaagcagcggagcatgtggtttaattcgaagcaacgcgaagaaccttaccagggcttgacatgccgctgaccggtttagagatagatctttacccttcggggtacagcggacacaggtggtgcatggttgtcgtcagctcgtgtcgtgagatgttgggttaagtcccgcaacgagcgcaacccttgtctttagttgccatcattaagttgggcactctaaagagactgccgatgacaaatcggaggaaggtggggatgacgtcaaatcatcatgccctttatgtcctgggctacacacgtgctacaatggtcggtacaacgagaagcaagtcagcgatggcaagcaaatctctaaaagccgatcccagttcggattgcaggctgcaactcgcctgcatgaagtcggagttgctagtaatcgcggatcagaatgccgcggtgaatgcgttcccgggtcttgtacacaccgcccgtcacaccatgggagttgtcaatacccgaagccagtgagctaaccataaaaggaggcagctgtcga

SEQ ID NO: 77 - DNA, 1430 bp, unknown
  Unknown clone from enriched environmental sample that by rDNA sequence analysis has highest identity to Deferribacter desulfuricans
agagtttgattatggctcagaacgaacgctggcggcgtgcttaacacatgcaagtcaaggagaaagtctcttcgggggcgagtaaactggcgcacgggtgagtaacgcgtgaggaacctgcccatatgtctgggataacctgctgaaaagcgggctaatactggatatattgtttaccgcatggtggacaaggaaagttggtgtaagctaacgcatatggatggtctcgcgtctgattagctagttggtggggtaaaggctcaccaaggcaacgatcagtagcgggtctgagaggatgatccgccacactgggactgagacacggcccagactcctacgggaggcagcagtggggaatattgcacaatgggcgaaagcctgatgcagcaacgccgcgtgagtgatgaaggccttcgggtcgtaaagctctttgatcagggatgataatgacagtacctgaaaaacaagccacggctaactacgtgccagcagccgcggtaatacgtatgtggcgagcgttgtccggaattattgggcgtaaagggttcgcaggcggtctgataagtcagatgtgaaaggcgtaggctcaacctacgtaagcatttgaaactgtcagacttgagttaaggagaggaaagtggaattcctagtgtagcggtgaaatgcgtagatattaggaggaataccagtggcgaaggcgactttctggacttatactgacgctgaggaacgaaagcgtggggagcaaacaggattagataccctggtagtccacgccgtaaacgatgagtgctaggtgttgggggtcaaacctcggtgccgcagctaacgcattaagcactccgcctggggagtacgtacgcaagtatgaaactcaaaggaattgacggggacccgcacaagcagcggagcatgtggtttaattcgaagcaacgcgaagaaccttaccagggcttgacatgccgctgaccggtttagagatagatctttacccttcggggtacggcggacacaggtggtgcatggttgtcgtcagctcgtgtcgtgagatgttgggttaagtcccgcaacgagcgcaacccttatttttagttgctaccattcagttgagcactctaaagagactgcccgggttaaccgggaggaaggtggggatgacgtcaaatcatcatgccccttatgtctagggctacacacgtgctacaatggtcggtacagagggttgccaagccgcgaggtggagccaatcccttaaagccgatcgtagtccggatcgtagtctgcaactcgactacgtgaagtcggaatcgctagtaatcgcagatcagcatgctgcggtgaatacgttcccgggtcttgtacacaccgcccgtcacaccatgggagtgggtttcaccagaagtaggtagcttaaccttcgggagggcgct

SEQ ID NO: 78 - DNA, 1436 bp, unknown
  Unknown clone from enriched environmental sample that by rDNA sequence analysis has highest identity to Bacteroides sp. EH30
tggctcaggatgaacgctagcggcaggcttaatacatgcaagtcgaacgggattcgaggtagcaatactttgatgagagtggcgcacgggtgcgtaacgcgtatgcaacctacctttaactgggagatagccccgagaaatcgggattaataccccataacattacgaattggcatcaatttgtgattaaagctccggcggttagagatgggcatgcgtgacattagctggttggtgaggtaacggctcaccaaggcaacgatgtctaggggtcctgagagggttatcccccacactggtactgagacacggaccagactcctacgggaggcagcagtaaggaatattggtcaatgggcgcaagcctgaaccagccatgccgcgtgcaggaagacggccctatgggttgtaaactgcttttatcagggaataaacccccgctcgtgagcggggctgaaggtacctgaggaataagcatcggctaactccgtgccagcagccgcggtaatacggaggatgcaagcgttatccggattcattgggtttaaagggtgcgcaggcggattggtaagtcaggggtgaaatcccacagctcaactgtggaactgcctttgatactgtcagtctagagtatagttgaagttggcggaatgtgtcatgtagcggtgaaatgcttagatatgacacagaacaccgatcgcgaaggcagctagctaagctataactgacgctcatgcacgaaagcgtggggatcaaacaggattagataccctggtagtccacgctgtaaacgatgattactcgatgttggcgatacacagtcagcgtttgagcgaaagcaataagtaatccacctggggagtacggccgcaaggttaaaactcaaatgaattgacgggggcccgcacaagcggtggagcatgtggtttaattcgaagcaacgcgaagaaccttaccaggccttgacatgcagagaactttccagagatggattggtgccttcgggagctctgacacaggtgctgcatggctgtcgtcagctcgtgtcgtgagatgttgggttaagtcccgtaacgagcgcaacccttgtccttagttaccagcacgttaaggtgggcactctaaggagactgccggtgacaaaccggaggaaggtggggatgacgtcaagtcatcatggcccttacggcctgggctacacacgtgctacaatggtcggtacaaagggttgccaagccgcgaggtggagctaatcccataaaaccgatcgtagtccggatcgcagtctgcaactcgactgcgtgaagtcggaatcgctagtaatcgtgaatcagaatgtcacggtgaatacgttcccgggccttgtacacaccgcccgtcacaccatgggagtgggtttcaccagaagtaggtagcttaaccttcgggagggcgct

SEQ ID NO: 79 - DNA, 1439 bp, unknown
  Unknown clone from enriched environmental sample that by rDNA sequence analysis has highest identity to Finegoldia magna
tggctcaggacgaacgctggcggcgtgcctaacacatgcaagtcgagcgaagtgactcggagagaagttttcggatggatcgaagagtcatcttagcggcggacgggtgagtaacgcgtgagaaacctgcctttcacaaagggatagcctcgggaaactgggattaataccttatgaaactgaattaccgcatggtagatcagtcaaagcgaataagcggtgaaagatggtctcgcgtcctattagctagttggtgaggtaacggctcaccaaggcttcgataggtagccggcctgagagggtgaacggccacactggaactgagacacggtccagactcctacgggaggcagcagtggggaatattgcacaatggaggaaactctgatgcagcgacgccgcgtgaatgatgaaggccttcgggttgtaaagttctgtccttggggaagataatgacggtacccaaggaggaagccccggctaactacgtgccagcagccgcggtaatacgtagggggcgagcgttgtccggaattattgggcgtaaagggttcgcaggcggtctgataagtcagatgtgaaaggcgtaggctcaacctacgtaagcatttgaaactgtcagacttgagttaaggagaggaaagtggaattcctagtgtagcggtgaaatgcgtagatattaggaggaataccagtggcgaaggcgactttctggacttatactgacgctgaggaacgaaagcgtggggagcaaacaggattagataccctggtaattcccgccgtaaacgatgagtgctaggtgttgggggtcaaacctcggtgccgcagctaacgcattaagcactccgcctggggagtacgtacgcaagtatgaaactcaaaggaattgacggggacccgcacaagcagcggagcatgtggtttaatttgaagcaacgcgaagaaccttaccagggcttgacatgccgctgaccggtgcagagatgcatctttatccttcggggtacagcggacacaggtggtgcatggttgtcgtcagctcgtgtcgtgagatgttgggttaagtcccgcaacgagcgcaacccttgtctttagttgccatcattaagttgggcactctaaagagactgccgatgacaaatcggaggaaggtggggatgacgtcaaatcatcatgccctttatgtcctgggctacacacgtgctacaatggtcggtacaacgagaagcaagtcagcgatggcaagcaaatctctaaaagccgatcccagttcggattgcagtctgcaactcgactgcatgaagtcggaatcgctagtaatcgcaggtcagcaaaactgcggtgaatacgttcccgggccttgtacacaccgcccgtcacaccacgggagtcggttgtacctgaagccggtggcccaaccgcaaggggggagccgt

SEQ ID NO: 80 - DNA, 882 bp, unknown
  Unknown clone from enriched environmental sample that by rDNA sequence analysis has highest identity to Pseudomonas putida
tggctcagattgaacgctggcggcatgctttacacatgcaagtcgaacggcagcgggggcttcggcctgccggcgagtggcgaacgggtgagtaatgcctaggaatctgcctggtagtgggggacaacgtttcgaaaggaacgctaataccgcatacgtcctacgggagaaagtgggggatcttcggacctcacgctatcagatgagcctaggtcggattagctagttggtgaggtaaaggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggcagtaagttaataccttgctgttttgacgttaccgacagaataagcaccggctaacttcgtgccagcagccgcggtaatacgaagggtgcaagcgttaatcggaattactgggcgtaaagcgcgcgtaggtggttcgttaagttagatgtgaaagccccgggctcaacctgggaactgcatccaaaactggcgagctagagtatggcagagggtggtggaatttcctgtgtagcggtgaaatgcgtagatataggaaggaacaccagtggcgaaggcgaccacctgggctaatactgacactgaggtgcgaaagcgtggggagcaaacaggattagataccctggtagtccacgccgtaaacgatgtcgactagccgttgggatccttgagatcttagtggcgcagctaacgcattaagcgtaccgcctggggagtacggccgcaaggttga

SEQ ID NO: 81 - DNA, 1442 bp, unknown
  Unknown clone from enriched environmental sample that by rDNA sequence analysis has highest identity to Clostridium aceticum
tggctcaggatgaacgctggcggcgtgcctaacacatgcaagtcgagcggtatatagtggaatgaaacttcggtcgagtgaagctatagagagcggcggacgggtgagtaacgcgtaggcaacctgccccatacagagggatagcctcgggaaaccgggattaaaacctcataacgcgaggagttcacatggactgctcgccaaagattcatcggtatgggatgggcctgcgtctgattagctagttggtgaggtaacggctcaccaaggcgacgatcagtagccgacctgagagggtaatcggccacattggaactgagacacggtccaaactcctacgggaggcagcagtggggaattttgcacaatgggggcaaccctgatgcagcgacgccgcgtgaacgaggaaggccttcgggtcgtaaagttctttcgacggggaagaaatgttatacgagtaactgcgtataatttgacggtacctgtagaagcagccccggctaactccgtgccagcagccgcggtaatacggagggggcgagcgttgttcggagttactgggcgtaaagcgcacgtaggcggtgcggtaagtcaggggttaaaggtcacagctcaactgtgataaggcctttgatactatcgtgctagagtgtcagagagggtagcggaattcccggtgtagcggtgaaatgcgtagatatcgggaggaacaccagtagcgaaggcggctacctggctgataactgacgctgaggtgcgagagcgtggggagcaaacaggattagataccctggtagtccacgctgtaaacgatggacgttaggtgttgggggaaccgaccccctcagtgccgaagctaacgcgttaaacgtcccgcctggggagtacggccgcaaggttgaaactcaaaggaattgacgggggcccgcacaagcggtggagcatgtggtttaattcgaagcaacgcgcagaaccttaccagcccttgacataccggtcgcggacacagagatgtgtctttcagttcggctggaccggatacaggtgctgcatggctgtcgtcagctcgtgccgtgagatgttgggttaagtcccgcaacgagcgcaaccctcgcccttagttgccagcatttagttgggcactctaaggggactgccggtgataagccgagaggaaggtggggatgacgtcaagtcctcatggcccttacgggctgggctacacacgtgctacaatggtggtgacagtgggcagcgagcacgcgagtgtgagctaatctccaaaagccatctcagttcggattgcactctgcaactcgagtgcatgaagttggaatcgctagtaatcgcggatcagcatgccgcggtgaatacgttcccgggccttgtacacaccgcccgtcacaccatgggagttggttttacccgaaggcgctgtgcta

SEQ ID NO: 82 - DNA, 861 bp, unknown
  Unknown clone from enriched environmental sample that by rDNA sequence analysis has highest identity to Anaerovorax sp. EH34
gtgaaaggcaatagcttaactattgtaagccttgcgaactgtgtggcttgagtgcaggagaggaaagtggaattcctagtgtagcggtgaaatgcgtagatattaggaggaacaccagtggcgaaggcgactttctggactgtaactgacactgaggcacgaaagcgtgggagcaaacaggattagataccctggtagtccacgccgtaaacgatgagcactaggtgtcggggtcgcaagacttcggtgccgcagttaacgcattaagtgctccgcctggggagtacgcacgcaagtgtgaaactcaaaggaattgacggggacccgcacaagcagcggagcatgtggtttaattcgaagcaacgcgaagaaccttaccagggcttgacatccctctgacagtcccttaaccgggaccttcttcggacagaggagacaggtggtgcatggttgtcgtcagctcgtgtcgtgagatgttgggttaagtcccgcaacgagcgcaacccttgtctttagttgccatcattcagttgggcactctagagagactgccgaggataactcggaggaaggtggggatgacgtcaaatcatcatgccccttatgccctgggctacacacgtgctacaatggctggtacaaagagacgcaagaccgcgaggtggagcaaatctcaaaaaccagtcccagttcggattgcaggctgcaactcgcctgcatgaagttggagttgctagtaatcgcagatcagaatgctgcggtgaatgcgttcccgggtcttgtacacaccgcccgtcacaccatgggagttgtcaatacccgaagccagtgagctaaccataaaaggaggcagctgtcgaa

SEQ ID NO: 83 - DNA, 620 bp, unknown
  Unknown clone from enriched environmental sample that by rDNA sequence analysis has highest identity to Pseudomonas putida
tggctcagattgaacgctggcggcaggcctaacacatgcaagtcgagcggatgaatggagcttgctccatgattcagcggcggacgggtgagtaatgcctaggaatctgcctggtagtgggggacaacgtttcgaaaggaacgctaataccgcatacgtcctacgggagaaagtgggggatcttcggacctcacgctatcagatgagcctaggtcggattagctagttggcgaggtaaaggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggcagtaagttaataccttgctgttttgacgttaccgacagaataagcaccggctaacttcgtgccagcagccgcggtaatacgtaaggtgcgagcgttaatcggaattactgggcgtaaagcgtgcgcaggcggttttgtaagacagatgtgaaatccccgggctcatcctgggaactgcgtctgtgactg

SEQ ID NO: 84 - DNA, 854 bp, unknown
  Unknown clone from enriched environmental sample that by rDNA sequence analysis has highest identity to Azotobacter beijerinckii
gccctgggctcaacatgggcatccatccagacaggcgagctagagtatagcagaggggtggtgtaatttccagcgtagcgatgaaatgagttgagataggaagccacaccagaagggaagcagaccacctgggataatcatgacagtgaggtacgaaagcgtgcggagcaaacaagataacatacccgtgcagtccatgcagtaaatgatgtcgcctagccgatgggatccatcagatcggagcggcgcagctaatgcactaagtgcaccgcgtggggagtacggccgcaaggtttcaaatcaaatgaattggcgggggaccgcacaagcggcgcagcatgtggtttaattcgaagcaacgagcagaaccttaccaggccatcccatgcatagaactttccagagagggatcggggccttccggaggtgtgacaccggtggcgccaggccgttgttaagttgggtcctgggatggtggggtaaattccgtaacgagggccaaccctgtctttagttacccacccgttaaggtgggcactctaaggagaccgccggggacaaaccggaggaaggtggggatgacgtcaagtcatcatggcccttacggcctgggctacacacgtgctacaatggtcggtacaaagggttgccaagccgcgaggtggagctaatcccataaaaccgatcgtagtccggatcgcagtctgcaactcgactgcgtgaagtcggaatcgctagtaatcgtgaatcagaatgtcacggtgaatacgttcccgggccttgtacacaccgcccgtcacaccatgggagtgggttgctccagaagtagctagtctaaccttcggggggacggt

SEQ ID NO: 85 - DNA, 824 bp, unknown
  Unknown clone from enriched environmental sample that by rDNA sequence analysis has highest identity to Azotobacter beijerinckii
caaatctcgcctcaactcgcgcttggtttgcatgcagcttcgtagtgtgagcgagtggatcctgcttgcaatgaatgagtcaagtcagatggagcacggatggcagggatctcctcgcgcatgtactacgtcttgcacgcaagagtgaggagcaaacaagcaatagctacctgttactcctccccctcaatgatgatgattattagtcgtagcagcaaaactctggtgtcgaagctaatacggaagtctcacctggggagtactgcgcattataaatactcaaaggattttggtgtcgccccccagcggggatatgtggattaattagatgaaacgcgaaaaaccttccctcccctcgacatacgacgaaccctttgagaggggagggtgcttttgggagcctggacacaggtgccgcatgggtgtcgtcacctcgtgtcgtgagatgttgggttatgtctcgcaacgagcgcaacccctgtcactagcgccatcatttgggggggcactctagtgagaccccggtgacaaaccggaggaaggggggggggacgtcaagtcctcatggcccttatgggtagggcttcccacgtctcacaatggtcggtacagagggggtcccagcccccgagggggagccaatccccaaagccgatcgtagtccggatggtagtttgcaactcgcctacgtgaagtcggaatcgtttgtaattgcagatcaccatggtgcggggaataccttcccgggtttggtaccccccgcccctccccccatgggggggggtttccccggaagtaggaagcttacccttcggggggggggt

SEQ ID NO: 86 - DNA, 827 bp, unknown
  Unknown clone from enriched environmental sample that by rDNA sequence analysis has highest identity to Azoarcus sp. EH36
tatggaagagagtcggttagtgcgtggaggagctgcgtatgtatctacttctctccgctctcctctctgcatgcgtgtcagacagccagagggggcggggtccccatccatcgttgtcttactttatgcattaatgatacaacaggagtaaacccccctcttctgtatatagcatcgcagtagcaacaacagctgttgggtggagcaggggatgatttatcatatgtctaaaacagcccgcgcgcacgctttatgcacagtatttgattgaaactcgcacccccctgtatatccccggggtgccgcacacatagttagggggtgtttttttttccggcacccccaccccgcgcgtgttagagagaccgtgattttttttggcggagagagagctttataaaccgaagggttttcactcacccgcggcagggggggatcaggcttgcgccccttttcaaaaaattccccccggcccccccccgagggggggtggggccgtttttcagtccccagggggggggggtatcctcttttcacccccccggattgttgtggagggggggggtttcaccccacggaaagatacaaacccattaagcgctccaatcgcgggaggtcggaagatcccccgctttttccctcaggaggtttggggtattagggtacctttcgatacgttttcccccccgccaggggcacgtttcgagccattattcacccgtttgccccttgccggcaggccgaagccccccctccctttggaatggcatttgtaaagcatgcccccagggttcaatttgagccaaaataaaacttaaagggggaat

SEQ ID NO: 87 - DNA, 349 bp, unknown
  Unknown clone from enriched environmental sample that by rDNA sequence analysis has highest identity to FLexistipes sp. vp180
ctattgtcagttgccatcaagtaaggtgggcactgtaaagagtccgctggggataacccggaggaaggtggggacgatgtcaagtcatcatggtcgtgatgtacagggttacgcacctgatacaatggtgcatacagagggcagtgagacaccgacgttaagagaatacgttaaagtgcacctcacttcggaatgcagtatgcaaatcgaatgcatggtgttggaattgttagtaattgcaggtcagcaatagtggggtgattacgttcccgggcatggtacacaccgccagtcacaccatgggagtcggttgtacatgaagccggtggcccaaccgcaaggggggagc

(19) United States
(12) Patent Application Publication
(10) Pub. No.: US 2010/0216219 A1
(43) Pub. Date: Aug. 26, 2010

(54) METHOD OF IN SITU BIOREMEDIATION OF HYDROCARBON-CONTAMINATED SITES USING AN ENRICHED ANAEROBIC STEADY STATE MICROBIAL CONSORTIUM

(75) Inventors: Edwin R. Hendrickson, Hockessin, DE (US); Abigail K. Luckring, West Chester, PA (US); Sharon Jo Keeler, Bear, DE (US); Michael P. Perry, Landenberg, PA (US); Eric R. Choban, Williamstown, NJ (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/704,598

(22) Filed: Feb. 12, 2010

Related U.S. Application Data
(60) Provisional application No. 61/154,522, filed on Feb. 23, 2009.

(51) Int. Cl. A62D 3/02

(52) U.S. Cl. 435/262.5

(57) ABSTRACT

A method for in situ bioremediation of hydrocarbon-contaminated sites using an enriched steady state microbial consortium capable of modifying crude oil components under anaerobic denitrifying conditions is disclosed.

This application claims the benefit of U.S. Provisional Patent Application 61/154,522, filed Feb. 23, 2009.

### FIELD OF INVENTION

This disclosure relates to the field of environmental microbiology and in situ bioremediation of hydrocarbon-contaminated sites using microorganisms that anaerobically modify the physiochemical properties of oil spills in an environment resulting in in-situ bioremediation.

### BACKGROUND OF THE INVENTION

Crude oil is made up of hydrocarbons, which consist of carbon and hydrogen. Hydrocarbons are characterized by apolar C—C and C—H bonds and are lacking in functional chemical groups. Further, some molecules contain p-bonds and cyclic structures. These compounds are distinguished as one of the following classes of hydrocarbons: alkanes, alkenes, alkynes, and alicyclic and aromatic molecules. The structural properties are responsible for their low chemical activity and water solubility, contributing to their recalcitrant nature.

Conventional methods used to remediate hydrocarbons include solvent treatment, polymeric particles having covalently bound to a polymeric component as described in U.S. Pat. No. 7,449,429B2, U.S. Pat. No. 6,852,234B2, U.S. Pat. No. 7,465,395, U.S. Pat. No. 7,201,804B2, U.S. Pat. No. 7,473,672B2, U.S. Pat. No. 7,442,313B2, site excavation as practiced by Ground Remediation Systems, LTD, UK, pump and treat, which involves pumping out contaminated groundwater with the use of a submersible or vacuum pump, and allowing the extracted groundwater to be purified by slowly proceeding through a series of vessels that contain materials designed to adsorb the contaminants from the groundwater, and vacuum extraction (U.S. Pat. No. 7,172,688B2).

Biodegradation and bioremediation of these compounds aerobically, using oxygen as the electron acceptor is well known, but in many cases impractical because natural environments contaminated with recalcitrant hydrocarbons are anoxic, such as soil, groundwater aquifers, fresh-water and marine sediments and oil reservoirs. For example, biodegradation of contaminants by indigenous microbial populations is common in many aerobic environments, the addition of oxygen and nutrients to stimulate the growth of indigenous microorganisms may be an effective bioremediation tool in the cleanup of petroleum hydrocarbons. An alternative approach reported for soils contaminated with petroleum hydrocarbons or certain pesticides is the introduction into the soils of microbes capable of degrading the petroleum hydrocarbons or pesticides. These processes rely on oxidative degradation under aerobic conditions, and the microbes use the contaminant itself as a carbon and energy source.

Thus, there is a need for developing methods to: 1) develop a steady state population of consortium of microorganisms that can grow in or on oil under anaerobic denitrifying conditions; 2) identify the members of the steady state consortium for properties that might be useful in oil modification and/or degradation and 3) use said steady state consortium of microorganisms, in a cost-effective way, for in situ bioremediation of hydrocarbon-contaminated sites.

### SUMMARY ON THE INVENTION

A method for in situ bioremediation of crude oil contaminated sites using an enriched anaerobic steady state consortium of microorganisms is provided. The method includes obtaining environmental samples comprising indigenous microbial populations exposed to crude oil or crude oil components in a contaminated site and enriching said populations per an enrichment protocol. The enrichment protocol employs a chemostat bioreactor to provide a steady state population. The steady state population may be characterized by using phylogenetic DNA sequence analysis techniques, which include 16S rDNA profiling and/or DGGE fingerprint profiling as described herein. The steady state population is further characterized as an enriched consortium comprising microbial constituents having relevant functionalities for remediating a hydrocarbon contaminated site. The steady state enriched consortium may grow in situ, under contaminated site conditions, using one or more electron acceptors and the crude oil or the hydrocarbon present in the hydrocarbon-contaminated sample, as the carbon source for microbial in situ bioremediation. The steady state consortium may be used with other microorganisms to enhance in situ bioremediation in various sites with analogous contamination and matrix conditions of the selected/targeted sites.

In one aspect a method for in situ bioremediation of hydrocarbon contaminated site comprising:
(a) providing environmental samples comprising indigenous microbial populations of said hydrocarbon-contaminated site;
(b) enriching for one or more steady state microbial consortium present in said samples wherein said enriching results in a consortium that utilizes hydrocarbon as a carbon source under anaerobic, denitrifying conditions;
(c) Characterizing the enriched steady state consortiums of (b) using 16S rDNA profiling;
(d) assembling a consortium using the characterization of (c) comprising microbial genera comprising one or more Thauera species and any two additional species that are members of genera selected from the group consisting of Rhodocyclaceae, Pseudomonadales, Bacteroidaceae, Clostridiaceae, Incertae Sedis, Spirochaetaceaes, Deferribacterales, Brucellaceae and Chloroflexaceae;
(e) identifying at least one relevant functionality for bioremediation of the consortium of (d);
(f) growing the enriched steady state consortium of (e) having at least one relevant functionality to a concentration sufficient for inoculating said hydrocarbon-contaminated site; and
(g) inoculating the hydrocarbon-contaminated site with said concentration of the consortium of (f) in the presence of one or more anoxic electron acceptors wherein the consortium grows in said hydrocarbon-contaminated site and wherein said growth promotes in situ bioremediation.

### BRIEF DESCRIPTION OF FIGURES OF THE INVENTION

FIG. 1: Distribution of microorganisms in the parent POG1 consortium after three months in second-generation parent populations as determined by 16S rDNA identities.

FIGS. 2A and 2B: Distribution of microorganisms in the parent POG1 consortium after 190 days in second- and third-generation parent populations determined by 16S rDNA identities. FIG. 2A: Population distribution of third-generation parent at 190 days while 6400 ppm Nitrate had been reduced. FIG. 2B: Population distribution of second-generation parent at 240 days while 6400 ppm Nitrate had been reduced

FIG. 3: Diagram of the anaerobic chemostat bioreactor for denitrifying growth studies with the steady state POG1 consortium: A) Reverse flow bubbler; B) Nitrogen manifold; C) Feed sampling syringe and relief valve (5 psi); D) Feed syringe pump; E) Feed reservoir head space nitrogen gas port; F) Feed input port on chemostat bioreactor; G) Feed medium reservoir (minimal and nitrate); H) Chemostat Bioreactor; I) Minimal salt medium and consortium culture; J) Magnetic stirrer; K) Crude oil supplement; L) Effluent reservoir; M) Effluent exit port on chemostat bioreactor; N) Effluent reservoir head space nitrogen gas port; O) Effluent syringe port; P) Effluent sampling syringe and relief valve (5 psi); Q) Inoculation and sampling port on chemostat bioreactor; R) Extra port and plug; S) Chemostat bioreactor head space nitrogen gas port.

FIG. 4: Distribution of microorganisms in the steady state POG1 as determined by 16S rDNA identities. Consortium constituents at 0, 28 and 52 day, were compared to the parent populations.

FIG. 5: Denaturing gradient gel electrophoresis fingerprint profile of the bacterial 16S rRNA gene fragments derived from community DNA extracted from the steady state POG1 chemostat bioreactor using primers SEQ ID NO: 12 and SEQ ID NO: 14 for region V4-5. (A) Thauera AL9:8 is a prominent species of a consortium as described herein. (B) Pseudomonas stutzeri LH4:15 is also a represented species of the consortium. (C) Ochrobactrum oryzae AL1:7 is the minor species. Minor bacterial species (D through L) are present in all samples. Bacterial species (C & M through O) are less important members of population and are selected against.

FIG. 6: Microsand column oil release—Using oil on North Slope sand, the 3^{rd} generation parent POG1 consortium culture EH40:1 (2400 ppm Nitrate).

The following sequences conform to 37 C.F.R. §1.821-1.825 (“Requirements for Patent Applications Containing Nucleotide Sequences and/or Amino Acid Sequence Disclosures—the Sequence Rules”) and are consistent with the World Intellectual Property Organization (WIPO) Standard ST.25 (1998) and the sequence listing requirements of the EPO and PCT (Rules 5.2 and 49.5 (a-bis), and Section 208 and Annex C of the Administrative Instructions. The symbols and format used for nucleotide and amino acid sequence data comply with the rules set forth in 37 C.F.R. §1.822.

TABLE 1
PRIMER SEQUENCES USED IN THIS INVENTION

| | SEQ ID NO: |
|---|---|
| Description | Nucleic acid |
| 8F | 1 |
| Bacterial 16S rDNA forward universal | |
| primer | |
| 1492 R | 2 |
| Bacterial 16S rDNA reverse universal | |
| primer | |
| 1407 R | 3 |
| Bacterial 16rDNA reverse universal | |
| primer | |
| U518R, | 4 |
| 16S rDNA universal reverse primer | |
| UB 357F | 5 |
| Bacterial 16S rDNA forward universal | |
| primer | |
| dG•UB 357F | 6 |
| DGGE Bacterial 16S rDNA universal | |
| forward primer with 5′ 40-bp GC-rich | |
| clamp | |
| UA 341F1 | 7 |
| Archaeal 16S rDNA universal forward | |
| primer | |
| dG•UA 341F1 | 8 |
| DGGE Archaeal 16S rDNA universal | |
| forward primer with 5′ 40-bp GC-rich | |
| clamp | |
| UA 341F2 | 9 |
| Archaeal 16S rDNA universal forward | |
| primer | |
| dG•UA 341F2 | 10 |
| DGGE Archaeal rDNA universal forward | |
| 16S primer with 5′ 40-bp GC-rich clamp | |
| U 519F | 11 |
| Universal 16S rDNA forward primer | |
| dG•U 519F | 12 |
| DGGE Universal 16S rDNA forward | |
| primer with 5′ 40-bp GC-rich clamp | |
| UA958R, | 13 |
| Archaeal universal 16S rDNA reverse | |
| primer | |
| UB 939R, Bacterial 16S rRNA universal | 14 |
| reverse primer | |

The following DNA sequences were consensus sequences of unique cloned PCR sequences, which were generated using universal 16S primers with DNA isolated from whole POG1 community:

SEQ ID NO: 15 is the consensus DNA sequence, clones ID: 1A: Thauera sp AL9:8
SEQ ID NO: 16 is the consensus DNA sequence, clones ID: 1B: Thauera sp R26885
SEQ ID NO: 17 is the consensus DNA sequence, clones ID: 1C: Azoarcus sp mXyN1
SEQ ID NO: 18 is the consensus DNA sequence, clones IDI: Azoarcus sp mXyN1
SEQ ID NO: 19 is the consensus DNA sequence, clones ID: 1E: Thauera sp R26885
SEQ ID NO: 20 is the consensus DNA sequence, clones ID: 1F: Azotobacter beijerinckii
SEQ ID NO: 21 is the consensus DNA sequence, clones ID: 1G: Thauera sp R26885
SEQ ID NO: 22 is the consensus DNA sequence, clones ID: 1H: Azoarcus sp mXyN1
SEQ ID NO: 23 is the consensus DNA sequence, clones ID: 1I: Thauera aromatica
SEQ ID NO: 24 is the consensus DNA sequence, clones ID: 1J: Thauera aromatica
SEQ ID NO: 25 is the consensus DNA sequence, clones ID: 1: Thauera aromatica
SEQ ID NO: 26 is the consensus DNA sequence, clones ID: 1L: Thauera aromatica
SEQ ID NO: 27 is the consensus DNA sequence, clones ID: 1M: Thauera aromatica
SEQ ID NO: 28 is the consensus DNA sequence, clones ID: 1N: Thauera aromatica
SEQ ID NO: 29 is the consensus DNA sequence, clones ID: 1O: Azoarcus sp. EH10
SEQ ID NO: 30 is the consensus DNA sequence, clones ID: 1P: Thauera sp R26885
SEQ ID NO: 31 is the consensus DNA sequence, clones ID: 1Q: Thauera aromatica
SEQ ID NO: 32 is the consensus DNA sequence, clones ID: 1R: Thauera aromatica
SEQ ID NO: 33 is the consensus DNA sequence, clones ID: 1S: Thauera aromatica
SEQ ID NO: 34 is the consensus DNA sequence, clones ID: 1T: Thauera aromatica
SEQ ID NO: 35 is the consensus DNA sequence, clones ID: 1U: Thauera aromatica
SEQ ID NO: 36 is the consensus DNA sequence, clones ID: 1V: Thauera aromatica
SEQ ID NO: 37 is the consensus DNA sequence, clones ID: 1W: Thauera aromatica
SEQ ID NO: 38 is the consensus DNA sequence, clones ID: 1X: Thauera aromatica
SEQ ID NO: 39 is the consensus DNA sequence, clones ID: 1Y: Thauera aromatica
SEQ ID NO: 40 is the consensus DNA sequence, clones ID: 1Z: Thauera aromatica
SEQ ID NO: 41 is the consensus DNA sequence, clones ID: 1AZ: Thauera aromatica
SEQ ID NO: 42 is the consensus DNA sequence, clones ID: 2: Finegoldia magna
SEQ ID NO: 43 is the consensus DNA sequence, clones ID: 3 Spirochaeta sp MET-E
SEQ ID NO: 44 is the consensus DNA sequence, clones ID: 4: Azotobacter beijerinckii
SEQ ID NO: 45 is the consensus DNA sequence, clones ID: Finegoldia magna
SEQ ID NO: 46 is the consensus DNA sequence, clones ID: 6: Azotobacter beijerinckii
SEQ ID NO: 47 is the consensus DNA sequence, clones ID: 7: Ochrobactrum sp mp-5
SEQ ID NO: 48 is the consensus DNA sequence, clones ID: 8A: Anaerovorax sp. EH8A
SEQ ID NO: 49 is the consensus DNA sequence, clones ID: 8B: Anaerovorax sp. EH8B
SEQ ID NO: 50 is the consensus DNA sequence, clones ID: 9A: Finegoldia magna
SEQ ID NO: 51 is the consensus DNA sequence, clones ID: 9B: Finegoldia magna
SEQ ID NO: 52 is the consensus DNA sequence, clones ID: 9C: Finegoldia magna
SEQ ID NO: 53 is the consensus DNA sequence, clones ID: 10: Flexistipes sp vp180
SEQ ID NO: 54 is the consensus DNA sequence, clones ID: 11: Azoarcus sp._EH11
SEQ ID NO: 55 is the consensus DNA sequence, clones ID: 12: Clostridium chartatabidium
SEQ ID NO: 56 is the consensus DNA sequence, clones ID: 13: Deferribacter desulfuricans
SEQ ID NO: 57 is the consensus DNA sequence, clones ID: 14A: Azotobacter beijerinckii
SEQ ID NO: 58 is the consensus DNA sequence, clones ID: 14B: Flexistipes sp vp180
SEQ ID NO: 59 is the consensus DNA sequence, clones ID: 15: Ochrobactrum lupini
SEQ ID NO: 60 is the consensus DNA sequence, clones ID: 16A: Pseudomonas pseudoalcligenes
SEQ ID NO: 61 is the consensus DNA sequence, clones ID: 16B: Pseudomonas putida
SEQ ID NO: 62 is the consensus DNA sequence, clones ID: 17A: Pseudomonas pseudoalcligenes
SEQ ID NO: 63 is the consensus DNA sequence, clones ID: 17B: Clostridium chartatabidium
SEQ ID NO: 64 is the consensus DNA sequence, clones ID: 18A: Finegoldia magna
SEQ ID NO: 65 is the consensus DNA sequence, clones ID: 18B: Finegoldia magna
SEQ ID NO: 66 is the consensus DNA sequence, clones ID: 18C: Finegoldia magna
SEQ ID NO: 67 is the consensus DNA sequence, clones ID: 19: Thauera aromatica
SEQ ID NO: 68 is the consensus DNA sequence, clones ID: 20: Thauera aromatica
SEQ ID NO: 69 is the consensus DNA sequence, clones ID: 21: Azoarcus sp. EH21
SEQ ID NO: 70 is the consensus DNA sequence, clones ID: 22: Azotobacter beijerinckii
SEQ ID NO: 71 is the consensus DNA sequence, clones ID: 23: Azotobacter beijerinckii
SEQ ID NO: 72 is the consensus DNA sequence, clones ID: 24: Azotobacter beijerinckii
SEQ ID NO: 73 is the consensus DNA sequence, clones ID: 25: Azotobacter beijerinckii
SEQ ID NO: 74 is the consensus DNA sequence, clones ID: 26: Azotobacter beijerinckii
SEQ ID NO: 75 is the consensus DNA sequence, clones ID: 27: Clostridium chartatabidium
SEQ ID NO: 76 is the consensus DNA sequence, clones ID: 28: Clostridium aceticum
SEQ ID NO: 77 is the consensus DNA sequence, clones ID: 29: Deferribacter desulfuricans
SEQ ID NO: 78 is the consensus DNA sequence, clones ID: 30: Bacteroides sp. EH30
SEQ ID NO: 79 is the consensus DNA sequence, clones ID: 31: Finegoldia magna
SEQ ID NO: 80 is the consensus DNA sequence, clones ID: 32: Pseudomonas putida
SEQ ID NO: 81 is the consensus DNA sequence, clones ID: 33: Clostridium aceticum
SEQ ID NO: 82 is the consensus DNA sequence, clones ID: 34: Anaerovorax sp. EH34
SEQ ID NO: 83 is the consensus DNA sequence, clones ID: 35: Pseudomonas putida
SEQ ID NO: 84 is the consensus DNA sequence, clones ID: 36: Azotobacter beijerinckii
SEQ ID NO: 85 is the consensus DNA sequence, clones ID: 37: Azotobacter beijerinckii
SEQ ID NO: 86 is the consensus DNA sequence, clones ID: 38: Azoarcus sp. EH36
SEQ ID NO: 87 is the consensus DNA sequence, clones ID: 39: Flexistipes sp vp180

### DETAILED DESCRIPTION OF THE INVENTION

Applicants specifically incorporate the entire content of all cited references in this disclosure. Unless stated otherwise, all percentages, parts, ratios, etc., are by weight. Trademarks are shown in upper case.

Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The means, methods and procedures for providing an enriched steady state consortium having one or more relevant functionality to in situ bioremediation of hydrocarbon-contaminated sites are disclosed.

The following definitions are provided for the terms and abbreviations used in this application:

The term “environmental sample” means any substance exposed to hydrocarbons of the contaminated site, including a mixture of water, soil and oil comprising microorganisms. As used herein environmental samples include water, soil and oil samples that comprise indigenous microorganisms and/or populations of microorganisms of varying genus and species that may be characterized by 16S rDNA profiling or DNA fingerprinting techniques as described in detail below. The environmental samples may comprise a microbial consortium unique to a geographic region or target contaminated site, or, alternatively the microbial consortium may be adaptable to other environment sites, geographies and reservoirs. f

“Enriching for one or more steady state consortium” as used herein means that an environmental sample may be enriched in accordance with the invention by culturing the sample in a chemostat bioreactor under desired conditions such as anaerobic denitrifying conditions using a basic minimal medium, such as SL-10 as described in Table 2 and a soil or water sample of the contaminated site as a carbon source.

The term “core flood assay” refers to water-flooding the core of an oil reservoir after application of an oil recovery technique, i.e. a MEOR technology, to the reservoir. An increase in oil release represents the ability of applied microbes to aid in the release of oil from the core matrix.

The term “indigenous microbial populations” means native populations of microorganisms present in a hydrocarbon-contaminated sample (rock or soil matrices, oil, water or oil-water samples).

The term “components of the POG1 consortium” refers to members or microbial constituents (both major and minor) of the POG1 consortium. These may be indigenous to the consortium or may be added strains. Additional components such as electron acceptors and combination of electron acceptors could be present too.

The terms “steady state consortium” and “enriched steady state microbial consortium” refers to a mixed culture of microorganisms and/or microbial populations grown in a chemostat bioreactor and in a medium under specific growth conditions to enrich for growth of particular populations of microorganisms, and once enriched, to reach a stable condition such that the consortium does significantly change over time under a given set of conditions. The steady state is controlled by a limiting nutrient. In an embodiment the steady state consortium is provided by enriching the microorganisms in a defined minimal, denitrifying medium, under anaerobic denitrifying conditions, using a hydrocarbon-contaminated environmental sample as the carbon source, until the population has reached its steady state. In the present case, electron acceptor, nitrate, is limiting and is fed at a constant flow. The consortium may comprise microbial populations from environmental samples or from pure or mixed non-indigenous cultures.

The term “POG1 consortium” as used herein refers to a consortium derived from a hydrocarbon-contaminated environmental sample enrichment that was obtained from a soil sample contaminated with polycyclic aromatic hydrocarbons.

The term “crude oil” refers to a naturally occurring, flammable liquid found in rock formations and comprises a complex mixture of hydrocarbons of various molecular weights, plus other organic compounds. The crude oil may contain, for example, a mixture of paraffins, aromatics, asphaltenes, aliphatic, aromatic, cyclic, and polycyclic, polyaromatic hydrocarbons. The crude oil may be generic or may be from hydrocarbon-contaminated environmental site targeted for bioremediation.

The term “electron acceptor” refers to a molecule or compound that receives or accepts an electron during cellular respiration.

The terms “denitrifying” and “denitrification” mean reducing nitrate for use as an electron acceptor in respiratory energy generation. The term “nitrates” and “nitrites” refers to any salt of nitrate (NO₃) or nitrite (NO₂).

The term “relevant functionalities” means that the consortium has the ability to function in ways that promotes in situ bioremediation. Certain such functionalities include:

(a) modification of the hydrocarbon components of the hydrocarbon-contaminated site, including hydrocarbon degradation;

(b) production of biosurfactants to decrease surface and interfacial tensions;

(c) production of polymers other than surfactants that facilitate mobility of petroleum;

(d) production of low molecular weight acids which cause rock dissolution; a

(e) change in hydrocarbon viscosity; and/or

(f) degradation of hydrocarbon contaminants.

The ability to demonstrate such functionalities in the present invention is dependent upon the consortium's ability to (1) grow under anaerobic conditions while reducing nitrates or nitrites; (2) use at least one component available in the hydrocarbon-contaminated site as a carbon source; (3) grow in the presence of hydrocarbons or oil; (4) grow optimally in the hydrocarbon-contaminated environment; and (5) achieve combinations of the above.

The term “hydrocarbon-contaminated site” as used herein means an environmental site that has received heavy spills of either crude oil, its refined or semi refined constituents or other mixtures of various aliphatic, aromatic and asphaltene hydrocarbons.

The term “bioremediation of hydrocarbon-contaminated site” as used herein means degradation of the hydrocarbons that have contaminated the site through action of the microbial constituents of the steady state consortium or alternatively changing the site or hydrocarbon such that it is more readily removable from a contaminated site.

The term “a concentration sufficient for inoculating said hydrocarbon-contaminated site” as used herein means a sufficient concentration of a seed culture that can be stimulated to grow at the contaminated site. This requires that the anoxic redox potential of the subsurface be reduced to support a denitrification condition in the subsurface of the contaminated site. The target site may be pre-treated with a sufficient electron donor such as lactate or acetate and the electron acceptor, nitrate, to stimulate reduction of the redox potential.

The term “promotes in situ bioremediation” as used herein means that addition of the steady state consortium to the hydrocarbon-contaminated site, promotes degradation and/or removal of the contaminating hydrocarbons.

The term “reduction in crude oil viscosity” as used herein means by addition of the steady state consortium to the hydrocarbon-contaminated site followed by degradation of the hydrocarbon contents of the site, less complex hydrocarbon components may be produced that may be further degraded by indigenous soil microflora.

The term “growing on oil” means the microbial species capable of metabolizing aliphatic, aromatic and polycyclic aromatic hydrocarbons or any other organic components of the crude petroleum as a nutrient to support growth.

The ability to grow on oil according to an embodiment of the invention eliminates the need for supplying certain nutrients, such as additional carbon sources, for using the microbial consortium for bioremediation of the hydrocarbon-contaminated site.

The term “chemostat bioreactor” refers to a bioreactor used for a continuous flow culture to maintain microbial populations or a consortium of microorganism in a steady state growth phase. This is accomplished by regulating a continuous supply of medium to the microbes, which maintains the electron donor or electron receptor in limited quantities in order to control the growth rate of the culture.

The term “fingerprint profile” refers to the process of generating a specific pattern of DNA bands on a denaturing gradient electrophoresis gel that are defined by their length and sequence and is used to identify and describe the predominant microbial population of a culture assessing microbial diversity and population stability at any particular metabolic state.

The term “reservoir inoculation” means inoculation of the oil reservoir with one or more microbes for microbially enhanced oil recovery.

The term “concentration sufficient for reservoir inoculation” means growing the microbial population to a density that would be suitable for inoculating the oil reservoir. For the purposes of this invention, a concentration of 10⁷ cells per milliliter of the sample may be employed.

The term “promotes in situ bioremediation” as used herein means growing the microbial consortium in the hydrocarbon-contaminated site under anaerobic conditions to provide for modification of the oil in the hydrocarbon-contaminated site as defined above by a relevant functionality, which may result in a change in the complex hydrocarbon content of the hydrocarbon-contaminated site. Such change supports release of oil or its components from sand or soil to enhance bioremediation of the hydrocarbon-contaminated site.

The term “rDNA typing” or “rDNA profiling” means the process of comparing the 16S rDNA gene sequences found in the experimental samples to rDNA sequences maintained in several international databases to identify, by sequence homology, the “closest relative” of microbial species.

The term “signature sequences” herein will refer to unique sequences of nucleotides in the 16S rRNA gene sequence that can be used specifically to phylogenetically define an organism or group of organisms. These sequences are used to distinguish the origin of the sequence from an organism at the kingdom, domain, phylum, class, order, genus, family, species and even an isolate at the phylogenic level of classification.

The term “structural domain” herein refers to specific sequence regions in the 16S rRNA gene sequence that when aligned reveal a pattern in which relatively conserved stretches of primary sequence and a secondary sequence alternate with variable regions that differ remarkably in sequence length, base composition and potential secondary structure. These structural domains of 16S rRNA gene sequence are divided into three categories: the universally conserved or “U” regions, semi conserved or “S” regions and the variable or “V” regions. All of the structural domains contain signature sequence regions that phylogenetically define an organism. (Neefs, J-M et al. Nucleic acids Research, 1990, Botter, E. C., ASM News 1996).

The term “phylogenetics” refers to the study of evolutionary relatedness among various groups of organisms (e.g., bacterial or archaeal species or populations).

The term “phylogenetic typing”, “phylogenetic mapping” or “phylogenetic classification” may be used interchangeably herein and refer to a form of classification in which microorganisms are grouped according to their ancestral lineage. The methods herein are specifically directed to phylogenetic typing on environmental samples based on 16S ribosomal DNA (rDNA) sequencing. In this context, approximately 1400 base pair (bp) length of the 16S rDNA gene sequence is generated using 16S rDNA universal primers identified herein and compared by sequence homology to a database of microbial rDNA sequences. This comparison is then used to help taxonomically classify pure cultures for use in enhanced oil recovery.

The abbreviation “DNA” refers to deoxyribonucleic acid.

“Gene” is a specific unit on a DNA molecule that is composed of a nucleotide sequence that encodes a distinct genetic message for regulatory regions, transcribed structural regions or functional regions.

The abbreviation “rDNA” refers to ribosomal operon or gene sequences encoding ribosomal RNA on the genomic DNA sequence.

The abbreviation “NTPs” refers to ribonucleotide triphosphates, which are the chemical building blocks or “genetic letters” for RNA.

The abbreviation “dNTPs” refers to deoxyribonucleotide triphosphates, which are the chemical building blocks or “genetic letters” for DNA.

The term “rRNA” refers to ribosomal structural RNA, which includes the 5S, 16S and 23S rRNA molecules. The term “rRNA operon” refers to an operon that produces structural RNA, which includes the 5S, 16S and 23S ribosomal structural RNA molecules.

The term “mRNA” refers to an RNA molecule that has been transcribed from a gene coded on a DNA template and carries the genetic information for a protein to the ribosomes to be translated and synthesized into the protein.

The term “hybridize” is used to describe the formation base pairs between complementary regions of two strands of DNA that were not originally paired.

The term “complementary” is used to describe the relationship between nucleotide bases that are capable of hybridizing to one another. For example, with respect to DNA, adenosine is complementary to thymine and cytosine is complementary to guanine.

The abbreviation “cDNA” refers to DNA that is complementary to and is derived from either messenger RNA or rRNA.

The abbreviation “NCBI” refers to the National Center for Biotechnology Information.

The term “GenBank” refers to the National Institute of Health's genetic sequence database.

The term “nutrient supplementation” refers to the addition of nutrients that benefit the growth of microorganisms that are capable of using crude oil as their main carbon source but grow optimally with other non-hydrocarbon nutrients, i.e., yeast extract, peptone, succinate, lactate, formate, acetate, propionate, glutamate, glycine, lysine, citrate, glucose, and vitamin solutions.

The abbreviation “NIC” refers to non-inoculum, negative controls in microbial culture experiments.

The abbreviation “ACO” (autoclaved crude oil) refers to crude oil that has been steam sterilized using an autoclave, and is assumed to be devoid of living microbes.

The term “bacterial” means belonging to the bacteria—Bacteria are an evolutionary domain or kingdom of microbial species separate from other prokaryotes based on their physiology, morphology and 16S rDNA sequence homologies.

The term “microbial species” means distinct microorganisms identified based on their physiology, morphology and phylogenetic characteristics using 16S rDNA sequences.

The term “archaeal” means belongings to the Archaea—Archaea are an evolutionary domain or kingdom of microbial species separate from other prokaryotes based on their physiology, morphology and 16S rDNA sequence homologies.

The term “biofilm” means a film made up of a matrix of a compact mass of microorganisms consisting of structural heterogeneity, genetic diversity, complex community interactions, and an extracellular matrix of polymeric substances. The term “ribotyping” or “riboprint” refers to fingerprinting of genomic DNA restriction fragments that contain all or part of the rRNA operon encoding for the 5S, 16S and 23S rRNA genes. Ribotyping, as described herein, is where restriction fragments, produced from microbial chromosomal DNA, are separated by electrophoresis, transferred to a filter membrane and probed with labeled rDNA operon probes. Restriction fragments that hybridize to the label probe produce a distinct labeled pattern or fingerprint/barcode that is unique to a specific microbial strain. The ribotyping procedure can be entirely performed on the Riboprinter® instrument (DuPont Qualicon, Wilmington, Del.).

The term “percent identity”, as known in the art, is a relationship between two or more polypeptide sequences or two or more polynucleotide sequences, as determined by sequence comparisons. In the art, “identity” also means the degree of sequence relatedness or homology between polynucleotide sequences, as determined by the match between strings of such sequences and their degree of invariance. The term “similarity” refers to how related one nucleotide or protein sequence is to another. The extent of similarity between two sequences is based on the percent of sequence identity and/or conservation. “Identity” and “similarity” can be readily calculated by known methods, including but not limited to those described in “Computational Molecular Biology, Lesk, A. M., ed. Oxford University Press, NY, 1988”; and “Biocomputing: Informatics and Genome Projects, Smith, D. W., ed., Academic Press, NY, 1993”; and “Computer Analysis of Sequence Data, Part I, Griffin, A. M., and Griffin, H. G., eds., Humana Press, NJ, 1994”; and “Sequence Analysis in Molecular Biology, von Heinje, G., ed., Academic Press, 1987”; and “Sequence Analysis Primer, Gribskov, M. and Devereux, J., eds., Stockton Press, NY, 1991”. Preferred methods to determine identity are designed to give the best match between the sequences tested. Methods to determine identity and similarity are codified in publicly available computer programs.

The term “sequence analysis software” refers to any computer algorithm or software program that is useful for the analysis of nucleotide or amino acid sequences. “Sequence analysis software” may be commercially available or independently developed. Typical sequence analysis software will include, but is not limited to: the GCG suite of programs (Wisconsin Package Version 9.0, Genetics Computer Group (GCG), Madison, Wis.), BLASTP, BLASTN, BLASTX (Altschul, S. F. et al., J. Mol. Biol. 215: 403-410, 1990), DNASTAR (DNASTAR, Inc., Madison, Wis.), and the FASTA program incorporating the Smith-Waterman algorithm (Pearson, W. R., Comput. Methods Genome Res., [Proc. Int. Symp, Meeting Date 1992, 111-120. eds.: Suhai, Sandor. Publisher: Plenum, New York, N.Y., 1994). Within the context of this application, it will be understood that where sequence analysis software is used for analysis, the results of the analysis will be based on the “default values” of the program referenced, unless otherwise specified. As used herein “default values” will mean any set of values or parameters that load with the software when first initialized.

The term “denaturing gradient gel electrophoresis” or “DGGE” refers to a molecular fingerprinting method that separates polymerase chain reaction-generated (PCR-generated) DNA products based on their length and sequence. The separation of the PCR product fragment of the same size, but with a different sequence reflects differential denaturing characteristics of the DNA due to their sequence variation. During DGGE, PCR products encounter increasingly higher concentrations of chemical denaturant as they migrate through a polyacrylamide gel. The rDNA PCR products are generated from the mixed microbial population being characterized. The weaker melting domains of certain double-stranded PCR sequences will begin to denature, slowing the electrophoretic migration dramatically. The different sequences of DNA (that are generated from different bacteria) will denature at different denaturant concentrations resulting in a pattern of bands that can be collectively referred to as the “community fingerprint profile”. In theory, each band in a given DGGE fingerprint profile represents an individual bacterial species present in the community. Once generated, the data represents a fingerprint profile of the population at a given point in time and under certain growth conditions. The DGGE fingerprint profile can be uploaded into database to compare profiles of the consortium under prescribed growth conditions. Thus DGGE is used to generate the finger prints of a microbial community and to resolve the genetic diversity of complex microbial populations.

The present method provides for microbially enhanced bioremediation of hydrocarbon-contaminated sites using an enriched steady state microbial consortium comprising the following steps: 1) obtaining an environmental samples comprising indigenous microbial populations of a contaminate site; 2) developing an enriched steady state microbial consortium wherein said consortium is enriched under anaerobic denitrifying conditions, using crude oil or hydrocarbon component samples from the specific contaminated site as the carbon source, until the population has reached its steady state; 3) developing fingerprint profiles of samples of the steady state consortium using 16S rDNA profiling methods of said samples; 4) selecting samples of the consortium comprising various microbial genera, for example, one or more Thauera species and other additional species selected from the group consisting of Rhodocyclaceae, Pseudomonadales., Bacteroidaceae., Clostridiaceae, Incertae Sedis., Spirochete, Spirochaetaceaes., Deferribacterales, Brucellaceae and Chloroflexaceae; 5) identifying at least one relevant functionality of the selected enriched steady state consortium for use in bioremediating the hydrocarbon-contaminated site; 6) growing the selected enriched steady state consortium having at least one relevant functionality to a concentration sufficient for hydrocarbon-contaminated site inoculation; 7) inoculating the hydrocarbon-contaminated site with said sufficient concentration of the steady state consortium and further additives comprising one or more electron acceptors wherein the consortium grows in the environmental matrix (soil, groundwater, sandstone, rock or any combinations of all within the matrix) and wherein said consortium promotes in situ bioremediation.

### Environmental Samples for Development of a Microbial Consortium

The sample source used for enrichment cultures and development of a consortium for use in in-situ bioremediation may be: (1) an environmental sample that has been exposed to crude oil or any one or combination of its components, such as paraffins, aromatics, asphaltenes, etc.; or (2) a preexisting consortium that meet the criteria for growth in the presence of the contaminating crude oil or hydrocarbons. The sample must be in contact with or near the oil formation since sample constituents are specific to an area. Sampling near an intended location is preferred. The sample volume and the number of microbial cells per milliliter may vary from 1 mL to 5 L and from 10⁵ to 10¹⁰ cells/mL, depending upon the specific requirements of the intended application. For the purposes of this invention, the cell density in the sample may be 10⁷ cells per milliliter. To these samples, a basic mineral salt medium, which is required for microbial growth, vitamins and electron acceptors, may be added in addition to the sample of the crude oil or the contaminating hydrocarbons from the desired contaminated location and the mixture may be incubated at a suitable temperature to allow development of the desired consortium with specific functionalities.

In an embodiment, an environmental sample may be provided from a site/location heavily contaminated with oil.

In another embodiment an environmental sample may be provided from a site located in the oil fields of Texas, the industrial North Eastern and Midwestern United States, Oklahoma, California, West Africa, the Middle East, India, China, North and Eastern South America, and the Old Soviet Union.

### Microbial Chemostat Bioreactor

The environmental samples comprising microbial populations may be grown in a chemostat bioreactor using enrichment techniques. The enrichment conditions may include growing an environmental sample under anaerobic denitrifying conditions in bottles while limiting the concentration of electron acceptor provided during anaerobic respiration since the rate of manual feed is often too slow to keep up with reduction of nitrate. In addition, if too high a concentration of nitrate (e.g., >2500 ppm) were to be applied, it may either inhibit growth of some microbes or be toxic and kill some other species. Conversely, denitrifying bacteria stop growing when nitrate is completely reduced, hence allowing other microbial populations to dominate the composition of the consortium, while reducing other trace metals, minerals and unsaturated hydrocarbons or organic molecules. Fluctuations in nitrate levels may affect changes in the microbial composition of the consortium and unduly influence the definition of the composition of the population in it. The non-limiting examples provided herein describe how to manipulate these conditions to enrich for and identify desired constituents of a steady state microbial consortium.

Chemostat bioreactors are systems for the cultivation of microbial communities or single microbial species and provide for maintaining conditions for microbial growth and populations at a steady state by controlling the volumetric feed rate of a growth dependant factor. The chemostat setup consists of a sterile fresh nutrient reservoir connected to a growth reactor. Fresh medium containing nutrients essential for cell growth is continuously pumped to the chamber from the medium reservoir. The medium contains a specific concentration of one or more growth-limiting nutrient that allows for growth of the consortium in a controlled physiological steady state. Varying the concentration of the growth-limiting nutrients will, in turn, change the steady state concentration of cells. The effluent, consisting of unused nutrients, metabolic wastes and cells, is continuously removed from the vessel, pumped from the chemostat bioreactor to the effluent reservoir and monitored for complete reduction of nitrate. To maintain constant volume, the flow of nutrients and the removal of effluent are maintained at the same rate and are controlled by synchronized syringe pumps.

### Enrichment Conditions

As stated above an environmental sample may be enriched in accordance with the invention herein by culturing the sample in a chemostat bioreactor under desired conditions such as anaerobic denitrifying conditions. Additional enrichment conditions include use of a basic minimal medium, such as SL-10 as described in Table 2.

The chemostat bioreactor may be held at a room temperature that may fluctuate from about 15° C. to about 35° C.

The steady state consortium may be enriched under anaerobic, denitrifying conditions using a nitrate salt as the electron acceptor. The enrichment culture thus may include nitrate concentrations from 25 ppm to 10,000 ppm. More specifically, the nitrate concentration may be from 25 ppm to 5000 ppm. Most specifically, the nitrate concentration may be from 100 ppm to 2000 ppm.

In one embodiment an enriched steady state microbial consortium designated POG1 was developed under denitrifying conditions with a nitrate salt as the anoxic electron acceptor. Other suitable anoxic reducing conditions would use the appropriate electron acceptors that include, but are not limited to: iron (III), manganese (IV), sulfate, carbon dioxide, nitrite, ferric ion, sulfur, sulfate, selenate, arsenate, carbon dioxide and organic electron acceptors that include, but not limited the chloroethenes, fumarate, malate, pyruvate, acetylaldehyde, oxaloacetate and similar unsaturated hydrocarbons may also be used.

The enrichment of the consortium may include a minimal growth medium supplemented with additional required nutritional supplements, e.g., vitamins and trace metals, and crude oil as the carbon source as described in details below.

This consortium may be grown at a pH from 5.0 to 10. More specifically the pH could be from 6.0 to about 9.0. Most specifically the pH could be from 6.5 to 8.5. In addition, the steady state consortium should have an OD₅₅₀ from about 0.8 to about 1.2 and should actively reduce the electron acceptor.

### Characterization of Microbial Populations in the Enriched Steady State Microbial Consortium

Constituents or the microbial populations of the enriched steady state consortium may be identified by molecular phylogenetic typing techniques. Identification of microbial populations in a consortium provides for selection of a consortium with certain microbial genera and species described to have relevant functionalities for bioremediation of the hydrocarbon-contaminated sites.

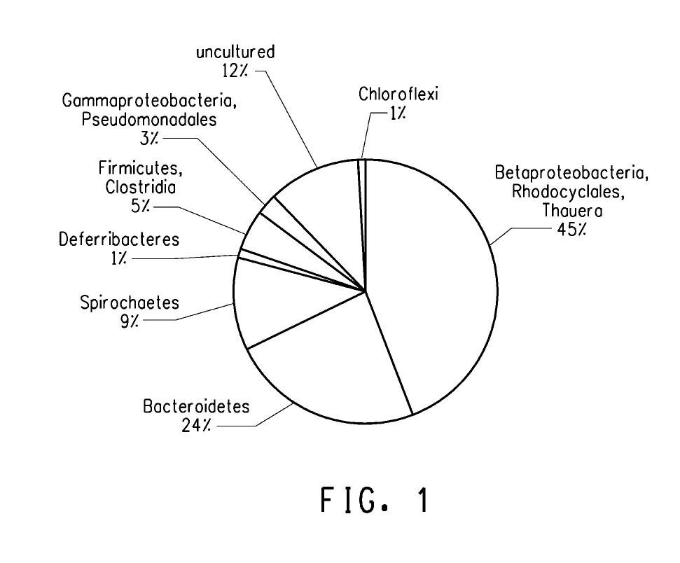

In an embodiment of the invention, an enriched steady state consortium (referred to as “POG1”) was developed from a parent mixed culture, enriched from an environmental sample, using crude oil from the targeted hydrocarbon-contaminated site as the energy source. Various constituents of the consortium were characterized using fingerprint profiles of their 16S rDNA as described below, using signature regions within the variable sequence regions found in the 16S rRNA gene of microorganisms (see Gerard Muyzer et al, supra). DNA sequences of the variable region 3 (V3) of 16S rRNA genes in a mix population were targeted and PCR amplified as described in detail below. Using this method a consortium comprising members from Thauera, Rhodocyclaceae, Pseudomonadales, Bacteroidaceae, Clostridiaceae, Incertae Sedis, Spirochete, Spirochaetaceaes, Deferribacterales, Brucellaceae and Chloroflexaceae were characterized (FIG. 1). The Thauera strain AL9:8 was the predominant microorganism in the consortium. It represented between 35 to 70% of the constituents during sampling processes. There were 73 unique sequences (SEQ ID NOs: 15-87), which were grouped into eight phylum of Bacteria, which included alpha-Proteobacteria, beta-Proteobacteria, gamma-Proteobacteria, Deferribacteraceae, Spirochaetes, Bacteroidetes, Chloroflexi (Green sulfur bacteria) and Firmicutes/Clostridiales. The primary genera continued to be the beta-Proteobacteria, Thauera and Thauera strain AL9:8 was the dominant constituent. There was a large diversity among the members of Thauera/Azoarcus group (Rhodocyclaceae), where there were 31 unique 16S rDNA sequences whose sequence differences occurred in the primary signature regions of the variable regions. Also the Firmicutes/Clostridiales group were diverse with 16 unique sequences that include constituents from the Clostridia (Clostridiaceae), and the Anaerovorax and Finegoldia group (Incertae Sedis). Further analyses using fingerprint profiling may allow assigning the DNA bands in the DGGE DNA fingerprint to some of these sequences.

Based on these characterizations of samples of an enriched steady state microbial consortium, an embodiment of the invention includes an enriched steady state consortium comprising species from: beta-Proteobacteria (Rhodocyclaceae, specifically Thauera), alpha-Proteobacteria, gamma-Proteobacteria, Deferribacteraceae, Bacteroidetes, Chloroflexi and Firmicutes/Clostridiales phyla. Certain microbial genera and species are known to have the ability to biodegrade oil or its hydrocarbon components. See, co-pending U.S. application Ser. No. 12/194,749, describing specifically, the one or more microbial cultures may be selected from the group consisting of Marinobacterium georgiense (ATCC#33635), Thauera aromatica T1 (ATCC#700265), Thauera chlorobenzoica (ATCC#700723), Petrotoga miotherma (ATCC#51224), Shewanella putrefaciens (ATCC#51753), Thauera aromatica S100 (ATCC#700265), Comamonas terrigena (ATCC#14635), Microbulbifer hydrolyticus (ATCC#700072), and mixtures thereof, having relevant functionalities for improving oil recovery. Comparing the components of an enriched steady state consortium to the phylogeny of known microorganisms having the ability to biodegrade oil or its hydrocarbon components provides a mechanism for selecting a consortium useful for in situ bioremediation. Further, such known microorganisms may be added to a steady state consortium to further enhance in situ bioremediation Accordingly it is within the scope of the invention to provide methods of the invention involving one or more non-indigenous microorganisms is selected from the group consisting of a) Marinobacterium georgiense, Thauera aromatica T1, Thauera chlorobenzoica), Petrotoga miotherma, Shewanella putrefaciens, Thauera aromatica S100, Comamonas terrigena, Microbulbifer hydrolyticus (ATCC#700072), and mixtures thereof; and b) comprises a 16s rDNA sequence having at least 95% identity to a 16s rDNA sequence isolated from the microorganisms of (a).

### Phylogenetic Typing

The following description provides mechanisms for characterizing the constituents of the enriched steady state microbial consortium.

Methods for generating oligonucleotide probes and microarrays for performing phylogenetic analysis are known to those of ordinary skill in the art (Loy, A., et al., Appl. Environ. Microbiol. 70: 6998-700, 2004) and (Loy A., et al., Appl. Environ. Microbiol. 68: 5064-5081, 2002) and (Liebich, J., et al., Appl. Environ. Microbiol. 72: 1688-1691, 2006). These methods are applied herein for the purpose of identifying microorganisms present in an environmental sample.

Specifically, conserved sequences of the 16S ribosomal RNA coding region of the genomic DNA were used herein. However there are other useful methodologies for phylogenetic typing noted in the literature. These include: 23S rDNA or gyrate A genes or any other highly conserved gene sequences. 16S rDNA is commonly used because it is the largest database of comparative known phylogenetic genotypes and has proven to provide a robust description of major evolutionary linkages (Ludwig, W., et al., Antonie Van Leewenhoek, 64: 285, 1993 and Brown, J. R. et al., Nature Genet., 28: 631, 2001).

The primers described herein were chosen as relevant to environmental samples from an oil reservoir (Grabowski, A., et al., FEMS Micro. Eco. 544: 427-443, 2005) and by comparisons to other primer sets used for other environmental studies. A review of primers available for use herein can be found in Baker et al., (Baker, G. C. et al., Review and re-analysis of domain-specific primers, J. Microbiol. Meth. 55: 541-555, 2003). Any primers which generate a part or whole of the 16S rDNA sequence would be suitable for the claimed method.

DNA extraction by phenol/chloroform technique is known in the art and utilized herein as appropriate for extracting DNA from oil contaminated environmental samples. However, there are other methodologies for DNA extraction in the literature that may be used in accordance with the present invention.

DNA sequencing methodologies that generate >700 bases of high quality sequence may be used for the type of plasmid based sequencing in accordance with the present invention in conjunction with other sequence quality analysis programs. The comparisons by homology using the BLAST algorithms to any comprehensive database of 16S rDNAs would achieve an acceptable result for identifying the genera of microorganisms present in the environmental sample. The most widely used databases are ARB (Ludwig, W., et al., ARB: a software environment for sequence data. Nucleic Acid Res., 32: 1363-1371, 2004) and NCBI.

### Fingerprint Profiling

Fingerprint profiling is a process of generating a specific pattern of DNA bands on an electrophoresis gel that are defined by their length and sequence. This profile is used to identify and describe the predominant microbial population of a culture assessing microbial diversity and population stability at particular metabolic state. For example, each band and its intensity in a given DGGE fingerprint profile represent an individual bacterial species present in the community and its relative representation in the population. Once generated, the data represents a fingerprint profile of the population at a given point in time and under certain growth conditions. The DGGE fingerprint profile can be compared to profiles of the consortium under prescribed growth conditions.

### Denaturing Gradient Gel Electrophoresis

This technique has been adopted to analyze PCR amplification products by targeting variable sequence regions in conserved genes such as one of the nine variable regions found in the 16S rRNA gene of microorganisms (Gerard Muyzer et al., Appl. Environ. Microbiol., 59: 695, 1993 and Neefs, J-M et al., Nucleic acids Research, 18: 2237, 1990, and Botter, E. C., ASM News 1996). DGGE provides a genetic fingerprint profile for any given population.

Denaturing gradient gel electrophoresis (DGGE) and temperature gradient gel electrophoresis (TGGE) are electrophoresis-gel separation methods that detect differences in the denaturing behavior of small DNA fragments (50-600 bp), separating DNA fragments of the same size based on their denaturing or “melting” profiles related to differences in their base sequence. This is in contrast to non-denaturing gel electrophoresis where DNA fragments are separated only by size.

The DNA fragments are electrophoresed through a parallel DGGE gel, so called because the linear gradient of denaturant ˜30-60% (urea/formamide) is parallel to the gel's electric field. Using DGGE, two strands of a DNA molecule separate or melt, when a chemical denaturant gradient is applied at constant temperature between 55°-65° C. The denaturation of a DNA duplex is influenced by two factors: 1) the hydrogen bonds formed between complimentary base pairs (since GC rich regions melt at higher denaturing conditions than regions that are AT rich); and 2) the attraction between neighboring bases of the same strand, or “stacking”. Consequently, a DNA molecule may have several melting domains, depending upon the denaturing conditions, which are characteristic of and determined by their nucleotide sequence. DGGE exploits the fact that virtually identical DNA molecules that have the same length and similar DNA sequence, which may differ by only one nucleotide within a specific denaturing domain, will denature at different conditions. Thus, when the double-stranded (ds) DNA fragment moves (by electrophoresis) through a gradient of increasing chemical denaturant, urea, formamide or both, it begins to denature and undergoes both conformational and mobility changes. At some point the two strands of the DNA to will come completely apart (also called “melting”). However, at some intermediate denaturant concentrations, as the denaturing environment increases, the two strands will become partially separated, with some segments of the molecules still being double-stranded and others being single-stranded, specifically at the particular low denaturing domains; thus, forming variable and intermediate denatured structures, which begin to retard the movement of the fragments through the gel denaturant gradients. The dsDNA fragment will travel faster than a denatured single-stranded (ss) DNA fragment. The more denatured fragment will travel slower through the gel matrix. The DGGE gel electrophoresis method offers a “sequence dependent, size independent method” for separating DNA molecules.

In practice, the DGGE electrophoresis is conducted at a constant temperature (60° C.) and chemical denaturants are used at concentrations that will result in 100% of the DNA molecules being denatured (i.e., 40% formamide and 7M urea). This variable denaturing gradient is created using a gradient maker, such that the composition of denaturants in the gel gradually decreases from the bottom of the gel to the top, where the fragments are loaded, e.g., 60% to 30%.

The principle used in DGGE profiling can also be applied to a second method, Temperature Gradient Gel Electrophoresis (TGGE), which uses a temperature gradient instead of a chemical denaturant gradient. This method makes use of a temperature gradient to induce the conformational change of dsDNA to ssDNA to separate fragments of equal size with different sequences. As in DGGE, DNA fragments will become immobile at different positions in the gel depending upon their different nucleotide sequences.

For characterizing microbial communities, DGGE fingerprint profiling has been applied to identify and characterize the genetic diversity of complex microbial populations much as, riboprinting has been applied to identify new environmental isolates by their rRNA fingerprint profile as being the same or different from previously described strains.

In practicing DGGE profiling, the variable sequence regions found in the 16S rRNA gene of microorganisms are targeted in PCR amplification of whole DNA isolated from a mix population (Gerard Muyzer et al (supra)). The variable or “V” regional segment not only differs in nucleotide sequence, but in length and secondary structure in the sequence. It is only recognizable as similar sequence in only closely related microorganisms. There are nine variable regions in the bacterial/archaeal 16S gene. These variable regions are designated by the letter V plus the number 1 through 9. Two V regions are most useful in using DGGE profile analysis, the V3 region and the V4/V5 region. Both V regions are flanked by universally conserved U regions.

The V3 region is flanked by two U sequences. The first at base coordinates 341 to 357 where bacteria and archaeal signature sequences exist. Bacterial universal primer, UB357F (SEQ NO: 5) and Archaeal universal primers 341F1 and 341F2, (SEQ NO: 7 and SEQ NO: 9 respectively) are designed from this region. The other U region, which is universally conserved in all phylogenetic domains, is found at base coordinates, 518 to 534. The domain universal reverse primer, UB518R (SEQ NO: 5) is designed from this region.

The V4/V5 region is also flanked by two universal conserved sequences. The first as above is the domain universal region at base coordinates, 518 to 534. The domain universal forward, U519F (SEQ NO: 11) was designed from this region. The other region at base coordinates 918 to 960, where additional universal bacterial and archaeal signature sequences exist. The bacterial universal reverse primer, UB939R (SEQ NO: 14) and Archaeal universal primer UA958R (SEQ NO: 13) in this application were designed from this region.

A 40-bp GC-rich clamp in the 5′ end of one of the PCR primers makes the method robust for genetic fingerprint profiling analysis of microbial populations. For profile analysis of region V3, the GC-clamp was designed into the bacterial universal primer, designated dG•UB357F (SEQ NO: 6) and archaeal universal primers designated dG•341F1 and dG•341F2, (SEQ NOs: 8 and 10 respectively) and for the V4/V5 region, the domain universal forward, designated dG•U 519F (SEQ NO: 12) was designed from this region. Using this method, PCR amplification of the total DNA from a diverse microbial population produces amplified fragments consisting of heterogeneous sequences of approximately 193 bp in length. These 16S rDNA fragments, when analyzed by DGGE analysis, demonstrate the presence of multiple distinguishable bands in the separation pattern, which are derived from the many different species constituting the population. Each band thereby, represents a distinct member of the population. Intensity of each band is most likely representative of the relative abundance of a particular species in the population, after the intensity is corrected for rRNA gene copies in one microbe versus the copies in others. The banding pattern also represents a DGGE profile or fingerprint of the populations. Using this method, it is possible to identify constituents, which represent only 1% of the total population. Changes in the DGGE fingerprint profile of the population can signal changes in the parameters, e.g., the electron donors and electron acceptors that determine the growth and metabolism of the community as a whole.

### Relevant Functionalities of Characterized, Enriched Steady State Microbial Consortium

Once an enriched steady state microbial consortium has been characterized, or in certain embodiments prior to constituent genetic characterization, the consortium may be assayed for one or more relevant functionality related to bioremediation of a hydrocarbon-contaminated site, including ability to degrade crude oil under the conditions of interest. Assays for the relevant functionalities include microsand column release assay and the LOOS (Liberation of Oil Off Sand) test (see Example 8,) and the “sand packed slim tube or core flood test.

### Inoculation of an Environmental Site for In Situ Bioremediation.

The following steps are taken to inoculate an environmental site for in situ bioremediation:

a) Inoculating the microbial consortium in a bioreactor containing a anaerobic minimal salts medium, the target crude oil and an appropriate electron acceptor (e.g., nitrate herein).

b) Incubating the microbial consortium of step (a) at a temperature similar to the target site to obtain a seed population of the microbial consortium (e.g. 30° C., or in the range of room temperature, +/−5° C. in this disclosure).

c) Inoculating the seed microbial consortium of step (b) under anaerobic condition into the contaminated site's subsurface.

d) Injecting the biological mixture of step (c) in to the subsurface, followed by injection water with dissolved electron acceptor to push the consortium mixture into the subterranean matrix, allowing the microbial consortium to grow and propagate resulting in in-situ bioremediation of the hydrocarbon-contaminants.

### Bioremediation Hydrocarbon Contaminated Sites and Oil Pipeline Maintenance

Hydrocarbons are represented by many natural organic compounds, such as crude oil, that were available on earth before the formation of an oxic atmosphere. Anaerobic hydrocarbon degradation therefore, is, in all likelihood, an evolutionary, rather old, metabolic capability of microorganisms. Coupling anaerobic hydrocarbon oxidation to different modes of energy allows these processes to occur throughout the different redox zones found in Nature. These anaerobic processes occur under nitrate, ferric ion, sulfate, and manganese reducing, phototrophic and syntrophic conditions.

Denitrifying bacteria provide an excellent choice for in situ bioremediation, because they grow rapidly and yield substantial cell mass. In addition, denitrifying microorganisms from the genera Thauera, Azoarcus and Dechloromonas have been shown to breakdown hydrocarbons such as benzene, toluene, ethylbenzene, and xylenes (BTEX), which are constituents of crude oil. In situ bioremediation remains potentially the most cost-effective cleanup technology for removing these compounds from contaminated sites.

The ability of the POG1 steady state consortium to metabolize hydrocarbons makes this consortium useful in in-situ bioremediation of areas contaminated with crude oil, BTEX and other related hydrocarbons. Bioremediation takes place when the steady state consortium cells are exposed to hydrocarbons and convert them into products such as carbon dioxide, water, and oxygen or when growth of the cells of POG1 steady state consortium allow release of high molecular weight hydrocarbons to the surface for subsequent removal by physical clean up methods. In some embodiments, the steady state consortium can be incubated in the environment to be bioremediated without any added co-substrate, or other carbon or energy source. The bioremediation process can be monitored by periodically taking samples of the contaminated environment, extracting the hydrocarbons, and analyzing the extract using methods known to one skilled in the art.

Contaminated substrates that may be treated with the steady state consortium include, but are not limited to, beach sand, harbor dredge spoils, sediments, wastewater, sea water, soil, sand, sludge, air, and refinery wastes.

In another embodiment, the contaminated substrate can be an oil pipeline. Hydrocarbon incrustation and sludge build-up are significant causes of decreased pipeline performance and can eventually lead to failure of the pipeline. Because of the ability of the POG1 steady state consortium to release hydrocarbons (see Example 7), its application to an oil pipeline containing incrusted hydrocarbons or hydrocarbon-containing sludge can be useful in the removal of the unwanted hydrocarbons from the pipeline.

In some embodiments, other agents effective in the bioremediation of hydrocarbons can be added to the POG1 steady state consortium bioremediation. These other agents may include one or more additional microorganism such as bacteria, yeast, or fungi. The agents may also include a chemical compound that is not lethal to the steady state consortium, but enhances degradation or modification of hydrocarbons and/or other contaminants or stimulates growth of the active strains to affect oil release.

An additional benefit of the application of the use of a enrichment of denitrifying consortium have the potential to prevent of the damage to the oil pipeline and oil recovery hardware. Corrosion of the oil pipeline and other oil recovery hardware may be defined as the destructive attack on metals by some microbial, chemical or electrochemical mechanisms. Microbially induced corrosion in oil pipelines is known (EP3543361 B and U.S. Pat. No. 4,879,240A) and is caused by a variety of microorganisms including, but not limited to, aerobic bacteria, anaerobic bacteria, acid forming bacteria, slime formers, and sulfate reducing bacteria (SRB). In an anaerobic environment, corrosion is most commonly attributed to the growth of dissimilatory SRB. This group of bacteria is responsible for possibly 50% of all instances of corrosion. The control of microbial corrosion in oil recovery operations generally incorporates both physical or mechanical and chemical treatments.

The use of nitrate as a means of controlling the activity of SRB and removing hydrogen sulfide from oil pipeline and other oil recovery hardware is well documented. There is a report (Jigletsova, S. K., et al. 2004, CORROSION/2004. Houston, Tex.: NACE International. Paper No. 04575) demonstrated that nitrate treatment is a effective alternative to biocide treatment, to reduce SRB numbers and their activity. It is a hypothesis that a compound that impedes the metabolism of microbes that are constituents in corrosion-associated biofilms could have an impact on compromising their effect on corrosion may limit the amount/rate of corrosion. The stimulation of nitrate-reducing bacteria (nrb) in oilfield systems to control sulfate-reducing bacteria (srb), microbiologically influenced corrosion (mic) and reservoir souring an introductory review, published by the Energy Institute, London, 2003). Because nitrate is a better electron acceptor than sulfide, nrb have a competitive advantage over srb. Nitrate produces a higher growth yield than sulfide reduction does. Application of denitrifying microorganisms for enhancing oil recovery, therefore, can also be used as a cost a cost effective, efficient and environmentally acceptable means of controlling SRB and remediating hydrogen sulfide contaminated systems, avoiding the use of expensive and environmentally unacceptable organic biocides. The use of the POG1 consortium therefore, may not only be beneficial to oil recovery, it may also prevent costly damage corrosion to the oil pipeline and other oil recovery hardware.

Microorganisms may be delivered to the contaminated substrate by any one of the many well-known methods including those described by Newcombe, D. A., and D. E. Crowley (Appl. Microbiol. Biotechnol. 51:877-82, 1999); Barbeau, C., et al., (Appl. Microbiol. Biotechnol. 48:745-52, 1997); and U.S. Pat. Nos. 6,573,087, 6,087,155, and 5,877,014.

### Benefits of In Situ Bioremediation of Hydrocarbon-Contaminated Sites Using Enriched Steady State Microbial Consortium

In this application, methods are disclosed to provide an enriched steady state consortium of microbial population, under denitrifying conditions (using an anaerobic electron acceptor), using a chemostat bioreactor. The enriched steady state consortium population anaerobically degrades crude oil or its hydrocarbon components under site specific conditions to modify the physiochemical properties of the hydrocarbons, resulting in in-situ bioremediation of the hydrocarbon-contaminated site. The ideal consortium would be developed and enriched for hydrocarbon degrading microbes from an indigenous microbial population.

### GENERAL METHODS

### Growth of Microorganisms

Techniques for growth and maintenance of anaerobic cultures are described in “Isolation of Biotechnological Organisms from Nature”, (Labeda, D. P. ed. p 117-140, McGraw-Hill Publishers, 1990). Anaerobic growth was measured by nitrate depletion from the growth medium over time. Nitrate was utilized as the primary electron acceptor under the growth conditions used in this invention. The reduction of nitrate to nitrogen has been previously described (Moreno-Vivian, C., et al., J. Bacteriol. 181: 6573-6584, 1999). In some cases, nitrate reduction processes lead to nitrite accumulation, which is subsequently, further reduced to nitrogen. Accumulation of nitrite is therefore also considered evidence for active growth and metabolism by these microorganisms.

Description of the Chemostat Bioreactor Used in this Invention

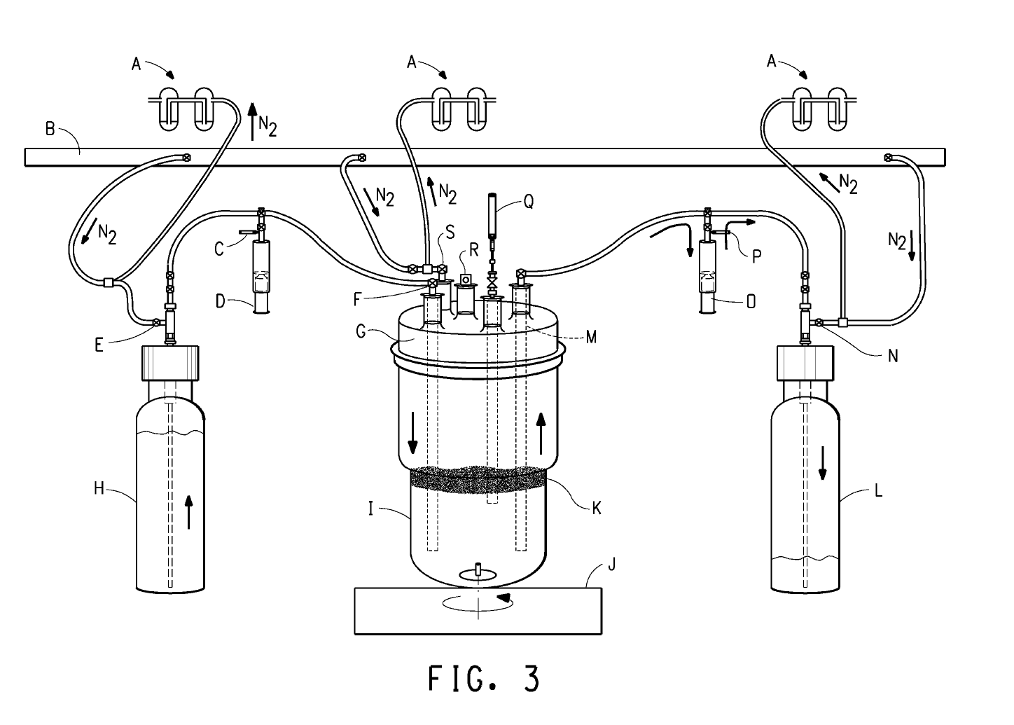

In this disclosure, a chemostat bioreactor was used as a bioreactor to maintain the consortium population in a steady state, using crude oil in excess as the sole energy source and a limiting nitrate supply, as the electron acceptor. FIG. 3 shows a diagram of the chemostat bioreactor used in this invention. The chemostat bioreactor was designed and used as a continuous-cultivation system, using a constant feed of medium and nitrate to develop a steady state population designated “POG1 consortium”. The chemostat bioreactor was operated under anaerobic conditions, at room temperature, pH 7.4 and one atmosphere pressure, using the targeted crude oil (Milne Pont reservoir, North Slop of Alaska) as the carbon source (primary source of electron donors), and supplying a minimal salts medium (Table 2) containing minimal essential minerals, salts, vitamins and nitrate, as the primary electron acceptor, for growth.

TABLE 2
Composition of the SL10 minimal salts medium - The pH of the medium
was adjusted to between 7.4-7.8

| Growth component | Final Concentration | | Chemical Source |
|---|---|---|---|
| Nitrogen | 18.7 | μM | NH₄Cl |
| Phosphorus | 3.7 | μM | KH₂PO₄ |
| Magnesium | 984 | μM | MgCl₂•6H₂O |
| Calcium | 680 | μM | CaCL₂•2H₂O |
| Sodium chloride | 172 | mM | NaCl |
| Trace metals | 670 | μM | nitrilotriacetic acid |
| | 15.1 | μM | FeCl₂•4H₂O |
| | 1.2 | μM | CuCl₂•2H₂O |
| | 5.1 | μM | MnCL₂•4H₂O |
| | 12.6 | μM | CoCl₂•6H₂O |
| | 7.3 | μM | ZnCl₂ |
| | 1.6 | μM | , H₃BO₃ |
| | 0.4 | μM | Na₂MoO₄•2H₂O |
| | 7.6 | μM | NiCl₂•6H₂O |
| Selenium-tungstate | 22.8 | nM | Na₂SeO₃•5H₂O |
| | 24.3 | nM | Na₂WO₄•2H₂O |
| PH buffer/Bicarbonate | 23.8 | nM | NaHCO₃ |
| vitamins | 100 | μg/L | vitamin B12 |
| | 80 | μg/L | p-amino-benzoic acid |
| | 20 | μg/L | nicotinic acid |
| | 100 | μg/L | calcium pantothenate |
| | 300 | μg/L | pyridoxine hydrochloride |
| | 200 | μg/L | thiamine-HCL•2H₂O |
| | 50 | μg/L | alpha-lipoic acid |
| Electron acceptor | 0.4 | g/L | NaNO₃ |

The chemostat bioreactor was set up in a chemical hood at room temperature (20 to 25° C.). All headspaces were anaerobic, using a blanket of nitrogen and an open-ended nitrogen flow (<1 psi) system, with a reverse double bubbler system, containing 5 mL mineral oil closing off the system from the atmosphere. Both the initial SL10 medium in the bioreactor and in the medium feed reservoir were degassed with an anaerobic mix of carbon dioxide and nitrogen (20/80 on a % basis) for 10 min, the pH checked and then titrated with either CO₂/N₂ mix or just N₂ until it was pH7.4. The SL10 minimal salts medium (1 L), in the bioreactor, was initially supplemented with 800 ppm nitrate and 400 mL of the targeted crude oil. The bioreactor was inoculated with 50 mL of the 3^{rd} generation (3^{rd} gen) parent POG1 from enrichment culture (designated EH50:1) grown on the target crude oil and 1600 ppm nitrate for 1 week and incubated at room temperature while shaking at 100 rpm. A magnetic stirrer at the bottom of the reactor was stirring the culture at 40 to 50 rpm.

The SL10 medium, supplemented with 3800 ppm nitrate, was pumped from the medium reservoir (FIG. 3: G) into the chemostat bioreactor by means of the feed syringe pump (KDS230 Syringe Pump, KD Scientific, Holliston, Mass.) (FIG. 3: D). A sampling port was attached to and inline with the feed syringe pump. A 5 mL Becton-Dickinson (BD) sterile plastic polypropylene syringe (FIG. 3: C) (Becton-Dickinson, Franklin Lakes, N.J.) was attached to the sampling port and had a double function: 1) as a sampling syringe for the input feed and 2) as a 5 psi pressure release valve for the feed syringe pump. The effluent from the chemostat bioreactor was pumped into an effluent reservoir (FIG. 3: L) by means of the effluent syringe pump (supra) (FIG. 3: O). A second sampling port was attached to and inline with the effluent syringe pump. The effluent sampling port also had a 5 mL BD sterile plastic polypropylene syringe (supra) attached (FIG. 3: P). Again, it functioned both as a sampling syringe for effluent and as a 5 psi pressure release valve for the effluent syringe pump.

### Obtaining the Environmental Sample

In this disclosure, soil or water samples obtained from anaerobic and microaerophilic (aerobic microorganisms that requires lower levels of oxygen to survive) locations on a hydrocarbon-contaminated site, which had been exposed to tar, creosol and polycyclic aromatic hydrocarbons (PAHs) were used for developing the microbial consortium. Soil samples were taken from locations where PAHs had been shown to be at elevated levels. Soil samples were placed in 500 mL brown bottles, filled to the top, sealed with no air space and, then shipped back to the lab on ice in a cooler. Once in the lab, the samples were placed in a Coy Type B anaerobic chamber (Coy Laboratories, Grass Lake, Mich.), filled with a specific anaerobic gas mixture (oxygen free anaerobic mix of hydrogen, carbon dioxide and nitrogen, 5%, 10% and 85%, respectively) for further processing.

### Ion Chromatography

An ICS2000 chromatography unit (Dionex, Banockburn, Ill.) was used to quantitate nitrate and nitrite ions in the growth medium. Ion exchange was accomplished on an AS15 anion exchange column using a gradient of 2 to 50 mM potassium hydroxide. Standard curves were generated and used for calibrating nitrate and nitrite concentrations.

Genomic DNA Extractions from Bacterial Cultures

To extract genomic DNA from liquid bacterial cultures, cells were harvested and concentrated by filtration onto a 0.2 micron Supor® Filter (Pall Corp, Ann Arbor, Mich.) or by centrifugation. An aliquot (2-5 mL) of a bacterial culture was passed through a 0.2 micron, 25 mm filter disk in a removable cartridge holder using either vacuum or syringe pressure. The filters were removed and placed in the following lysis buffer (100 mM Tris-HCL, 50 mM NaCl, 50 mM EDTA, pH8.0) followed by agitation using a Vortex mixer. The following reagents were then added to a final concentration of 2.0 mg/mL lysozyme, 10 mg/mL SDS, and 10 mg/mL Sarkosyl to lyse the cells. After further mixing with a Vortex mixer, 0.1 mg/mL RNase and 0.1 mg/mL Proteinase K were added to remove the RNA and protein contaminants and the mixture was incubated at 37° C. for 1.0-2.0 hr. Post incubation, the filters were removed and samples were extracted twice with an equal volume of a phenol: chloroform: isoamyl:alcohol (25:24:1, v/v/v) and once with chloroform: isoamyl alcohol (24:1, v/v). One-tenth volume of 5.0M NaCl and two volumes of 100% ethanol were added to the aqueous layer and mixed. The tubes were frozen at −20° C. overnight and then centrifuged at 15,000×g for 30 min at room temperature to pellet chromosomal DNA. The pellets were washed once with 70% ethanol, centrifuged at 15,000×g for 10 min, dried, resuspended in 100 μL of de-ionized water and stored at −20° C. An aliquot of the extracted DNA was analyzed on an agarose gel to ascertain the quantity and quality of the extracted DNA.

Population Analysis of the Microorganisms of the Steady State Consortium and Parent Enrichment Cultures Using Cloned 16S rDNA Libraries

Primer sets were chosen from Grabowski et al. (FEMS Microbiol. Ecol., 54: 427-443, 2005) to generate 16S rDNA of microbial species in DNA samples prepared from the consortium. The combination of forward primer (SEQ ID NO: 1) and reverse primers (SEQ ID NOs: 2 or 3) were chosen to specifically amplify the bacterial 16S rDNA sequences.

The PCR amplification mix included: 1.0× GoTaq PCR buffer (Promega), 0.25 mM dNTPs, 25 pmol of each primer, in a 50 μL reaction volume. 0.5 μL of GoTaq polymerase (Promega) and 1.0 μL (20 ng) of sample DNA were added. The PCR reaction thermal cycling protocol used was 5.0 min at 95° C. followed by 30 cycles of: 1.5 min at 95° C., 1.5 min at 53° C., 2.5 min at 72° C. and final extension for 8 min at 72° C. in a Perkin Elmer 9600 thermal-cycler (Waltham, Mass.). This protocol was also used with cells from either purified colonies or mixed species from enrichment cultures.

The 1400 base pair amplification products for a given DNA pool were visualized on 0.8% agarose gels. The PCR reaction mix was used directly for cloning into pPCR-TOPO4 vector using the TOPO TA cloning system (Invitrogen) as recommended by the manufacturer. DNA was transformed into TOP10 chemically competent cells selecting for ampicillin resistance. Individual colonies (˜48-96 colonies) were selected and grown in microtiter plates for sequence analysis.

### Plasmid Template Preparation

Large-scale automated template purification systems used Solid Phase Reversible Immobilization (SPRI, Agencourt, Beverly, Mass.) (DeAngelis, M. M., et al., Nucleic Acid Res., 23: 4742-4743, 1995). The SPRI® technology uses carboxylate-coated, iron-core, paramagnetic particles to capture DNA of a desired fragment length based on tuned buffering conditions. Once the desired DNA is captured on the particles, they can be magnetically concentrated and separated so that contaminants can be washed away.

The plasmid templates were purified using a streamlined SprintPrep™ SPRI protocol (Agencourt). This procedure harvests plasmid DNA directly from lysed bacterial cultures by trapping both plasmid and genomic DNA to the functionalized bead particles and selectively eluting only the plasmid DNA. Briefly, the purification procedure involves addition of alkaline lysis buffer (containing RNase A) to the bacterial culture, addition of alcohol based precipitation reagent including paramagnetic particles, separation of the magnetic particles using custom ring based magnetic separator plates, 5× washing of beads with 70% ETOH and elution of the plasmid DNA with water.

rDNA Sequencing, Clone Assembly and Phylogenetic DNA Analysis

DNA templates were sequenced in a 384-well format using BigDye® Version 3.1 reactions on ABI3730 instruments (Applied Biosystems, Foster City, Calif.). Thermal cycling was performed using a 384-well thermal-cycler. Sequencing reactions were purified using Agencourt's CleanSeq® dye-terminator removal kit as recommended by the manufacturer. The reactions were analyzed with a model ABI3730XL capillary sequencer using an extended run module developed at Agencourt. All sequence analyses and calls were processed using Phred base calling software (Ewing et al., Genome Res., 8: 175-185, 1998) and constantly monitored against quality metrics.

Assembly of rDNA Clones

A file for each rDNA clone was generated. The assembly of the sequence data generated for the rDNA clones was performed by the PHRAP assembly program (Ewing, et al., supra). Proprietary scripts generate consensus sequence and consensus quality files for greater than one overlapping sequence read.

Analysis of rDNA Sequences

Each assembled sequence was compared to the NCBI (rDNA database; ˜260,000 rDNA sequences) using the BLAST algorithm program (Altschul, supra). The BLAST hits were used to group the sequences into homology clusters with ≧90% identity to the same NCBI rDNA fragment. The homology clusters were used to calculate proportions of particular species in any sample. Because amplification and cloning protocols were identical for analysis of each sample, the proportions could be compared from sample to sample. This allowed comparisons of population differences in samples taken for different enrichment selections and or at different sampling times for the same enrichment consortium culture.

### Using Fingerprint Profiles to Characterize the Genetic Diversity of Complex Microbial Populations

For characterizing microbial communities, DGGE fingerprint profiling (as described above) has been applied to identify and characterize the genetic diversity of complex microbial communities.

Targeting the variable sequence regions found in the 16S rRNA gene of microorganisms, Gerard Muyzer et al (supra) PCR amplified DNA sequence of the V3 region of 16S rRNA genes in a mixed population. As stated above, the region is flanked by two universal conserved primer regions one at 341 to 357 and the other at 518 to 534. A 40-bp GC-rich clamp in the 5′ end of one of the forward PCR primers, which included: universal bacterial primer 357, universal archaeal primers, 341F1, 341F2, (SEQ NOs: 5, 7, 9) were designed as dG•UB 357, dG•UA 341F1 and dG•UA 341F2, respectively (SEQ NOs: 6, 8, 10). As described above, the rDNA PCR products were electrophoresed on a linear gradient of denaturant ˜30-60% (urea/formamide) which is parallel to the gel's electric field. DGGE gels were cast and electrophoresed using a D Gene™: Denaturing Electrophoresis System from BIORAD (Hercules, Calif.) following manufacturer's suggested protocols. rDNA samples were electrophoresed at a constant temperature of 60° C. for 8-24 hr at an appropriate voltage depending upon the 16S rDNA fragment population being analyzed. The electrophoresis buffer (1×TAE) was preheated to the target temperature in the D GENE chamber prior to electrophoresis. DGGE gels were stained with SYBR® GOLD nucleic acid stain (Invitrogen, Carlsbad, Calif.) for visualization and imaged on a Kodak imaging station 440. Multiple distinguishable bands, which were visualized in the separation pattern, were derived from the different species which constituted the POG1 population. Each band thereby, represented a distinct member of the population. Intensity of each band was most likely representative of the relative abundance of a particular species in the population, after the intensity was corrected for rRNA gene copies in one microbe versus the copies in others. The banding pattern also represented a DGGE profile or fingerprint of the populations. It is possible to identify constituents, which represent only 1% of the total population. Changes in the DGGE fingerprint profile of the population can signal changes in the parameters, e.g., the electron donors and electron acceptors that determine the growth and metabolism of the community as a whole. Thus the method described above provided a unique and powerful tool for conclusive identification of various microbial species within a mixed population.

### Microsand Column Oil Release Test

Isolated bacterial strains were examined for their ability to release oil from sand using a microsand column assay to visualize oil release. The microsand column consisted of an inverted glass Pasteur pipette containing the sand (10 to 100 microns) from the Alaskan North Slope oil reservoirs, which had been coated with crude oil and allowed to age for at least one week. Specifically, oil and sand were autoclaved separately to sterilize. Autoclaved sand samples are then transferred to a vacuum oven and dried at 180° C. for a minimum of one week. Sterilized dried sand and oil were then combined ˜1:1 v/v in an anaerobic environment. The mixtures were stirred and allowed to age for a minimum of seven days in an anaerobic environment. The barrels of glass Pasteur pipette (5¾ inches) were cut to approximately half height (3 inches) and autoclaved. The cut end of the pipette was plunged into the sand/oil mix and the core filled to about 0.5 inches in height from the bottom of the pipette barrel. Next, the cut-end of the pipette, which contained the oil/sand mixture, was then placed (with the tapered end of the pipette pointing upward) into the 13 mm glass test tube. A test inoculum in four milliliters of minimal salts medium was added to the 13 mm glass tube. The apparatus was sealed inside 23×95 mm glass vials in an anaerobic environment. Oil released from the sand collects in the narrow neck of the Pasteur pipettes or as droplets on the surface of the sand layer. Cultures that enhanced release of oil over background (sterile medium) were presumed to have altered the interaction of the oil with the sand surface, demonstrating the potential to contribute to enhancing oil recovery in a petroleum reservoir.

### Gas Chromatography

A flame ionization detector gas chromatography (GC FID) method was developed to analyze the wet sand from the sacrificed slim tubes for residual oil. An empirical relationship was determined based on North Slope sand and the intrinsic pore volume of packed sand, e.g., for 240 g of packed sand there was a pore volume of 64 mL. Weights of the individual sand samples were obtained and the oil on the sand was extracted with a known amount of toluene. A sample of this toluene with extracted oil was then analyzed by GC. The samples were analyzed using an Agilent Model 5890 Gas Chromatograph (Agilent, Wilmington, Del.) fitted with equipped with a flame photoionization detector, a split/splitless injector and capillary column, DB5 column (length 30 m×thickness 0.32 mm, film thickness 0.25 μm). An aliquot of 2 μL was injected with an analysis of 42 min. The injector temperature was at 300° C. and the detector temperature kept at 300° C. The carrier gas was helium, flowing at 2 mL/min. The FID detector gases were air and hydrogen flowing at 300 mL/min and 30 mL/min, respectively. A calibration curve was generated and used to determine the amount of oil in toluene on a weight percent basis. The calibration curve used 0.01, 0.1, 1, 5, and 10 wt % dissolved crude oil in toluene.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions.

In the present disclosure, it was intended to develop a steady state consortium of microorganisms, under anaerobic denitrifying conditions, using crude oil as the carbon source would maintain the relative abundance of various microbial species of the consortium hence allowing the consortium's optimal operation in in-situ bioremediation of hydrocarbon-contaminated sites as compared to the ability of a single major species on the consortium as shown below.

Additional abbreviations used in the Examples below are as follows: “hr” means hour(s), “min” means minute(s), “L” means liter(s), “mL” means milliliters, “μL” means microliters, “g” means gram, “mg/mL” means milligram per milliliter, “M” means molar, “mM” means millimolar, “mmoles” means millimoles, “μmoles” means micromoles, pmoles means picomole(s), “° C.” means degrees Centigrade, “bp” means base pair(s), “rpm” refers to revolutions per minute, “ppm” means part per million, “v/v” means volume for volume, “v/v/v” means volume for volume for volume, “w/v” means weight for volume, “mL/hr” means milliliter per hour, “mL/min” means milliliter per minute, “%” means percent, “g” means gravitational force, “nm” means nano meter, “psi” means per square inch, “sec” means second, “LB” means Luria Broth culture medium, “R2A” means Reasoner's 2A culture medium, “PCR” means polymerase chain reaction and “SDS” means sodium dodecyl sulfate.

### Example 1

### Enrichment of a Microbial Consortium from an Environmental Sample on Targeted Oil, as the Carbon Source, Under Denitrifying Anaerobic Conditions

### Development of the Parent POG1 Consortium

For the present Example, parent enrichment cultures and a screening protocol were developed to identify microbes capable of growth under anoxic conditions on either crude oil or its components or samples from a hydrocarbon-contaminated site as the sole source of carbon. Nitrate was used as the primary electron acceptor as described herein. Soil samples were diluted at a 1 to 10 w/v ratio (10 g in 100 mL medium) and incubated in the SL10 medium and 250 ppm sodium nitrate as the electron acceptor for 72 hr as described below. These soil suspensions were used as an inoculum into 60 mL serum vials that contained 2:1 v/v of the minimal salts medium (20 mL) and the autoclaved crude oil (10 mL). Inoculations for the enrichment cultures were performed in the Coy anaerobic glove bag as described above. All crude oil used in the present Examples was from Milne Point, Prudhoe Bay on the Alaskan North Slop. The enrichment cultures were maintained anaerobically in the gas tight, septa sealed vials. These cultures were grown with moderate shaking (100 rpm) at ambient temperatures for weeks to months and sampled regularly for nitrate depletion and nitrite accumulation, visible turbidity and visible altered oil viscosity or oil adherence to glass. Cultures were occasionally sampled for analysis of their structure of microbial populations by rDNA sequence typing.

After 10 to 15 days, a biomass had developed in the original enrichment cultures that used crude oil for as the carbon source. Using these enrichments as an inoculum, a new series of enrichment parent subcultures were prepared. These second set of enrichment subcultures were designated “1^{st} generation parent cultures” (1^{st} gen) and were inoculated, capped and sealed in the anaerobic chamber. The 60 mL sub-culture serum vials contained 30 mL of the SL10 minimal salts medium (Table 2) with 250 ppm sodium nitrate and 15 mL autoclaved crude oil. The 1^{st} gen subcultures were grown with moderate shaking (100 rpm) at ambient temperatures for several weeks to three months and sampled regularly for nitrate depletion and nitrite accumulation, or in some cases, nitrite depletion. Changes observed included: visible turbidity, biofilms observed on the glass bottles or on the oil aqueous interface, oil-water emulsion, and visible altered oil viscosity or oil adherence to glass. Cultures were intermittently sampled for 16S rDNA phylogenetic typing.

When all available nitrates and produced-nitrites were reduced, the cultures were anaerobically subcultured into fresh medium supplemented with additional 250 ppm of sodium nitrate. Culture sampling was performed as before. After three months of growth and one to three subcultures, the resulting subculture populations were characterized using 16S rDNA typing (see above). The enrichment populations consisted of both facultative and strict anaerobes. These included various species of beta-Proteobacteria, primarily Thauera species and other species from: beta-Proteobacteria (Rhodocyclaceae), alpha-Proteobacteria, gamma-Proteobacteria, Deferribacteraceae, Bacteroidetes, Chloroflexi and Firmicutes/Clostridiales phyla (FIG. 1).

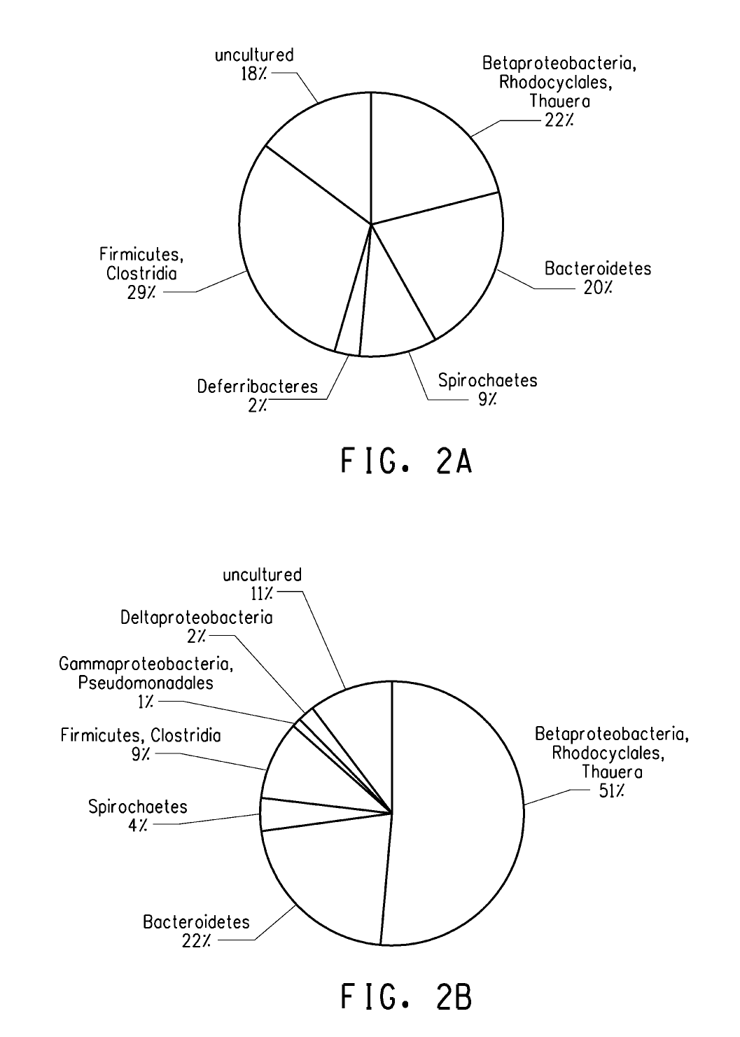

Since the individual enrichment populations were similar to each other, they were anaerobically pooled and inoculated into one liter of SL10 medium with 250 ppm sodium nitrate. The inoculated medium was then divided into 250 mL portions and each aliquot was inoculated into one of four 500 mL-serum bottles containing 125 mL of sterile crude oil. All bottles were anaerobically sealed. The cultures were referred to as “second-generation parent cultures” (2^{nd} gen). Enrichments samples (designated EH36:1 A, EH36:1B, EH36:1C, EH36:1 D) (see Table 5) of the 2^{nd} gen cultures, were grown with moderate shaking (100 rpm) at ambient temperatures for several weeks and sampled regularly for nitrate and nitrite depletion. Nitrate was replenished to 250 ppm on four separate occasions. After the fourth depletion of nitrate, a 10 mL aliquot from one of the cultures was anaerobically inoculated and sealed into a 500 mL serum bottle containing 200 mL of SL10 medium with 2400 ppm sodium nitrate and 100 mL sterile crude oil, and designated as “third-generation parent” (3^{rd} gen) (designated EH40:1 and EH44:1). The 2^{nd} gen cultures were continued on 250 ppm sodium nitrate, by removing 150 mL of culture and adding back 150 mL of sterile SL 10 minimal salts medium plus nitrate. All consortium cultures were incubated as described above for several weeks and regularly sampled for nitrate and nitrite depletion. After the 3^{rd} gen parent cultures had depleted the 2400 ppm sodium nitrate and all of the produced nitrite, all enrichment cultures were replenished with 2400 ppm sodium nitrate. After 190 days, all 2^{nd} and 3^{rd} gen enrichments had reduced 6600 ppm nitrate. Cultures were then sampled for 16S rDNA phylogenetic typing to characterize their populations (FIG. 2). The members of population profiles of the enrichments were similar to what had been detected in previous enrichments.

### Example 2

### Monitoring Denitrification and Growth of a Steady State Consortium in a Chemostat Bioreactor

Growth of the steady state POG1 consortium in the chemostat was monitored by optical density (OD₅₅₀) and nitrate reduction through taking daily samples for six weeks and then every second to third day for the next nine weeks. The nitrate and nitrite concentrations were determined by ion chromatography as described above. For the first two weeks, nitrate was fed at 14 ppm/day and thereafter at 69 ppm/day. Table 3 shows that equilibrium for nitrate reduction was reached after 9 days, where all of the nitrate, as well as the produced nitrite, were completely reduced. The culture completely reduced its nitrate supply for the next 97 days. Cell density equilibrium was reached after 32 days, two weeks after the nitrate feed had been increased by approximately five fold. The optical densities remained relatively constant for the next 74 days. At 35 to 43 days, the cells started to aggregate together and form biofilms at the oil-aqueous interface and oil water emulsions were observed. These culture characteristics made it difficult to obtain homogenous samples for growth measurements. Between 30 and 32 days into the experiment, the magnetic stirrer had stopped mixing and nitrate reduction was interrupted due to incomplete mixing of the culture in the bioreactor. Once the stirrer was restarted, nitrate was completely reduced within two days and the chemostat returned to equilibrium.

The steady state POG1 consortium consumed 6662 mg or 107.5 mol of nitrate in 106 days before nitrate reduction began to decrease as indicated by the presence of 27 ppm nitrite in the effluent after 106 days. The decreased rate of nitrate reduction seemed to indicate that the target component of the oil was becoming limiting. The denitrification of nitrate and its reduced nitrite to nitrogen is equivalent to 537.3 mmol of electrons consumed in crude oil oxidation (Rabus, R., et al., Arch Microbiol., 163: 96-103, 1995). It follows that the equivalent of 1.23 g of decane (8.6 mmol) was degraded to carbon dioxide. Therefore since 400 g of crude oil had been added to the chemostat bioreactor, theoretically approximately 0.31% of the oil had been dissimilated.

TABLE 3
Monitoring the optical density, nitrate feed and denitrification of the POG1 consortium in the chemostat bioreactor

| | Time (days) | | | | | | | | | | | |
|---|---|---|---|---|---|---|---|---|---|---|---|---|
| | 0 | 4 | 9 | 11 | 18 | 32 | 42 | 57 | 71 | 85 | 91 | 106 |
| OD₅₅₀ nm | .04 | 0.553 | 0.584 | 0.586 | 0.717 | 1.151 | 1.469 | 0.870 | 0.994 | 0.814 | 0.989 | 0.906 |
| Total | 583.0 | 631.4 | 699.5 | 763.4 | 1045 | 2002 | 2654 | 3448 | 4337 | 5226 | 5636 | 6662 |
| Nitrate | | | | | | | | | | | | |
| fed | | | | | | | | | | | | |
| Nitrate in | 356.1 | 5.7 | 0 | 0 | 0 | 150 | 0 | 0 | 0 | 0 | 0 | 0 |
| Effluent | | | | | | | | | | | | |
| ppm | | | | | | | | | | | | |
| Nitrite in | 0 | 4.7 | 1.4 | 0 | 1 | 26.6 | 0 | 0 | 0 | 0 | 0 | 27.1 |
| Effluent | | | | | | | | | | | | |
| ppm | | | | | | | | | | | | |

After 106 days of incubation, biofilm was seen on the glass of the bioreactor at or near the oil/aqueous fraction. The oil and aqueous fractions showed signs of emulsification. To observe emulsification, samples were examined using dark field and bright field phase microscopy at 400× magnification (Zeiss Axioskop 40, Carl Zeiss Micro Imaging, Inc, Thornwood, N.Y.). Microbes adhered to both the glass slide and the cover slip, demonstrating a positive hydrophobic response. This assay is a modified version of a procedure which indirectly measures hydrophobicity through the attachment of microbes to polystyrene plates (Pruthi, V. and Cameotra, S., Biotechnol. Tech., 11: 671-674, 1997). In addition, tiny, emulsified oil droplets (around 3 to 40 micron in diameter) were seen in the aqueous phase. Bacteria were also seen in a biofilm-like attachments to some of these emulsified oil droplets.

An aliquot (1 μL) of the steady state POG1 consortium with an emulsified oil drop was placed on a microscope slide and covered with a 20 mm-square No. 1 coverslip and examined using a phase imaging microscopy under an oil emersion lens at 1000× magnification. Microbes were also found in the oil phase in irregular “pockets” formed around aggregated bacteria.

Normally water droplets that are trapped in oil will take on a near circular shaped form. The aqueous-oil interface was moving toward the bottom of the slide, the bacteria were being captured at the interface within these aggregated hydrophobic forms, which were eventually “pinched-off” and left in the oil phase.

Microbes were also seen aggregated at the aqueous-oil interface. Bacteria are usually attracted to the interface but not in mass; they often stream quickly along the interface in one direction, one bacterium at a time. In this Example, the microbes were attracted to the interface as a non-motile aggregate of 30 to 50 microns wide. These observations demonstrate formation of a hydrophobic aggregate mass that may contribute to the formation of the biofilm at the aqueous-oil interface or with an oil/aqueous emulsion. This structure allows microbes to interact with oil and use some of its components as their carbon source.

The members of population profiles of the steady state were similar to what had been detected in previous enrichments and are shown in Table 4 below. There were 73 unique sequences (SEQ ID NOs: 15-87), which were grouped into seven classes of bacteria, which included alpha-Proteobacteria, beta-Proteobacteria, gamma-Proteobacteria, Deferribacteraceae, Spirochaetes, Bacteroidetes and Firmicutes/Clostridiales and Incertae Sedis. The primary Genera continued to be the beta-Proteobacteria, Thauera. Thauera strain AL9:8 was the dominant constituent. The diversity among the members of Thauera/Azoarcus group (Rhodocyclaceae) is significant since there are 31 unique 16S rDNA sequences in this group whose sequence differences occur in the primary signature regions of the variable regions. Also the Firmicutes/Clostridiales group are diverse with 16 unique sequences that include constituents from the Clostridia, Anaerovorax and Finegoldia genera.

TABLE 4
Unique strains in consortium population based on 16S rDNA sequences

| | | | GenBank | |
|---|---|---|---|---|
| | | | Accession | SEQ ID |
| Class | Genus | Highest Identity species | No. | NO. |
| Beta-Proteobacteria | Thauera | Thauera strain AL9:8 | AJ315680 | 15 |
| | Thauera | Thauera aromatica | U95176 | 23, 24, |
| | | | | 25, 26, |
| | | | | 27, 28, |
| | | | | 31, 32, |
| | | | | 33, 34, |
| | | | | 35, 36, |
| | | | | 37, 38, |
| | | | | 39, 40, |
| | | | | 41, 67, |
| | | | | 68 |
| | | Thauera sp. R26885 | AM084104 | 16, 19, |
| | | | | 21, 30 |
| | Azoarcus | Azoarcus sp mXyN2 | X83533 | 17, 18, |
| | | | | 22 |
| | | Azoarcus sp | AY570623 | 29, 54, |
| | | | | 69, 86 |
| Gamma- | Azotobacter | Azotobacter beijerinckii | AJ30831 | 20, 44, |
| Proteobacteria | | | | 46, 57, |
| | | | | 70, 71, |
| | | | | 72, 73, |
| | | | | 74, 84, |
| | | | | 85 |
| | Pseudomonas | Pseudomonas putida | EU930815 | 61, 80, |
| | | | | 83 |
| | | Pseudomonas | AB109012 | 60, 62 |
| | | pseudoalcligenes | | |
| Deferribacteraceae | Deferribacter | Deferribacter | AB086060 | 56, 77 |
| | | desulfuricans | | |
| | Flexistipes | Flexistipes sp vp180 | AF220344 | 53, 58, |
| | | | | 87 |
| Alpha- | Ochrobactrum | Ochrobactrum sp mp- | AY331579 | 47 |
| Proteobacteria | | 57 | | |
| | | Ochrobactrum lupini | AY457038 | 59 |
| Spirochaetes | Spirochaeta | Spirochaeta sp MET-_E | AY800103 | 43 |
| Bacteroidetes/ | Bacteroides | Uncultured | DQ238269 | 78 |
| Chloroflexi group | | Bacteroides/Cytophaga | | |
| Firmicutes | Clostridia | Clostridium aceticum | Y181183 | 76, 81 |
| Clostridiales | | Clostridium | X71850 | 55, 63, |
| | | chartatabidium | | 75 |
| | Anaerovorax | Anaerovorax sp | EU498382 | 48, 49, |
| | | | | 82, |
| | Finegoldia | Finegoldia magna | NC010376 | 42, 45, |
| | | | | 50, 51, |
| | | | | 52, 64, |
| | | | | 65, 66, |
| | | | | 79 |

### Example 3

### Population Analysis of the Steady State POG1 Consortium and Parent POG1 Cultures Using Cloned 16S rDNA Libraries

DNA was extracted as described above from the 3^{rd} gen POG1 parent enrichment cultures and from the steady state POG1 chemostat culture samples and used to make cloned 16S rDNA libraries. Briefly, the 1400 base pair 16S rDNA amplification products for a given DNA pool were visualized on 0.8% agarose gels. The PCR reaction mix was used directly for cloning into pPCR-TOPO4 vector using the TOPO TA cloning system (Invitrogen) following the manufacturer's recommended protocol. DNA was transformed into TOP10 chemically competent cells selecting for ampicillin resistance. Individual colonies (˜48-96 colonies) were selected, grown in microtiter plates, prepared and submitted for sequence analysis as described above.

Results of 16S rDNA Sequence Analysis

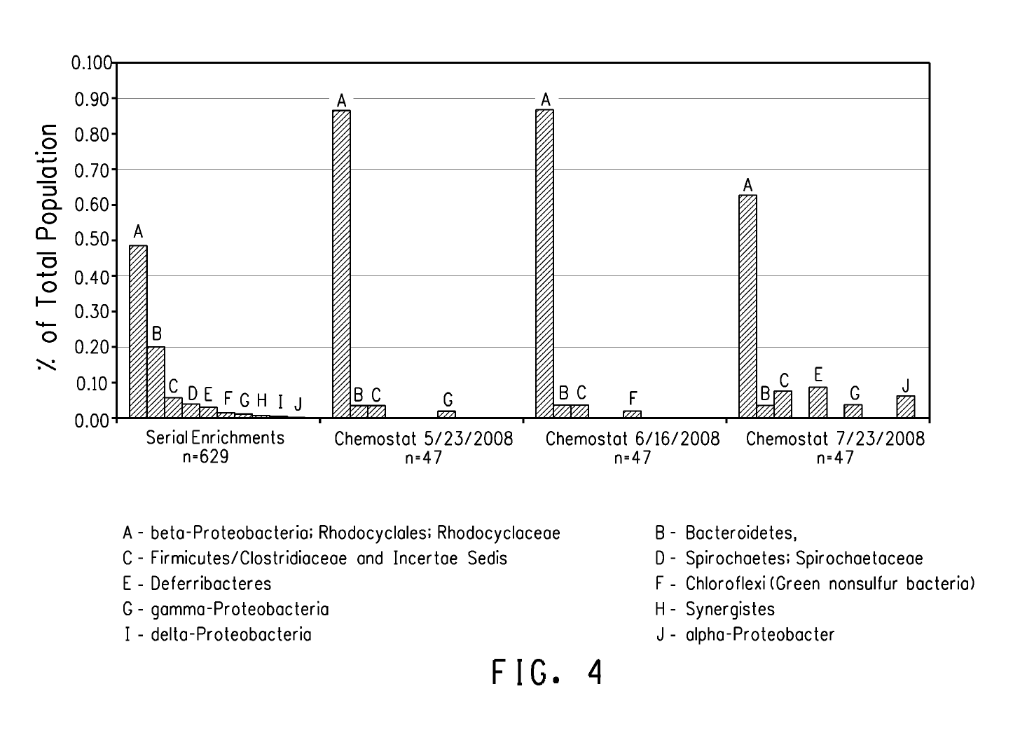

An overall 16S profile was compiled for 1^{st} gen, 2^{nd} gen and 3^{rd} gen parent POG1 cultures described herein. 16S rDNA profiles were also prepared from samples taken at several different time points from the ongoing steady state POG1 chemostat culture. A minimum of 48 16S rDNA clones for each enrichment and/or steady state time sample were sent to Agencourt for sequencing. The 16S rDNA sequence obtained was subsequently blasted (BLASTn) against the NCBI database. Sequences were grouped into homology clusters with at ≧90% identity to the same NCBI rDNA fragment. The homology clusters obtained for all parent POG1 cultures and steady state culture were used to calculate the proportions of particular bacteria in any sample. The populations' results obtained from selected parent enrichment cultures verses steady state is shown FIG. 4.

Analysis indicated that 50-90% of the total 16S rDNAs sequenced belonged to the taxonomic class of beta-Proteobacteria, family Rhodocyclaceae. Members of the beta-Proteobacteria phylum subclass, Thauera in particular, were the most abundant microorganism in the steady state POG1 consortium at any given time. Strains of Thauera have been shown to grow on oil and or oil constituents under anaerobic conditions without the need for additional nutrient supplementation (Anders et. al. Int. J. Syst. Evol. Microbiol. 45: 327-333, 1995).

Sequences belonging to the phyla Bacteroides, Firmicutes/Clostridiales (low G+C gram-positive bacteria), Deferribacteres and Spirochaetes represented between 4-23% of the microbial population and were consistently represented in the POG1 consortium steady state samples and its parent enrichments. The sample size of cloned 16S rDNAs (n=47) for steady state POG1 samples most likely under report the incidences of these organisms in the microbial population. Sequences affiliated with members of the gamma-Proteobacteria, Pseudomonadales, were also represented at a consistently low level in steady state POG1 time samples. This is in contrast to 16S rDNA profiles obtained for several of the initial parent enrichments of this consortium, which did not contain Pseudomonadales 16S rDNA sequences indicating that members of this phylotype may not be critical to steady state POG1 function in MEOR.

Lastly, a low level of sequences (≦3%) associated with phylotypes representing the Chloroflexi, Synergistes, delta-Proteobacteria, and alpha-Proteobacteria were frequently detected in the POG1 parent enrichment cultures.

In summary, the distribution of 16S rDNA sequences described for the steady state POG1 culture as well as the POG1 parent enrichment cultures describes the composition of organisms that define the steady state POG1 consortium. This selected composition of microorganisms may be effective in in-situ bioremediation of the hydrocarbon-contaminated sites.

### Example 4

### Partially Prophetic

### Analysis of Microbial Community by DGGE

The distribution of individual microbial populations in the steady state POG1 consortium's community was analyzed using the 16S rDNA variable region analysis by DGGE. DNA for DGGE community fingerprinting was isolated from samples taken from the steady state POG1 consortium crude oil chemostat over the course of two months. PCR amplified fragments were generated using primers dG.UB357 and U518R for bacteria (SEQ ID NOs: 6 and 4) and dG.UA341F1 and F2 with U518R for Archaea (SEQ ID NOs: 8, 10 and 4). This produced an approximately 200 bp sequence from the V3 region of the bacterial and archaeal 16S rDNA which were then analyzed by DGGE. In addition, PCR amplified fragments for the V4/V5 region of the bacterial and archaeal 16S rDNA sequences were also generated producing fragments of approximately 400 bp generated using primers dG.U519F and UB 936R for bacteria (SEQ ID NOs: 12 and 14) and dG.U519F and UA 9958R for Archaea (SEQ ID NOs: 12 and 15). These PCR fragments were separated by length and nucleotide sequence using DGGE.

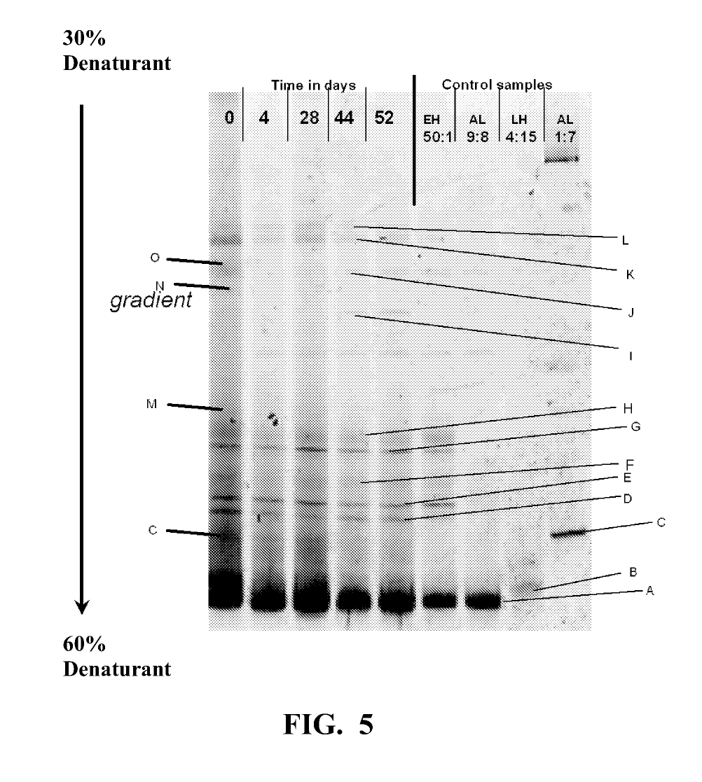

Denaturing gradient gel electrophoresis for fingerprint profiling was performed using a Bio-Rad DGGE DCode System (Bio-Rad Laboratories, Hercules, Calif.). Fingerprint profiles of the amplified rRNA gene fragments were resolved by electrophoresis at 60° C. at 35 V for 16 hr on 8% (w/v) denaturing polyacrylamide gels containing from 30% to 60% denaturant concentration gradient (w/v, 7M urea and 40% formamide in 1×TAE (50×TAE: 2M Tris-Acetate, 50 mM EDTA, pH 8.0)). FIG. 5 is an example of a community DGGE profile of the V4/V5 region from time zero to 52 days. The profiles of the steady state POG1 consortium test samples (days, 0, 4, 28, 44, 52) on the left side appear to have stabilized after 28 days. The controls, on the right half of the gel, include the parent POG1 startup inoculum EH50:1 and a Thauera strain AL9:8. Also included as controls were two strains isolated from the Alaskan North Slop production oil, strain LH4:15 (Pseudomonas stutzeri) and strain AL1:7 (Ochrobactrum sp., from the Brucellaceae family), respectively. The last two strains were chosen as controls to see if the steady state POG1 population included microorganisms that have been seen as major constituents of an oil field population. The major band in all consortium profiles (A) correlated with the band observed for Thauera strain AL9:8.

The second band, (B), which correlates with strain LH4:15, appears to decrease as a major constituent of the population in profiles from day 4 through day 52. The third band (C), which correlates with strain AL1:7 is less dense and is a constituent of the population in profiles for zero through 28 days. However, this band disappears in the later stages of denitrification. Bands D through L are also detectable as minor constituent bands of the population in all samples.

The following steps are prophetic: To identify these steady state POG1 profile bands, previously identified 16S rDNA clones representing constituents from the steady state POG1 consortium, may be applied to DGGE analysis to identify individual DGGE bands as was done to identify to bands A through C in FIG. 5. The V4/V5 region from cloned constituent 16S rDNAs may be used to analyze and identify the remaining bands D through L of the steady state POG1 DGGE profile. The results should closely correlate with the profile bands with major constituents of the consortium identified in the earlier 16S rDNA profile in FIG. 5. Table 4 in Example 2 lists the isolated 16S rDNA clones, obtained from POG1 16S rDNA population profile studies. The clones used to obtain these sequences may be used to generate PCR produces using the DGGE PCR products to identify and correlate the individual bands (A-L) of the DGGE 16S V4/V5 rDNA. Table 4 also includes the associated NCBI rDNA database Accession number ID obtained for these reference clones. These clones represent the major groups of bacteria comprising the POG1 consortium, which include beta-Proteobacteria, primarily Thauera aromatica species (Rhodocyclaceae), and from Pseudomonadales, Bacteroidaceae, Clostridiaceae, Incertae Sedis., Spirochete, Spirochaetaceaes., Deferribacterales Brucellaceae and Chloroflexaceae. PCR amplified fragments for the V4/V5 region of the microbial 16S rDNA may then be generated from both the cloned rDNA (plasmid DNA) that were identified as POG1 constituents and genomic DNA from correlated POG1 samplings as well as POG1 cultures started form frozen culture stocks. Miniprep DNA from POG1 16S rDNA clones may be prepared using a Qiagen Miniprep Kit (Valencia, Calif.) following the manufacturer's protocol. PCR amplified fragments from the V4/V5 region of approximately 400 bp may be generated using primers dG.U519F and UB 936R for bacteria (SEQ ID NOs: 12 and 14). Amplified fragments may be separated by length and nucleotide sequence using DGGE as described above.

### Example 5

### Partially Prophetic

### Long-Term Storage and Recovery of the Consortium for Field Inoculations

An important criterion for the application of any consortium for in situ bioremediation is its viability and function following its long term storage. An aliquot (20 mL) of the steady state POG1 consortium was taken during the steady state growth in the chemostat. The 16S rDNA community sequence and a DGGE fingerprint profiles were performed to define the composition of the community at the sampling time point. The anaerobic sample was placed in a 15-20% glycerol mix (e.g., 150 μL of sterile degassed glycerol into 650 μL of the sample) in the Coy anaerobic chamber, dispensed into sterile 2.0 mL cryogenic polypropylene tubes and treated as described above. The tubes were quickly frozen on dry ice and stored in a −70° C. freezer until needed.

To test the viability of the steady state POG1 freezer culture or to use it as an inoculum, a cryogenic tube was removed from a −70° C. freezer and thawed on wet ice in an anaerobic chamber. An aliquot (50 μL) of the sample was used to start a seed culture for a larger inoculum for the chemostat bioreactor. The seed culture was inoculated into 20 mL of SL10 minimal medium supplemented with 300 ppm nitrate and 10 mL of the autoclaved-targeted crude oil in a 60 mL sterile serum bottle. The anaerobic bottle was sealed with a septum, incubated outside the anaerobic chamber at room temperature (20° to 25° C.) while shaking at 100 rpm on an orbital shaker. Culture turbidity, which is indicative of growth of the constituents of the consortium, was visually observed.

The following steps are prophetic: In addition, with a revived consortium, reduction of nitrate to nitrite is expected to occur after three days. When nitrate concentration reaches about 50 ppm or less, a sample may be taken for isolating the microbial community's DNA for 16S rDNA typing and DGGE fingerprint profiling. It would be expected that the DGGE profile and the 16S rDNA typing of the freezer seed culture would be similar to the profiles obtained for the steady state POG1 consortium. If the freezer culture were stable as expected, a seed culture may be prepared as an anaerobic inoculum for the chemostat bioreactor for nitrate assimilation analysis. The revived frozen consortium may also be used in an oil release sandpack or core flood assay. Furthermore, the revived frozen consortium may be used as a seed culture for inoculating the initial culture to be used for in situ bioremediation of the hydrocarbon-contaminated sites.

### Example 6

### Growth of the Steady State Consortium in Crude Oil Flooded Sandpack or Core Flood Assay

The application of the steady state POG1 consortium to a sandpack saturated with oil was use to evaluate its use as a denitrifying consortium, growing in pipelines as possible method to impede the effects of SRB strains producing corrosion in pipelines or refinery pipes. This was accomplished using the sandpack technique in in-house developed Teflon® shrink-wrapped sandpack apparatus that simulates packed sand of sandstone.

The process described herein was used for making two column sets, a “control” set and a “test” set, which was inoculated with the steady state POG1 consortium to test its efficacy to release oil from the sand column. Using a 1.1 inches thick, and 7 inches long Teflon heat shrink tube, an aluminum inlet fitting with Viton® O-ring was attached to one end of the tube using a heat gun. North Slope sand was added to the column which was vibrated with an engraver to pack down the sand and release trapped air. A second aluminum inlet fitting with Viton® O-ring was attached to the other end of the tube and sealed with heat a gun. The sandpack was then put in an oven at 275° C. for 7 min to evenly heat and shrink the wrap. The sandpack was removed and allowed to cool to room temperature. A second Teflon® heat shrink tube was installed over the original pack and heated in the oven as described above. After the column had cooled, a hose clamp was attached on the pack on the outer wrap over the O-ring and then tightened.

Both column sets (two columns in each set) were then flooded horizontally (at 60 mL/hr) with four pore volumes of “Brine” (sterile, anaerobic SL 10 medium, supplemented with 250 ppm nitrate and 3 mM phosphate buffer, pH 7.4) by means of a syringe pump and a 60 mL sterile plastic polypropylene syringe. Both sets of sandpacks were then flooded with anaerobic autoclaved crude oil to irreducible water saturation, which was predetermined to be two pore volumes. The oil was flooded, at a rate of 0.4 mL/hr, using a 10 mL sterile syringe and a syringe pump. The crude oil was aged on the sand by shutting-in the columns for seven days. One column set was anaerobically inoculated with one half of a pore volume at 0.4 mL/hr with a sample of the consortium removed anaerobically from the chemostat. Simultaneously a control inoculation using anaerobic “Brine” was also loaded on the control column set using the same procedure. The inocula were shut-in for incubation with the oil for seven days and the columns were then flooded with four pore volumes of anaerobic sterile “Brine” at 0.4 mL/hr.

At the conclusion of the production flood, the 7 inches long slim tubes were sacrificed into 5× one-inch sections labeled A-E. One inch was skipped at the beginning and at the exit of the slim tube to avoid edge effects during analysis. Section “A” came from the front end of the column. Sections A, C, and E were analyzed for residual oil saturation on the sand. The amount of oil on the wet sand from the sacrificed slim tubes for residual oil was measured by GC as described above. This value was multiplied by the total amount of toluene used to extract the oil resulting in the total amount of oil on the sand. The value obtained was then divided by the total sample weight to yield the percent of oil with respect to the total sample weight. The weight percent of oil of the sample was then multiplied by the ratio of the empirically derived characteristic of packed North Slope sand (total weight of sample after being flooded with brine divided by total sand weight, 1.27). This relationship is equal to the amount of oil on dry sand. This value was then multiplied by the ratio of the weight of the North Slope sand to the weight of the fluid trapped in the pore space of the sand, 3.75. The resulting value reflected the residual oil left on the sand in units of g of oil/g of total fluid in the pore space. As shown in Table 5, residual oil left on the column, in fractions A and C of the test column, were less than the controls confirming that the columns inoculated with the POG1 consortium released more oil than those that were not inoculated.

TABLE 5
Residual oil left on sand along the tube length
after flooding with anaerobic sterile “Brine”

| Column | Average Percent Residual Oil on | | |
|---|---|---|---|
| Fraction | Sand | | |
| Assay Column | A | C | E |
| Test columns | 23.2% | 22.2% | 18.5% |
| Control | 27.3% | 22.3% | 18.2% |
| columns | | | |

### Example 7

### Ability of the Parent POG1 Consortium to Enhance Oil Release and Grow Using Oil as the Carbon Source

The parent POG1 consortium cultures were examined for their ability to release oil from sand in a visual oil release assay using the microsand column described above. This Example was used evaluate the consortium as a denitrifying culture in pipelines as possible method to impede the effects of SRB strains producing corrosion in pipelines or refinery pipes, using oil as the carbon source. Inocula from early parallel enrichment cultures of the 2^{nd} gen parent POG1 consortium e.g., EH36:1 A, EH36:1B, EH36:1C, EH36:1 D each with ˜250 ppm nitrate and one 3^{rd} gen culture (EH40:1) with high nitrate concentration (˜1600 ppm) were tested in this assay. All enrichment cultures were grown anaerobically in the SL10 minimal salts medium (Table 2) using ACO oil as the carbon source and nitrate as the electron acceptor until turbidity was observed. All operations for preparation of the microsand columns, inoculation and growth were done in an anaerobic chamber using sterile techniques. A 4.0 mL aliquot of each inoculum was added to the 13 mm glass tubes either directly or diluted 1:2 with the minimal salts medium. The microsand columns (filled with oil-saturated sand as described above) were placed in each glass tube, immersed in the medium/cell inoculum with the tapered neck of the Pasteur pipettes pointing up. The outer vials were sealed in the anaerobic Coy chamber and allowed to incubate at ambient temperatures for the next several weeks. Each column was periodically checked for oil release. Cultures that enhanced release of oil over background (sterile medium) were presumed to have altered the interaction of the oil with the sand surface.

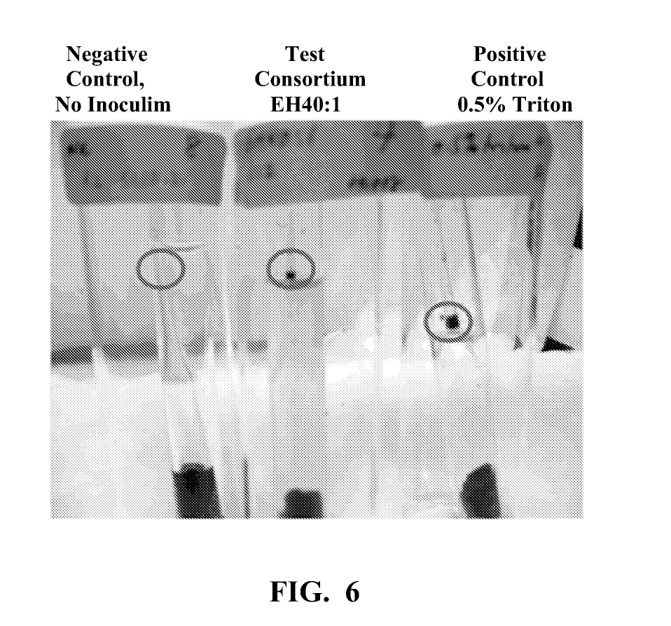

Oil released from the sand was visualized by the released oil collecting in the tapered neck of the Pasteur pipettes or forming droplets on the surface of the sand layer (FIG. 6). Oil release was observed for some of the POG1 parent enrichment cultures as rapidly as only 3 hr after inoculation. Oil release was also observed with the pure Thauera strain AL9:8, isolated from the 1^{st} gen POG1 parent enrichment cultures. Microsand columns were then observed over the course of several weeks. An increase in the initial amount of oil released was observed after 3 months of incubation. Uninoculated controls did not show visual release of oil over the course of the experiment. Triton® X-100 (Rohm & Haas Co), a nonionic surfactant was used as a positive assay for the release of oil from sand. Table 6 lists the enrichment cultures tested and the observations of oil release after 7 days and 3 months incubation at ambient temperatures. These results indicated that the parent POG1 consortium interacted with oil-wet sands at the water/oil/sand interface and induced oil release from the sand's surface. Results described in Example 6 and 7 clearly underline the ability of the POG1 steady state consortium in the release of oil from sand. In addition, it is anticipated that this consortium may be used in applications such as for cleaning oil or refinery pipelines.

TABLE 6
Release of oil from microsand columns by enrichment cultures the
steady state POG1 consortium

| | | | |
|---|---|---|---|
| Inoculum | | Oil release | Oil release |
| ID | dilution | T = 7 days | T = 3 months |

Controls

| | | | |
|---|---|---|---|
| 1.0% Triton | no | +++ | ++++ |
| 1.0% Triton | ½ | ++ | +++ |
| NIC (medium) | no | − | − |

Parent Environmental Enrichment Cultures

| | | | |
|---|---|---|---|
| EH36:1A | no | − | + |
| EH36:1B | no | + | ++ |
| EH36:1C | no | − | − |
| EH36:1C | ½ | + | + |
| EH36:1D | no | + | + |
| EH40:1 | no | − | +/− |
| EH40:1 | ½ | + | + |

Thauera strain

| | | | |
|---|---|---|---|
| AL9:8 | no | + | ++ |

1. Microsand columns were scored for oil release on a scale of 1 to 5 (+) in order of increased oil release; (−) = no release of oil, 5 = complete release of oil from oil coated sand, as judged visually.

### Example 8

### The Ability of the Steady State Consortium to Release Oil from Sand Particles

In order to screen the enrichment cultures for the ability to release oil from the nonporous silica medium, a microtiter plate assay to evaluate its use in growing a denitrifying culture in pipelines as a possible method to impede the effects of SRB strains producing corrosion in pipelines or refinery pipes. The assay is referred to as the LOOS test (Liberation of Oil Off Sand)

A microtiter plate assay was developed to measure the ability of the enrichment cultures and the consortium to release oil/sand from the oil-saturated Alaskan North Slope sand. North Slope sand was autoclaved and then dried under vacuum at 160° C. for 48 hr and 20 g of this dried sand was then mixed with 5 mL of autoclaved, degassed crude oil obtained from Milne point, North Slope. The oil-coated sand was then allowed to adsorb to the sand and age anaerobically at room temperature for at least a week. Microtiter plate assays were set up in the Coy anaerobic chamber. An aliquot of the undiluted steady state POG1 consortium (20 mL) was added into the wells of a 12-well microtiter plate. The POG1 was grown anaerobically in SL10 minimal medium with 2000 ppm sodium nitrate and North Slope crude oil. The control wells contained 2 mL of the SL10/2000 ppm NaNO₃ medium alone. Approximately 40 mg of oil-coated sand was then added to the center of each well. Samples were then monitored over time for the release and accumulation of “free” sand collecting in the bottom of the wells. Approximate diameters (in millimeters) of the accumulated total sand released were measured daily. A score of 3 mm and above indicated the microbes' potential to release oil from a nonporous silica medium such as sand.

Table 7 shows the relative sand release by the steady state POG1 consortium over a period of four weeks. After about 15 days, a 4 mm zone of released sand was observed in the bottom of the wells containing the steady state POG1 consortium. No release was observed for the medium alone. The results indicate that the steady state POG1 consortium may be used to release oil from nonporous silicate substrates.

TABLE 7
Relative sand release by the steady state POG1 consortium over a period
of four weeks (Values 2 or greater represent significant oil release)

| | | | | Day |
|---|---|---|---|---|
| Sample | Day 1 | Day 6 | Day 16 | 24 |
| Steady state POG1 | 0 | 2 | 4 | 4 |
| Consortium in SL10 | | | | |
| medium | | | | |
| SL10 medium alone | 0 | 0 | 0 | 0 |
| (control) | | | | |

### Example 9

### Comparison of Growth of the POG1 Consortium and the Pure Strain Thauera AL9:8 on Targeted Oil Under Anaerobic Denitrifying Conditions

Growth rates of the POG1 consortium and Thauera strain AL9:8 in oil enrichments under anaerobic denitrifying conditions were compared. Thauera strain AL9:8 represents the major microbial constituent of the POG1 consortium. Equivalent inocula of about 10⁶ cells of the consortium and the purified strain were used to inoculate 60 mL serum vials containing a 1:2 ratio of minimal salts medium to autoclaved crude oil under anaerobic conditions. SL10 medium (20 mL) (Table 2) with added nitrate (final concentration of 1100 to 1200 ppm) and 10.0 mL of autoclaved crude oil was used. The medium and crude oil had been deoxygenated by sparging with a mixture of nitrogen and carbon dioxide followed by autoclaving. All manipulations of bacteria were done in an anaerobic chamber. Samples were inoculated in triplicates, were incubated at ambient temperatures for several days and monitored for nitrate and nitrite levels for visible turbidity and gross visible changes to the integrity of the oil phase. POG1 inoculated vials consistently reduced nitrate at a faster rate than did pure cultures of Thauera strain AL9:8. Table 8 summarizes the results of the average nitrate reduction for the triplicate cultures of POG1 consortium verses pure cultures of Thauera strain AL9:8.

TABLE 8
Anaerobic growth in oil enrichments

| | | | Average¹ % of |
|---|---|---|---|
| | | | Nitrate reduced |
| | Average¹ ppm | Average¹ ppm | after |
| Microbial inoculum | Nitrate Day 0 | Nitrate Day 5 | 6 days |
| POG1 consortium | 971 | 117 | 95% |
| Strain AL9:8 | 1323 | 789 | 43% |

¹Nitrate values are the average of three replicates per microbial test inoculum

The POG1 consortium consistently developed biofilms under anaerobic denitrifying conditions in oil enrichments, a phenomenon not observed consistently in oil enrichments of Thauera strain AL9:8. Table 9 summarizes the results obtained for a set of oil enrichments cultured anaerobically as above in the SL10 medium and autoclaved crude oil (2:1) ratio. These cultures were initially incubated with ˜300 ppm nitrate and then further supplemented with nitrate to a final concentration of 1100-1200 ppm for 6 days. Formation of a stable biofilm was observed on the surface of the glass vial [after 3-5 days]. These results underline the synergistic effect of various components of the POG1 consortium, whose major constituent is Thauera strain AL 9:8, on forming a biofilm compared to that formed by Thauera strain AL9:8 alone. This demonstrates that the selected denitrifying consortium may have a more synergistic affect that contributes to a higher growth rate on nitrate than its primary constituent, Thauera strain AL9:8. This may imply that the consortium will have a competitive advantage in the presence of SRB under denitrifying conditions. This would support its use as denitrifying culture in pipelines as possible method to impede the effects of SRB strains, which produce corrosion in pipelines or refinery pipes.

TABLE 9
Biofilm formation of microbes in oil enrichments

| Microbial Oil | |
|---|---|
| Enrichment | Biofilm Formation |
| POG1 consortium | + |
| POG1 consortium | + |
| POG1 consortium | + |
| POG1 consortium | + |
| POG1 consortium | + |
| Strain AL9:8 | − |
| Strain AL9:8 | − |
| Strain AL9:8 | − |
| Strain AL9:8 | − |
| Strain AL9:8 | − |

What is claimed is:

1. A method for in situ bioremediation of hydrocarbon-contaminated site comprising:
(a) providing environmental samples comprising indigenous microbial populations of said hydrocarbon-contaminated site;
(b) enriching for one or more steady state microbial consortium present in said samples wherein said enriching results in a consortium that utilizes hydrocarbon as a carbon source under anaerobic, denitrifying conditions;
(c) Characterizing the enriched steady state consortiums of (b) using 16S rDNA profiling;
(d) assembling a consortium using the characterization of (c) comprising microbial genera comprising one or more Thauera species and any two additional species that are members of genera selected from the group consisting of Rhodocyclaceae, Pseudomonadales, Bacteroidaceae, Clostridiaceae, Incertae Sedis, Spirochaetaceaes, Deferribacterales, Brucellaceae and Chloroflexaceae;
(e) identifying at least one relevant functionality for bioremediation of the consortium of (d);
(f) growing the enriched steady state consortium of (e) having at least one relevant functionality to a concentration sufficient for inoculating said hydrocarbon-contaminated site; and
(g) inoculating the hydrocarbon-contaminated site with said concentration of the consortium of (f) in the presence of one or more anoxic electron acceptors wherein the consortium grows in said hydrocarbon-contaminated site and wherein said growth promotes in situ bioremediation.

2. The method of claim 1, wherein the enriched steady state consortium can be stored at −70° C. before step (f) without loss of relevant functionality for in situ bioremediation.

3. The method of claim 1, wherein the indigenous microbial populations are environmental samples from the hydrocarbon-contaminated site in the form of water or soil that has been exposed to crude oil or any one or combination of oil components from the hydrocarbon-contaminated site including paraffins, aromatics, and asphaltenes.

4. The method of claim 1, wherein said enriching includes conditions comprising:
i) anaerobic and denitrifying conditions;
ii) a temperature of from about 15° C.-45° C.;
iii) a pH of from about 6 to about 9; and
iv) a nitrate concentration from about 25 ppm to about 7000 ppm.

5. The method of claim 1, wherein the anoxic electron acceptor in (g) is selected from the group consisting of, nitrate, iron (III), manganese (IV), sulfate, carbon dioxide, nitrite, ferric ion, sulfur, selenate, arsenate, and organic electron acceptors selected from the group consisting of, but not limited to chloroethenes, fumarate, malate, pyruvate, acetylaldehyde oxaloacetate and similar unsaturated hydrocarbon compounds.

6. The method of claim 1, wherein the one or more Thauera species in (d) is one or more species selected from the group consisting of Thauera strain AL9:8, Thauera aromatica, Thauera chlorobenzoica, Thauera vanillica and Thauera selenatis.

7. The method of claim 1, wherein the microbial consortium of (f) is a consortium comprising at least one species from each of Firmicutes, Clostridiales, Deferribacterale, Spirochaetaceaes, Bacteroidaceae, Rhodocyclacea, Pseudomonadales Brucellaceae and Chloroflexaceae.

8. The method of claim 1, wherein said relevant functionality of (e) is the ability of the consortium to cause any one or more of the following to facilitate in situ bioremediation:
(i) alteration of the permeability of the subterranean formation for improved water sweep efficiency;
(ii) production of biosurfactants to decrease surface and interfacial tensions;
(iii) change in wettability;
(iv) production of polymers other than surfactants;
(v) production of low molecular weight acids which cause rock dissolution; o
(vi) reduction in oil viscosity; or
(vii) degradation of hydrocarbon contaminants.

9. The method of claim 1, wherein the in situ bioremediation occurs by a reduction in crude oil viscosity by growth of the enriched steady state consortium in hydrocarbon-contaminated site, wherein said growth results in the production of any one or more of biosurfactants, carbon dioxide, or cell mass, or selective degradation of high molecular weight components in said hydrocarbons, or combinations thereof.

10. The method of claim 1, further comprising adding to the steady state microbial consortium of (d) one or more non-indigenous microorganisms having a relevant functionality for in situ bioremediation.

11. The method of claim 10, wherein said one or more non-indigenous microorganisms is selected from the group consisting of a) Marinobacterium georgiense, Thauera aromatica T1, Thauera chlorobenzoica), Petrotoga miotherma, Shewanella putrefaciens, Thauera aromatica S100, Comamonas terrigena, Microbulbifer hydrolyticus (ATCC#700072), and mixtures thereof; and
b) comprises a 16s rDNA sequence having at least 95% identity to a 16s rDNA sequence isolated from the microorganisms of (a).
